(19) United States
(12) Patent Application Publication
(10) Pub. No.: US 2025/0289106 A1
(43) Pub. Date: Sep. 18, 2025

(54) FASTENER DRIVER

(71) Applicant: Nanjing Chervon Industry Co., Ltd., Nanjing (CN)

(72) Inventors: Jie Jiang, Nanjing (CN); Ran Lan, Nanjing (CN); Junyi Wu, Nanjing (CN); Changqing Cui, Nanjing (CN); Junjie Ye, Nanjing (CN); Wenyang Liu, Nanjing (CN)

(21) Appl. No.: 19/095,698

(22) Filed: Mar. 31, 2025

Related U.S. Application Data
(63) Continuation of application No. PCT/CN2024/117669, filed on Sep. 9, 2024.

(30) Foreign Application Priority Data
Sep. 26, 2023 (CN) 202311246522.5
Sep. 26, 2023 (CN) 202311252952.8
Sep. 26, 2023 (CN) 202311253522.8
Sep. 26, 2023 (CN) 202311253589.1
Sep. 26, 2023 (CN) 202311253890.2
Sep. 26, 2023 (CN) 202322624189.9
Sep. 26, 2023 (CN) 202322626766.8
May 21, 2024 (CN) 202421115920.3

(51) Int. Cl. B25C 1/04; B25C 1/06

(52) U.S. Cl. CPC B25C 1/047; B25C 1/06

(57) ABSTRACT

A fastener driver includes a firing pin, a piston connected to the firing pin, a driving member driving a striking assembly to move backward to a top dead center position, and an energy storage device driving the striking assembly to move forward to a bottom dead center position to output an impact force. The distance L3 between the top dead center position and the bottom dead center position is defined as the stroke of the striking assembly, the fastener driver is configured to drive a fastener within a preset length LA to move, and the ratio of the stroke of the striking assembly to the preset length is less than or equal to 1.5 to 1.

### RELATED APPLICATION INFORMATION

This application is a continuation of International Application Number PCT/CN2024/117669, filed on Sep. 9, 2024, through which this application also claims the benefit under 35 U.S.C. § 119 (a) of Chinese Patent Application No. 202311252952.8, filed on Sep. 26, 2023, Chinese Patent Application No. 202311253589.1, filed on Sep. 26, 2023, Chinese Patent Application No. 202322626766.8, filed on Sep. 26, 2023, Chinese Patent Application No. 202311253890.2, filed on Sep. 26, 2023, Chinese Patent Application No. 202311253522.8, filed on Sep. 26, 2023, Chinese Patent Application No. 202311246522.5, filed on Sep. 26, 2023, Chinese Patent Application No. 202322624189.9, filed on Sep. 26, 2023, and Chinese Patent Application No. 202421115920.3, filed on May 21, 2024, which applications are incorporated herein by reference in their entireties.

### TECHNICAL FIELD

The present application relates to the field of power tools, for example, a fastener driver.

### BACKGROUND

A fastener driver in the related art is usually used for fixing a workpiece. A user drives a fastener into the workpiece to fix the workpiece. In the fastener driver of the related art, the fastener driver drives one fastener in each striking cycle.

In the related art, when operating the fastener driver, the user needs to carry or lift the fastener driver by hand. The fastener driver in the related art is large in size, offers low operational comfort, and is inconvenient to use.

This part provides background information related to the present application, and the background information is not necessarily the existing art.

### SUMMARY

An example of the present application provides a fastener driver that includes a striking assembly including a piston and a firing pin, where the firing pin is connected to the piston; a transmission mechanism including a driving member configured to drive the striking assembly to move backward to a top dead center position; and an energy storage device configured to drive the striking assembly to move forward to a bottom dead center position to output an impact force. The distance L3 between the top dead center position and the bottom dead center position is defined as the stroke of the striking assembly, the fastener driver is configured to drive a fastener within a preset length L4 to move, and the ratio of the stroke of the striking assembly to the preset length is less than or equal to 1.5.

In some examples, the stroke is less than or equal to 80 mm.

In some examples, the length of the firing pin is less than or equal to 165 mm.

In some examples, the firing pin includes a toothed portion, and the ratio of the length of the toothed portion to the preset length is less than or equal to 1.21.

In some examples, the driving member drives the firing pin to move from the bottom dead center position, pass through a switching position and a stop position in sequence, and move to the top dead center position.

In some examples, the ratio of the stroke distance of the firing pin moving from the stop position to the top dead center position to the stroke distance of the firing pin moving from the switching position to the top dead center position is less than 1.

In some examples, the stroke distance of the firing pin moving from the switching position to the top dead center position is greater than or equal to 3.7 mm and less than or equal to 4.8 mm.

In some examples, the stroke distance of the firing pin moving from the stop position to the top dead center position is greater than or equal to 1.6 mm and less than or equal to 2.6 mm.

In some examples, the ratio of the stroke distance of the firing pin moving from the stop position to the top dead center position to the stroke distance of the firing pin moving from the switching position to the top dead center position is greater than or equal to 0.5 and less than or equal to 0.9.

In some examples, the firing pin includes a body portion extending along the direction of a first straight line and multiple meshing teeth disposed on the body portion, the driving member includes multiple driving teeth configured to mesh with the firing pin to drive the firing pin, and the multiple meshing teeth include a first meshing tooth that stops the firing pin at the stop position.

In some examples, the first meshing tooth and the driving tooth are in contact at a contact point and generate a force perpendicular to the tangent at the contact point, and when the firing pin moves from the switching position to the top dead center position, the included angle between the direction of the force and the direction of the first straight line gradually increases.

In some examples, the fastener driver includes a guide assembly configured to guide the fastener to move, where the length of the guide assembly is less than or equal to 108 mm.

In some examples, the length of the fastener driver in the front and rear direction is less than or equal to 295 mm.

In some examples, the energy storage device includes a first cylinder accommodating at least part of the piston, the first cylinder includes a first inner wall in contact with the piston, the first inner wall has a circular first cross section, and the ratio of the stroke of the firing pin to the diameter of the first cross section is greater than or equal to 1.7 and less than or equal to 2.8.

In some examples, the product of an area of the first cross section and the stroke is defined as the gas displacement, and the ratio of the striking energy outputted by the fastener driver to the gas displacement is greater than or equal to 0.3 J/cm³ and less than or equal to 0.7 J/cm³.

An example of the present application provides a fastener driver that includes a striking assembly including a piston and a firing pin, where the firing pin is connected to the piston; a transmission mechanism including a driving member configured to drive the striking assembly to move backward to a top dead center position; and an energy storage device configured to drive the striking assembly to move forward to a bottom dead center position to output an impact force. The length of the fastener driver in the front and rear direction is less than or equal to 295 mm.

An example of the present application provides a fastener driver that includes a striking assembly including a piston and a firing pin, where the firing pin is connected to the piston; a transmission mechanism including a driving member configured to drive the striking assembly to move backward to a top dead center position; and an energy storage device configured to drive the striking assembly to move forward to a bottom dead center position to output an impact force, where the energy storage device includes a first cylinder accommodating at least part of the piston, the first cylinder includes a first inner wall in contact with the piston, and the first inner wall has a circular first cross section. The distance between the top dead center position and the bottom dead center position is defined as the stroke of the striking assembly, and the ratio of the stroke of the firing pin to the diameter of the first cross section is greater than or equal to 1.7 and less than or equal to 2.8.

In some examples, the energy storage device includes a second cylinder, at least part of the first cylinder is accommodated in the second cylinder, the second cylinder includes a second inner wall, the second inner wall has a circular second cross section, and the ratio of the diameter of the first cross section to the diameter of the second cross section is greater than or equal to 0.6 and less than or equal to 0.7.

In some examples, the diameter of the first cross section is greater than or equal to 28 mm and less than or equal to 36 mm.

In some examples, the product of the first cross section and the stroke is defined as the gas displacement, and the ratio of the striking energy outputted by the fastener driver to the gas displacement is greater than or equal to 0.3 J/cm³ and less than or equal to 0.7 J/cm³.

An example of the present application provides a fastener driver that includes a firing pin configured to output an impact force to drive a fastener into a workpiece; a transmission mechanism configured to drive the firing pin to move backward at least to a stop position; a motor configured to drive at least the transmission mechanism; a controller connected to the motor; and a detection mechanism connected to the controller, where the detection mechanism is configured to detect the position of a moving part and send a detection signal when the moving part is within a first preset position range to allow the controller to send a control signal. When the moving part reaches a second preset position before reaching the stop position or at a first preset time before the moving part reaches the stop position, the controller sends the control signal to control the motor to rotate by a preset number of rotations or brake after a second preset time.

In some examples, the transmission mechanism includes a driving member including multiple driving teeth configured to mesh with the firing pin to drive the firing pin.

In some examples, the first preset position range has a first boundary position, and it is defined that an angle between a line connecting the center point of the moving part at the stop position and the rotation point of the driving part and a line connecting the center point of the moving part at the first boundary position and the rotation point of the driving part when the center point of the moving part is at the stop position and the first boundary position separately, the angle formed with the rotation point of the driving part as the vertex is greater than or equal to 10 degrees and less than or equal to 60 degrees.

In some examples, the firing pin includes a body portion extending along the direction of a first straight line and multiple meshing teeth disposed on the body portion, the multiple meshing teeth include a first meshing tooth that stops the firing pin at the stop position, the multiple driving teeth include a first driving tooth configured to mesh with at least the first meshing tooth, and an angle between a line connecting the center point of the moving part and the rotation point of the driving part and a line connecting the center point of the first driving tooth and the rotation point of the driving part is greater than or equal to 5 degrees and less than or equal to 30 degrees. In some examples, the moving part is a magnetic element.

In some examples, the surface magnetic field strength of the magnetic element is greater than or equal to 2800 Gs and less than or equal to 3600 Gs.

In some examples, the first preset time is greater than or equal to 20 ms and less than or equal to 30 ms.

In some examples, the preset number of rotations is greater than or equal to 1 and less than or equal to 5.

In some examples, the second preset time is greater than or equal to 4 ms and less than or equal to 20 ms.

In some examples, the stroke distance of the firing pin moving from the first preset position range to the stop position is greater than or equal to 4 mm and less than or equal to 10 mm.

An example of the present application provides a fastener driver that includes a striking assembly including a firing pin configured to output an impact force to drive a fastener into a workpiece; an energy storage device configured to drive the firing pin to move forward to output the impact force; a main housing supporting at least part of the energy storage device; a grip connected to the main housing; a transmission mechanism configured to drive the firing pin to move backward; and a motor configured to drive at least the transmission mechanism. The centerline of the grip is at least partially disposed between the centerline of the energy storage device and the centerline of the motor.

In some examples, the fastener driver has a center of gravity, and the centerline of the grip is at least partially disposed between the centerline of the energy storage device and the center of gravity.

In some examples, the fastener driver includes a coupling portion for detachably mounting a battery pack that provides energy to the motor, and the centerline of the coupling portion is at least partially disposed between the centerline of the energy storage device and the centerline of the motor.

In some examples, the centerline of the coupling portion and the centerline of the grip are on the same plane.

In some examples, the striking assembly further includes a piston, the energy storage device includes a first cylinder accommodating at least part of the piston, and the centerline of the grip is at least partially disposed between the centerline of the first cylinder and the centerline of the motor.

In some examples, the centerline of the grip is at least partially disposed between the centerline of the firing pin and the centerline of the motor.

In some examples, the centerline of the grip is parallel to the centerline of the energy storage device, and the distance between the centerline of the grip and the centerline of the energy storage device is greater than or equal to 0.5 mm and less than or equal to 10 mm.

In some examples, the main housing includes a first housing and a second housing fitting each other along a fitting surface, and the fitting surface of the first housing and the second housing passes through the centerline of the grip and the centerline of the energy storage device.

In some examples, the fastener driver includes a trigger configured to activate the fastener driver, and the centerline of the trigger is at least partially disposed between the centerline of the energy storage device and the centerline of the motor.

In some examples, the motor is disposed in front of the grip.

An example of the present application provides a fastener driver that includes a firing pin configured to output an impact force to drive a U-shaped fastener into a workpiece; an energy storage device configured to drive the firing pin to move to output the impact force; and a guide assembly configured to guide at least the fastener into the workpiece. The guide assembly includes a first guide structure for preventing at least two legs of the fastener from approaching each other.

In some examples, the guide assembly includes a second guide structure for preventing at least two legs of the fastener from moving away from each other.

In some examples, the guide assembly includes a guide surface configured to be in contact with the at least two legs, and the first guide structure protrudes relative to the guide surface.

In some examples, the fastener further includes a connecting portion connecting the at least two legs, and the connecting portion is configured to be in contact with the first guide structure.

In some examples, the guide assembly includes a first guide member and a second guide member that faces the first guide member, and the first guide structure and the second guide structure are disposed on the first guide member.

In some examples, at least part of the first guide member is located above the second guide member.

In some examples, the first guide structure is configured to guide the firing pin to move.

In some examples, the firing pin includes a guide groove configured to engage with the first guide structure, and the ratio of the length of the guide groove to the length of the firing pin in the front and rear direction is greater than or equal to 0.5 and less than or equal to 0.7.

In some examples, the guide assembly extends basically along the direction of the first straight line, and after being in contact with the guide assembly, the fastener extends in a direction inclined relative to the direction of the first straight line at an angle greater than or equal to 0 degrees and less than or equal to 8 degrees.

In some examples, the guide assembly extends basically along the direction of the first straight line, the guide assembly includes input ports for the fastener to pass through, the fastener driver includes a lifting member configured to drive the fastener to move and pass through the input ports, and the lifting member is inclined relative to the direction of the first straight line.

An example of the present application provides a fastener driver that includes a firing pin configured to output an impact force; and a transmission mechanism including a driving member configured to drive the firing pin to move. The firing pin includes a body portion extending along the direction of a first straight line and multiple meshing teeth disposed on the body portion. The multiple meshing teeth include a first meshing tooth that stops the firing pin at a stop position. The driving member includes driving teeth configured to mesh with the multiple meshing teeth to drive the firing pin to move from a bottom dead center position, pass through a switching position and the stop position in sequence, and move to a top dead center position. The first meshing tooth and the driving tooth are in contact at a contact point and generate a force perpendicular to the tangent at the contact point, and when the firing pin moves from the switching position to the top dead center position, the included angle between the direction of the force and the direction of the first straight line gradually increases. The ratio of the stroke distance of the firing pin moving from the stop position to the top dead center position to the stroke distance of the firing pin moving from the switching position to the top dead center position is less than 1.

In some examples, the first meshing tooth has an outer contour for engagement with the driving tooth, the outer contour has a straight-line portion and an arc portion, and at the switching position, the driving tooth transitions from engagement with the straight-line portion to engagement with the arc portion.

In some examples, the included angle between the straight-line portion and the direction of the first straight line is greater than or equal to 87 degrees and less than or equal to 105 degrees.

In some examples, the driving member is configured to rotate about a second straight line, the distance from the second straight line to the direction of the force is the moment arm of the force, and when the firing pin moves from the switching position to the top dead center position, the moment arm of the force relative to the second straight line gradually shortens.

In some examples, the stroke distance of the firing pin moving from the bottom dead center position to the top dead center position is greater than or equal to 70 mm and less than or equal to 86 mm.

In some examples, the stroke distance of the firing pin moving from the switching position to the top dead center position is greater than or equal to 3.7 mm and less than or equal to 4.8 mm.

In some examples, the stroke distance of the firing pin moving from the stop position to the top dead center position is greater than or equal to 1.6 mm and less than or equal to 2.6 mm.

In some examples, the ratio of the stroke distance of the firing pin moving from the stop position to the top dead center position to the stroke distance of the firing pin moving from the switching position to the top dead center position is greater than or equal to 0.5 and less than or equal to 0.9.

In some examples, from the switching position to the stop position, the torque of the driving member is greater than or equal to 2.5 N·m and less than or equal to 8.5 N·m.

An example of the present application provides a fastener driver that includes a firing pin configured to output an impact force; and a transmission mechanism including a driving member configured to drive the firing pin to move. The firing pin includes a body portion extending along the direction of a first straight line and multiple meshing teeth disposed on the body portion. The multiple meshing teeth include a first meshing tooth that stops the firing pin at a stop position. The driving member includes driving teeth configured to engage with the multiple meshing teeth to drive the firing pin to move. When the firing pin is at the stop position, the first meshing tooth and the driving tooth are in contact at a contact point and generate a force perpendicular to the tangent at the contact point, and the included angle between the direction of the force and the direction of the first straight line is greater than or equal to 0 degrees and less than or equal to 40 degrees.

An example of the present application provides a fastener driver that includes a striking assembly including a piston and a firing pin, where the firing pin is connected to the piston; a transmission mechanism including a driving member configured to drive the striking assembly to move backward to a top dead center position; an energy storage device configured to drive the striking assembly to move forward to a bottom dead center position to output an impact force, where the energy storage device includes a ventilation portion for the energy storage device to inflate and deflate; and a control device configured to control the firing pin to be at a stop position, where the stop position is between the top dead center position and the bottom dead center position. Before the energy storage device is inflated, the striking assembly is configured to move backward to and stay at a ready position which exceeds the stop position and is closer to the top dead center position or move backward to and stay at an inflation position that reaches or exceeds the top dead center position.

In some examples, the striking assembly is configured to move forward toward the bottom dead center position when the energy storage device is inflated.

In some examples, the striking assembly is configured to move forward to the bottom dead center position when the energy storage device is inflated.

In some examples, before the energy storage device is inflated, the transmission mechanism drives the striking assembly to move backward to and stay at the inflation position.

In some examples, the striking assembly is configured to move backward to and stay at the inflation position when the energy storage device is deflated through the ventilation portion.

In some examples, the energy storage device includes a first cylinder, and at least part of the striking assembly is configured to move in the first cylinder.

In some examples, the transmission mechanism includes a motor configured to brake to stop the backward movement of the striking assembly. When the motor brakes, the motor is configured to, before the energy storage device is inflated, rotate by a first number of braking rotations from the start of braking to the end of braking and after the energy storage device is inflated, rotate by a second number of braking rotations from the start of braking to the end of braking. The difference between the first number of braking rotations and the second number of braking rotations is greater than or equal to 6 and less than or equal to 12.

In some examples, the fastener driver includes a detection assembly for detecting the position of the striking assembly relative to the inflation position.

In some examples, the fastener driver includes a display device for displaying the position of the striking assembly.

In some examples, the transmission mechanism includes a clutch assembly for limiting the forward movement of the striking assembly when the striking assembly meshes with the driving member.

An example of the present application provides an inflation adapter suitable for a fastener driver. The inflation adapter includes a first connection end for connecting an air source, where the first connection end is provided with an air inlet; a second connection end configured to be connected to a ventilation portion of the fastener driver and move toward the ventilation portion to an extreme position; an air outlet connected to the ventilation portion; and a drive assembly configured to open a valve at the ventilation portion, where the drive assembly has at least a first position at which the drive assembly opens the valve and a second position at which the drive assembly does not open the valve, and the drive assembly is configured to be at the second position at least when the second connection end is at the extreme position.

In some examples, the inflation adapter further includes an operating portion configured to be operated by a user to drive the drive assembly to move.

In some examples, the drive assembly includes a first driving member and a second driving member, the operating portion is configured to drive the first driving member, and the first driving member is configured to drive the second driving member.

In some examples, the first connection end is rotatable relative to the second connection end.

In some examples, the inflation adapter further includes a filter configured to filter air, and the filter is connected to the air inlet so that filtered air enters the air inlet.

In some examples, the second connection end includes a meshing portion configured to mesh with the ventilation portion so that the second connection end can stay at least at the extreme position.

In some examples, the ventilation portion and the meshing portion are formed with threads.

In some examples, the inflation adapter further includes a first inflation cavity for accommodating a first elastic member and a second inflation cavity for accommodating a second elastic member.

In some examples, the inflation adapter further includes a first sealing member configured to seal the first inflation cavity relative to the second inflation cavity.

In some examples, the inflation adapter further includes a second sealing member configured to seal the second connection end and the ventilation portion.

In some examples, the drive assembly is configured to move to the first position at least after the second connection end reaches the extreme position.

An inflation adapter for inflating a device to be inflated is provided. The device to be inflated includes an air storage space and a ventilation portion connected to the air storage space. The inflation adapter includes a first connection end for connecting an air source, where the first connection end is provided with an air inlet; a second connection end configured to be connected to the ventilation portion of the device to be inflated and move toward the ventilation portion to an extreme position, where an airflow path from the air inlet to the air storage space is defined as an inflation channel; and a drive assembly having at least a first position at which the drive assembly opens the inflation channel to allow the flow of air and a second position at which the drive assembly closes the inflation channel to block the flow of air. The drive assembly is configured to be at the second position at least when the second connection end is at the extreme position.

In some examples, the inflation adapter further includes an operating portion configured to be operated by a user to drive the drive assembly to move.

In some examples, the drive assembly is configured to move to the first position at least after the second connection end reaches the extreme position.

### BRIEF DESCRIPTION OF THE DRAWINGS

FIG. 1 is a perspective view of a fastener driver according to an example of the present application.

FIG. 2 is a left side view of the fastener driver in FIG. 1.

FIG. 3 is a front view of the fastener driver in FIG. 1.

FIG. 4 is a sectional view of the fastener driver in FIG. 3 taken along the x1 plane.

FIG. 5 is a front view of a transmission mechanism and a housing of the fastener driver in FIG. 1.

FIG. 6 is a sectional view of the transmission mechanism and the housing in FIG. 5 taken along the x2 plane.

FIG. 7 is a sectional view of the transmission mechanism and the housing in FIG. 5 taken along the x3 plane.

FIG. 8 is a top view of a striking assembly and a driving member of the fastener driver in FIG. 1.

FIG. 9 is a front view of a striking assembly and a driving member of the fastener driver in FIG. 1.

FIG. 10 is a sectional view of the striking assembly and the driving member of the fastener driver in FIG. 9 at a bottom dead center position taken along the x4 plane.

FIG. 11 is a sectional view of the striking assembly and the driving member of the fastener driver in FIG. 9 at a top dead center position taken along the x4 plane.

FIG. 12 is a schematic diagram of a first meshing tooth and a first driving tooth of the fastener driver in FIG. 1 at a top dead center position, a stop position, a switching position, and a bottom dead center position.

FIG. 13 is a schematic diagram illustrating the relationship among the stroke distance of a firing pin of the fastener driver in FIG. 1 moving from a bottom dead center position to a top dead center position, the torque of a driving member, an included angle a, the moment arm, and a force F.

FIG. 14 is a perspective view of a transmission mechanism, a moving part, a detection mechanism, and a guide assembly of the fastener driver in FIG. 1.

FIG. 15 is a top view of a transmission mechanism, a moving part, a detection mechanism, and a guide assembly of the fastener driver in FIG. 1.

FIG. 16 is a top view of a striking assembly and a driving member of the fastener driver in FIG. 1 at a top dead center position.

FIG. 17 is a side view of a transmission mechanism, a moving part, a detection mechanism, and a guide assembly of the fastener driver in FIG. 1.

FIG. 18 is a schematic view of a moving part, a detection mechanism, and a driving member of the fastener driver in FIG. 1 within a first preset position range.

FIG. 19 is a perspective view of a support frame and an energy storage device of the fastener driver in FIG. 1.

FIG. 20 is a perspective view of a support frame, an energy storage device, and a second guide member of the fastener driver in FIG. 1.

FIG. 21 is a bottom view of a support frame, an energy storage device, and a second guide member of the fastener driver in FIG. 1.

FIG. 22 is a perspective view of a support frame of the fastener driver in FIG. 1 according to an example.

FIG. 23 is a perspective view of a support frame, an energy storage device, and a guide assembly of the fastener driver in FIG. 1 according to an example.

FIG. 24 is a bottom view of a support frame, an energy storage device, and a guide assembly of the fastener driver in FIG. 1 according to an example.

FIG. 25 is a sectional view of an energy storage device of the fastener driver in FIG. 1 at a top dead center position and a bottom dead center position.

FIG. 26 is a top view of a striking assembly of the fastener driver in FIG. 1.

FIG. 27 is a top view of an energy storage device and a striking assembly of the fastener driver in FIG. 1.

FIG. 28 is a sectional view of an energy storage device of the fastener driver in FIG. 1 taken along the x5 plane.

FIG. 29 is a perspective view of a magazine and an anti-dry fire assembly of the fastener driver in FIG. 1.

FIG. 30 is a side view of a magazine and an anti-dry fire assembly of the fastener driver in FIG. 1.

FIG. 31 is a sectional view of an anti-dry fire assembly and part of a magazine of the fastener driver in FIG. 1.

FIG. 32 is a front view of part of an anti-dry fire assembly of the fastener driver in FIG. 1.

FIG. 33 is an exploded view of a magazine and an anti-dry fire assembly of the fastener driver in FIG. 1 from a certain angle.

FIG. 34 is an exploded view of a magazine and an anti-dry fire assembly of the fastener driver in FIG. 1 from another angle.

FIG. 35 is a top view of the fastener driver in FIG. 1.

FIG. 36 is a partial enlarged view of a ventilation portion of the fastener driver in FIG. 1.

FIG. 37 is a schematic diagram of a striking assembly of the fastener driver in FIG. 1 at an inflation position, a ready position, a stop position, and a bottom dead center position.

FIG. 38 is a flowchart illustrating the inflation of an energy storage device of the fastener driver in FIG. 1.

FIG. 39 is a perspective view of an inflation adapter and a filter suitable for the fastener driver in FIG. 1.

FIG. 40 is a sectional view of an inflation adapter and a filter suitable for the fastener driver in FIG. 1 taken along a plane.

FIG. 41 is an exploded view of an inflation adapter and a filter suitable for the fastener driver in FIG. 1.

FIG. 42 is a side view of a valve of the fastener driver in FIG. 1.

FIG. 43 is a sectional view of a valve of the fastener driver in FIG. 1.

FIG. 44 is a sectional view of an inflation adapter suitable for the fastener driver in FIG. 1 taken along another plane.

FIG. 45 is a plan view of an inflation adapter and a measuring device suitable for the fastener driver in FIG. 1.

FIG. 46 is a perspective view of a housing and a magazine of the fastener driver in FIG. 1.

FIG. 47 is a left side view of a housing and a magazine of the fastener driver in FIG. 1.

FIG. 48 is a sectional view of a housing and a magazine of the fastener driver in FIG. 1 taken along the x6 plane.

FIG. 49 is a partial enlarged view of the housing and the magazine of the fastener driver in FIG. 48.

FIG. 50 is a rear view of a fastener driver according to an example of the present application.

FIG. 51 is a left side view of the fastener driver in FIG. 50.

FIG. 52 is a sectional view of the fastener driver in FIG. 51 taken along the x7 plane.

FIG. 53 is a sectional view of the fastener driver in FIG. 51 taken along the x8 plane.

FIG. 54 is a rear view of an energy storage device, a gearbox, a motor, a trigger, and a coupling portion of the fastener driver in FIG. 50.

FIG. 55 is a partial enlarged view of a first housing and a second housing of the fastener driver in FIG. 50.

FIG. 56 is a left side view of a fastener driver according to an example of the present application.

FIG. 57 is an exploded view of a magazine of the fastener driver in FIG. 56 from a certain angle.

FIG. 58 is an exploded view of a magazine of the fastener driver in FIG. 56 from another angle.

FIG. 59 is a perspective view of a fastener driver according to an example of the present application.

FIG. 60 is an exploded view of a guide assembly, a firing pin, and a fastener of the fastener driver in FIG. 59 from a certain angle.

FIG. 61 is a partial enlarged view of a first guide member of the fastener driver in FIG. 59.

FIG. 62 is a perspective view of a first guide member, a firing pin, and a fastener of the fastener driver in FIG. 59.

FIG. 63 is a schematic view of a guide assembly, a firing pin, and a fastener of the fastener driver in FIG. 59.

FIG. 64 is an exploded view of a guide assembly, a firing pin, and a fastener of the fastener driver in FIG. 59 from another angle.

FIG. 65 is a left side view of a guide assembly, fasteners, and a lifting member of the fastener driver in FIG. 59.

FIG. 66 is a partial enlarged view of the guide assembly and the fasteners of the fastener driver in FIG. 65.

FIG. 67 is a schematic view of some internal structures of a fastener driver according to an example of the present application.

FIG. 68 is a structural view of some components of the fastener driver in FIG. 67, where a striking member is located at a striking position.

FIG. 69 is a structural view of FIG. 68 from another perspective.

FIG. 70 is a half section view of FIG. 68, where the striking member is at the striking position.

FIG. 71 is a half section view of FIG. 68, where the striking member is at a stop position.

FIG. 72 is a schematic view of a striking member and an outer envelope of a rotation trajectory of a first pin.

FIG. 73 is a partial enlarged view of a part J in FIG. 72.

### DETAILED DESCRIPTION

Before any examples of this application are explained in detail, it is to be understood that this application is not limited to its application to the structural details and the arrangement of components set forth in the following description or illustrated in the above drawings.

In this application, the terms “comprising”, “including”, “having” or any other variation thereof are intended to cover an inclusive inclusion such that a process, method, article or device comprising a series of elements includes not only those series of elements, but also other elements not expressly listed, or elements inherent in the process, method, article, or device. Without further limitations, an element defined by the phrase “comprising a . . . ” does not preclude the presence of additional identical elements in the process, method, article, or device comprising that element.

In this application, the term “and/or” is a kind of association relationship describing the relationship between associated objects, which means that there can be three kinds of relationships. For example, A and/or B can indicate that A exists alone, A and B exist simultaneously, and B exists alone. In addition, the character “/” in this application generally indicates that the contextual associated objects belong to an “and/or” relationship.

In this application, the terms “connection”, “combination”, “coupling” and “installation” may be direct connection, combination, coupling or installation, and may also be indirect connection, combination, coupling or installation. Among them, for example, direct connection means that two members or assemblies are connected together without intermediaries, and indirect connection means that two members or assemblies are respectively connected with at least one intermediate members and the two members or assemblies are connected by the at least one intermediate members. In addition, “connection” and “coupling” are not limited to physical or mechanical connections or couplings, and may include electrical connections or couplings.

In this application, it is to be understood by those skilled in the art that a relative term (such as “about”, “approximately”, and “substantially”) used in conjunction with quantity or condition includes a stated value and has a meaning dictated by the context. For example, the relative term includes at least a degree of error associated with the measurement of a particular value, a tolerance caused by manufacturing, assembly, and use associated with the particular value, and the like. Such relative term should also be considered as disclosing the range defined by the absolute values of the two endpoints. The relative term may refer to plus or minus of a certain percentage (such as 1%, 5%, 10%, or more) of an indicated value. A value that did not use the relative term should also be disclosed as a particular value with a tolerance. In addition, “substantially” when expressing a relative angular position relationship (for example, substantially parallel, substantially perpendicular), may refer to adding or subtracting a certain degree (such as 1 degree, 5 degrees, 10 degrees or more) to the indicated angle.

In this application, those skilled in the art will understand that a function performed by an assembly may be performed by one assembly, multiple assemblies, one member, or multiple members. Likewise, a function performed by a member may be performed by one member, an assembly, or a combination of members.

In this application, the terms “up”, “down”, “left”, “right”, “front”, and “rear” and other directional words are described based on the orientation or positional relationship shown in the drawings, and should not be understood as limitations to the examples of this application. In addition, in this context, it also needs to be understood that when it is mentioned that an element is connected “above” or “under” another element, it can not only be directly connected “above” or “under” the other element, but can also be indirectly connected “above” or “under” the other element through an intermediate element. It should also be understood that orientation words such as upper side, lower side, left side, right side, front side, and rear side do not only represent perfect orientations, but can also be understood as lateral orientations. For example, lower side may include directly below, bottom left, bottom right, front bottom, and rear bottom.

In this application, the terms “controller”, “processor”, “central processor”, “CPU” and “MCU” are interchangeable. Where a unit “controller”, “processor”, “central processing”, “CPU”, or “MCU” is used to perform a specific function, the specific function may be implemented by a single aforementioned unit or a plurality of the aforementioned unit.

In this application, the term “device”, “module” or “unit” may be implemented in the form of hardware or software to achieve specific functions.

In this application, the terms “computing”, “judging”, “controlling”, “determining”, “recognizing” and the like refer to the operations and processes of a computer system or similar electronic computing device (e.g., controller, processor, etc.).

Technical solutions of the present application are further described below in conjunction with drawings and examples.

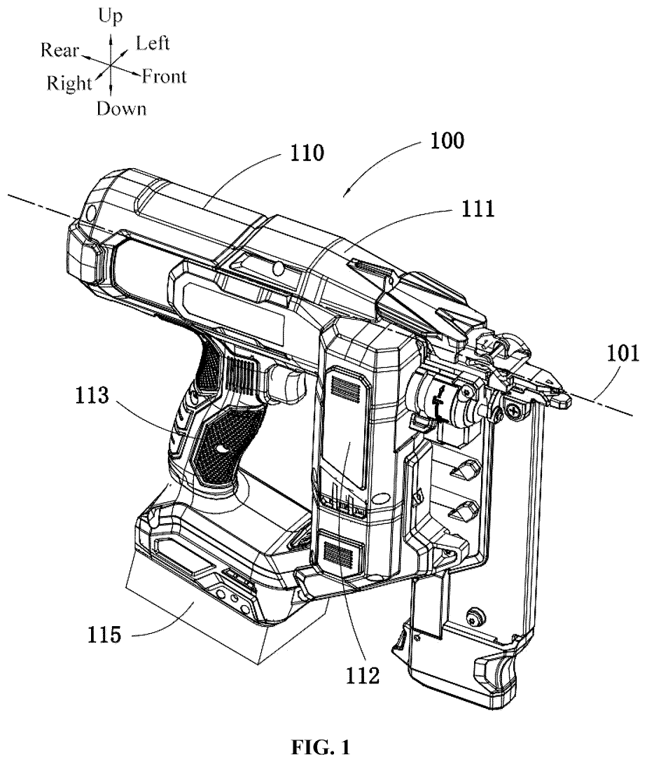

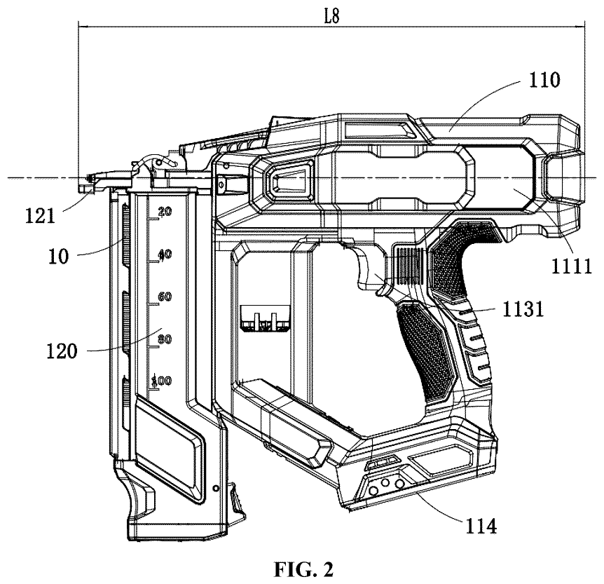

As shown in FIGS. 1 and 2, this example provides a fastener driver 100. The fastener driver 100 provided in this example is a pre-inflated dual-cylinder fastener driver. For example, the fastener driver may be a single-cylinder fastener driver, a dual-cylinder fastener driver, a pre-inflated fastener driver, a non-pre-inflated fastener driver, a spring-loaded fastener driver, or the like, which is not limited here. The fastener driver 100 can generate an impact force on a fastener 10, thereby driving the fastener 10 into a workpiece.

The fastener driver 100 includes a housing 110 and a magazine 120. The housing 110 includes a main housing 111, a transmission portion 112, and a grip 113 for a user to hold. The magazine 120 is configured to accommodate fasteners 10, and at least part of the magazine 120 is disposed on the outer side of the housing 110. The fastener in this example is a nail. The dimension of the nail may be 15 Ga, 16 Ga, 18 Ga, 23 Ga, 25 Ga, or the like, which is not limited here. The usage angle of the nail may be 0 degrees, 5 degrees, 10 degrees, 15 degrees, 20 degrees, 25 degrees, 30 degrees, or the like, which is not limited here. The nail may be a straight nail, a U-shaped nail, or the like, which is not limited here.

An end of the grip 113 is connected to the main housing 111. The grip 113 is provided with a trigger 1131 connected to a main switch. The user triggers the main switch through the trigger 1131 to control the start and stop of the fastener driver 100. The fastener driver 100 includes a coupling portion 114. The other end of the grip 113 is connected to the coupling portion 114, and the coupling portion 114 is configured to be connected to a direct current power supply or an alternating current power supply. In this example, a battery pack 115 is detachably mounted on the coupling portion 114, and the specification and power of the battery pack 115 are not limited here.

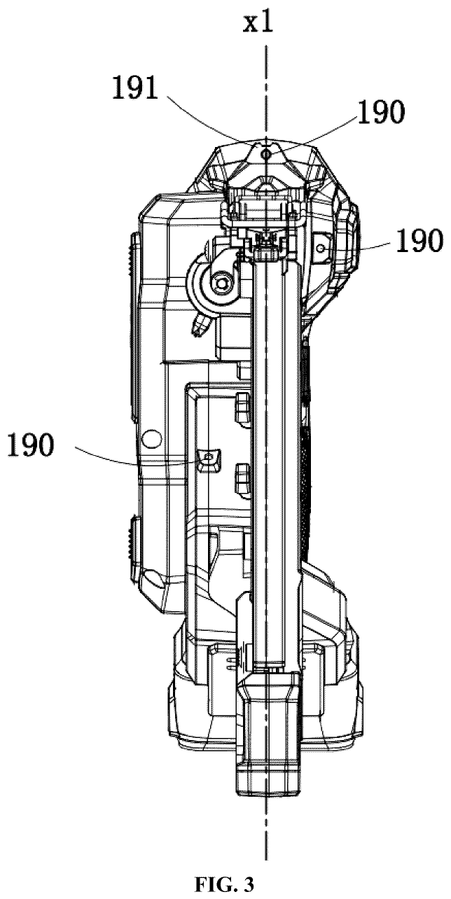

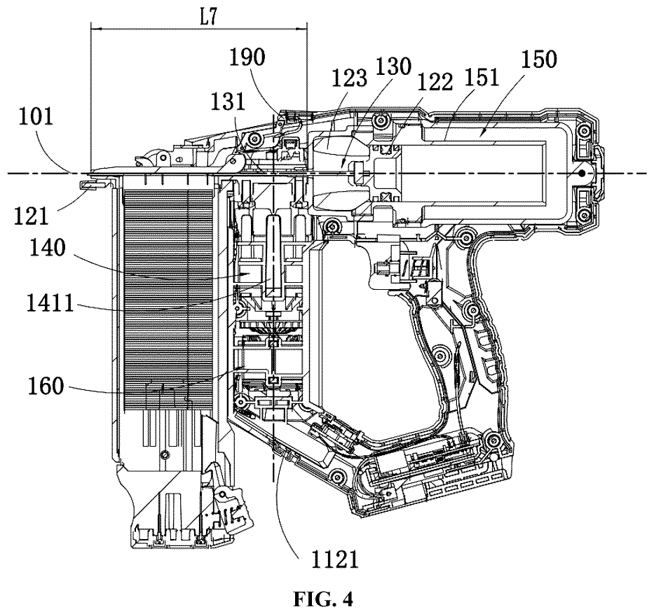

As shown in FIGS. 3 and 4, the fastener driver 100 further includes a striking assembly 130, a transmission mechanism 140, an energy storage device 150, and a motor 160. The striking assembly 130 includes a firing pin 131. The firing pin 131 outputs the impact force to the fastener 10 to drive the fastener 10 into the workpiece. The energy storage device 150 drives the firing pin 131 to move forward to output the impact force. The transmission mechanism 140 drives the firing pin 131 to move backward to store energy for the energy storage device 150. An accommodation space is formed on the inner side of the main housing 111 to accommodate at least part of the energy storage device 150 and the striking assembly 130. The main housing 111 supports at least part of the energy storage device 150. The motor 160 drives at least the transmission structure. The battery pack 115 provides energy to the motor 160. An accommodation space is formed on the inner side of the transmission portion 112. At least part of the motor 160 and the transmission mechanism 140 are accommodated in the transmission portion 112. The transmission portion 112 supports at least part of the motor 160 and the transmission mechanism 140.

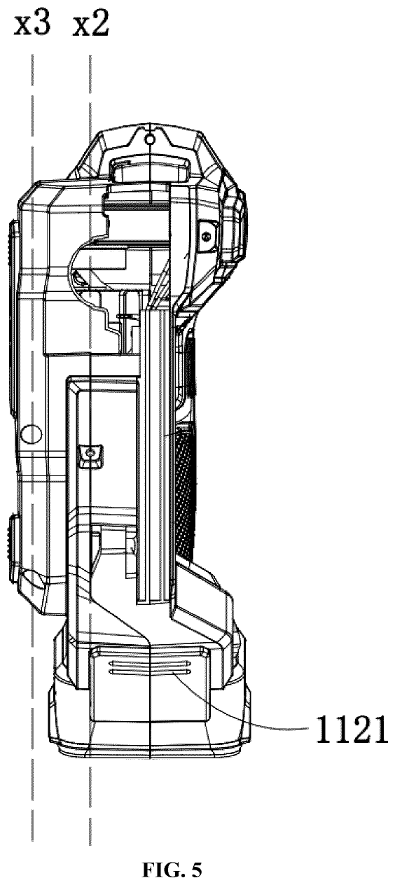

As shown in FIGS. 3 to 7, in this example, the motor 160 is an electric motor. The motor 160 includes a motor output shaft 161. The transmission mechanism 140 includes a gearset 141 and a driving member 142. The motor output shaft 161 drives the gearset 141 to rotate. The gearset 141 includes a gearset output shaft 1411. The gearset output shaft 1411 drives the driving member 142 to move. The driving member 142 drives the firing pin 131 to move. The gearset 141 includes multiple stages of planet gears, and the multiple stages of planet gears include at least two stages of planet gears. Planet gears of each stage adopt the same number of teeth, the same gear module, the same dimension, and the same gear ratio, thereby reducing manufacturing costs.

The transmission portion 112 is fixed by screws 112a. In the transmission portion 112, the distance between the gearset 141 and the motor 160 in the up and down direction is relatively large so that the screws 112a can contract inward along the radial direction of the transmission portion 112. The screws 112a are partially located between the gearset 141 and the motor 160 so that the space between the gearset 141 and the motor 160 can be fully utilized, the radial dimension of the transmission portion 112 is reduced, and the outer surface does not bulge due to the installation of the screws 112a, which is aesthetically pleasing, simple, and cost-effective.

The fastener driver 100 includes gas inlets 1121. Multiple gas inlets 1121 may be provided. In this example, the gas inlets 1121 are disposed between the transmission portion 112 and the coupling portion 114. The gas inlets 1121 are disposed between the motor 160 and a printed circuit board (PCB), thereby fully utilizing the space of the housing 110 and improving the heat dissipation efficiency of the motor 10. The gas inlet 1121 is a hole in a strip shape. The housing 110 is formed with a dustproof structure at the gas inlets 1121 that bends inward toward the housing 110 to prevent dust from entering the fastener driver 100. In some examples, air may also flow out from the gas inlets 1121.

The fastener driver 100 includes a trigger lever 121. The trigger lever 121 is connected to a safety switch. When the trigger lever 121 is triggered, the safety switch is turned on. When the user presses the trigger 1131 with the safety switch turned on, the firing pin 131 drives one fastener 10 out. After completing the strike, the firing pin 131 stays at a stop position, waiting for the user to press the trigger 1131 again to strike the next fastener 10. In some examples, in the case where the trigger 1131 is pressed, the firing pin 131 strikes the fastener 10 once every time the safety switch is turned on. After the firing pin 131 completes one strike, the fastener 10 in the magazine 120 is replenished to the front end of the firing pin 131, waiting to be driven out by the firing pin 131. The striking assembly 130 is driven by the transmission mechanism 140 and the energy storage device 150 to reciprocate to continuously strike the fasteners 10 in sequence. During each striking cycle, the fastener driver 100 drives out one fastener 10.

The striking assembly 130 further includes a piston 122. The firing pin 131 is mounted on the piston 122, and the piston 122 is basically located behind the firing pin 131. The energy storage device 150 includes a first cylinder 151. The first cylinder 151 accommodates at least part of the piston 122 and allows the piston 122 and part of the firing pin 131 to reciprocate in the first cylinder 151. When the transmission mechanism 140 drives the striking assembly 130 to move backward, the air in the first cylinder 151 is compressed, and the energy storage device 150 stores energy. When the energy storage device 150 drives the striking assembly 130 to move forward, the elastic potential energy of the compressed air is converted into kinetic energy, and the striking assembly 130 outputs the impact force.

The main housing 111 includes heat dissipation regions 1111 which are hollow regions on the main housing 111. The outer surface of the first cylinder 151 exchanges heat with the air through the heat dissipation regions 1111, thereby improving the heat dissipation efficiency. Multiple heat dissipation regions 1111 may be provided. The heat dissipation regions 1111 are located on the rear half of the main housing 111. In this example, at least 80% of the area of the heat dissipation regions 1111 allows the outer surface of the rear half of the first cylinder 151 to be in contact with the air, thereby dissipating heat for the part of the first cylinder 151 where heat generation is more significant. Two heat dissipation regions 1111 are provided, are located on the left and right sides of the main housing 111, respectively, and have basically the same shape and position.

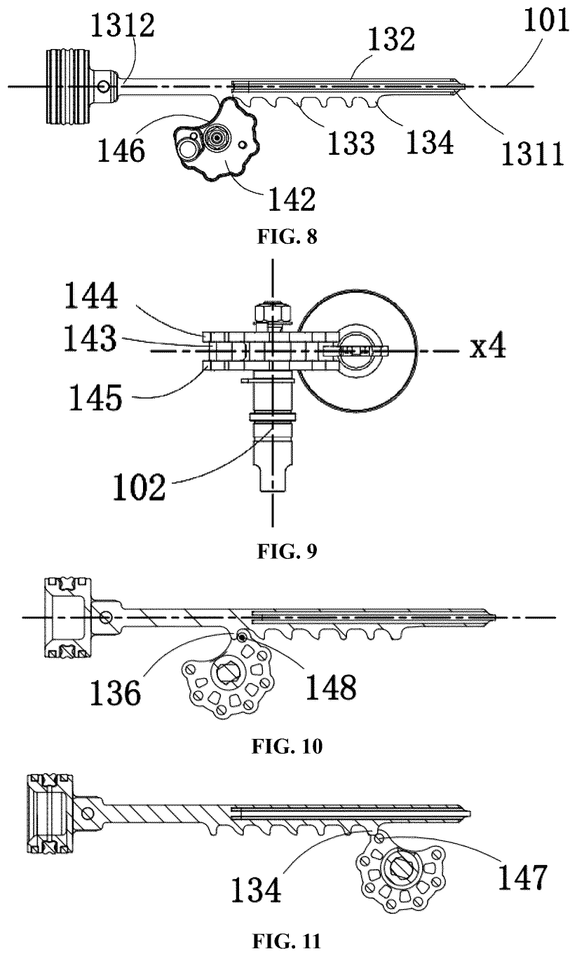

As shown in FIGS. 8 to 12, the firing pin 131 includes a body portion 132 and multiple meshing teeth 133. The multiple meshing teeth 133 are disposed on the body portion 132. The body portion 132 is configured to extend along the direction of a first straight line 101. The firing pin 131 moves along the direction of the first straight line 101 to output the impact force to the fastener 10. It is to be noted that the first straight line 101 is a virtual line, and the direction of the first straight line 101 is the front and rear direction indicated by the first straight line 101. The direction of the first straight line 101 is a direction in which the fastener 10 is driven into the workpiece.

The multiple meshing teeth 133 are arranged on the firing pin 131 at basically equal intervals along the length direction of the firing pin 131. The multiple meshing teeth 133 protrude from the body portion 132 and are wavy as a whole. The multiple meshing teeth 133 include a first meshing tooth 134. The first meshing tooth 134 stops the firing pin 131 at the stop position. The firing pin 131 includes a tip 1311 and an end 1312 along the length direction. The end 1312 is mounted to the piston 122, and the tip 1311 is in contact with the fastener 10 when the firing pin 131 strikes the fastener 10. The first meshing tooth 134 is closest to the tip 1311 of the firing pin 131 among the multiple meshing teeth 133. In some examples, at least one meshing tooth 133 among the multiple meshing teeth 133 is in the shape of a shark fin. The first meshing tooth 134 is thicker than the other meshing teeth 133. A coating may be applied or plated onto the first meshing tooth 134.

The driving member 142 includes driving teeth 143. Multiple driving teeth 143 are provided, and the multiple driving teeth 143 mesh with the multiple meshing teeth 133 to drive the firing pin 131 to move backward. The driving member 142 includes a first fixing layer 144 and a second fixing layer 145 that are basically in parallel. The multiple driving teeth 143 are disposed at basically equal intervals along the circumferential direction between the first fixing layer 144 and the second fixing layer 145. The first fixing layer 144 and the second fixing layer 145 are plates having a certain thickness. The multiple driving teeth 143 are cylindrical, and two ends of the cylinder are fixed on the first fixing layer 144 and the second fixing layer 145, respectively. In some examples, the driving teeth 143 are movable or rotatable to reduce friction between the driving teeth 143 and the meshing teeth 133. In some examples, a movable or rotatable pin bushing is sleeved on the driving tooth 143.

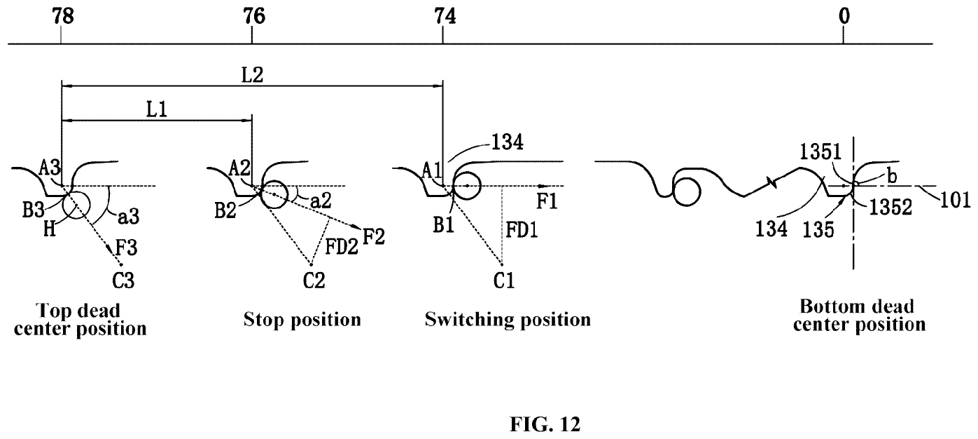

Referring to FIG. 12, the driving member 142 rotates about a second straight line 102, and the second straight line 102 is a rotation point C when viewed from above. The reference numerals of the rotation point C at different positions are denoted by C1, C2, and C3 in the drawings, respectively. The driving member 142 is a drive wheel that rotates about the second straight line 102, that is, rotates about the rotation point C when viewed from above. In some examples, when the driving member 142 is viewed from above, the outer contours of the multiple driving teeth 143 are tangent to the circumference of the same circle.

When the driving member 142 drives the firing pin 131 to move backward, the circumferential outer contours 135 of the multiple meshing teeth 133 are in contact with the circumferential outer contours 135 of the multiple driving teeth 143. In this example, seven driving teeth 143 and seven meshing teeth 133 are provided. The seven driving teeth 143 mesh with the seven meshing teeth 133 in sequence in one-to-one correspondence. In some examples, the number of driving teeth 143 and the number of meshing teeth 133 may be other values. The position of the driving member 142 remains unchanged along the front and rear direction, and the driving member 142 rotates in place about the rotation point C. Therefore, when the driving member 142 rotates, the firing pin 131 is driven by the driving member 142 to move backward. The driving member 142 includes a notch 146, and the notch 146 is basically in an arc shape that is concave toward the rotation point C.

As shown in FIGS. 9 and 10, the driving member 142 and the firing pin 131 are viewed from directly above the fastener driver 100. When the notch 146 rotates until the notch 146 opens basically upward, the first driving tooth 143 on the left side of the notch 146 is named a first driving tooth 147, and the first driving tooth 143 on the right side of the notch 146 is named a seventh driving tooth 148. The multiple meshing teeth 133 further include a seventh meshing tooth 136. The first driving tooth 147 meshes with the first meshing tooth 134 during rotation, and the seventh driving tooth 148 meshes with the seventh meshing tooth 136 during rotation. Every time the driving member 142 rotates one circle, each driving tooth 143 meshes with the corresponding meshing tooth 133 once.

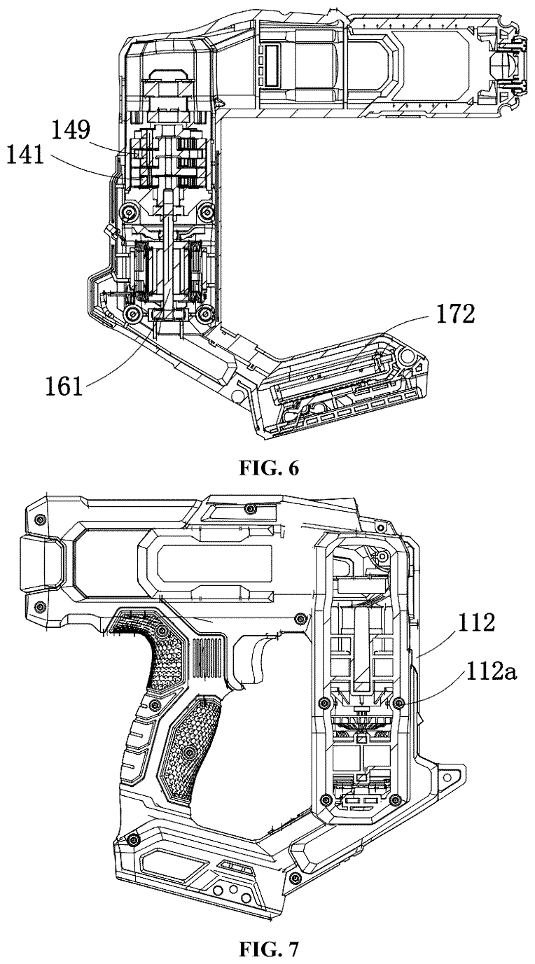

The firing pin 131 may move to multiple positions. As shown in FIG. 4, the fastener driver 100 includes a buffer 123. When the firing pin 131 is at the bottom dead center position, the piston 122 is in contact with the buffer 123, the striking assembly 130 stops moving forward, and the firing pin 131 moves basically to the forwardmost position to which the firing pin 131 can move. The fastener 10 is driven out by the firing pin 131. The seventh driving tooth 148 meshes with the seventh meshing tooth 136, and the motor 160 drives the transmission mechanism 140 to drive the driving member 142 to rotate counterclockwise. As shown in FIG. 6, the transmission mechanism 140 includes a clutch assembly 149 for preventing the driving member 142 from rotating clockwise.

As shown in FIGS. 8 to 12, during the counterclockwise rotation of the driving member 142, the multiple driving teeth 143 mesh with the multiple meshing teeth 133 in sequence. Driven by the driving member 142, the striking assembly 130 overcomes atmospheric pressure and moves backward from the bottom dead center position, and the first driving tooth 147 meshes with the first meshing tooth 134. The first meshing tooth 134 and the first driving tooth 147 are in contact at a contact point B and generate a force F perpendicular to the tangent at the contact point B. The reference numerals of the contact point B at different positions are denoted by B1, B2, and B3 in the drawings, respectively. The reference numerals of the force F at different positions are denoted by F1, F2, and F3 in the drawings, respectively. After the driving teeth 143 start to mesh with the first meshing tooth 134, the included angle a between the direction of the force F and the direction of the first straight line gradually decreases or remains unchanged. The firing pin 131 gradually moves to the switching position. The included angle a between the direction of the force F and the direction of the first straight line is basically zero. When the firing pin 131 continues moving backward from the switching position, the included angle a between the direction of the force F and the direction of the first straight line gradually increases. The reference numerals of the included angle a at different positions are denoted by a1 (not shown), a2, and a3 in the drawings, respectively.

The firing pin 131 continues moving backward, the energy storage device 150 continues storing energy, and the firing pin 131 reaches the stop position. At the stop position, the fastener driver 100 stops operating. When the user presses the trigger 1131, the driving member 142 continues driving the firing pin 131 to move backward to the top dead center position. The air in the first cylinder 151 is basically compressed to the limit, and the elastic potential energy stored in the energy storage device 150 basically reaches the peak value. The striking assembly 130 stops moving backward, and the firing pin 131 moves basically to the rearmost position to which the firing pin 131 can move. When the firing pin 131 just passes the top dead center position, the driving teeth 143 disengage from the meshing teeth 133. At this time, the driving member 142 rotates to a position where the notch 146 opens upward, and the firing pin 131 does not mesh with the driving member 142 so that the firing pin 131 can move forward. Under the drive of the energy storage device 150, the elastic potential energy is converted into kinetic energy, the compressed air causes the firing pin 131 to move forward, the firing pin 131 outputs the impact force, and the fastener 10 is driven out by the firing pin 131. The firing pin 131 moves to the bottom dead center position again.

From the perspective of distance, one striking cycle occurs when the firing pin 131 moves from the top dead center position to the top dead center position or from the bottom dead center position to the bottom dead center position. From the user's perspective, one striking cycle occurs every time the firing pin 131 returns to the stop position. In this example, one striking cycle occurs every time the firing pin 131 returns to the stop position.

As shown in FIG. 12, the ratio of the stroke distance L1 of the firing pin 131 moving from the stop position to the top dead center position to the stroke distance L2 of the firing pin 131 moving from the switching position to the top dead center position is less than or equal to 1. In some examples, the ratio of the stroke distance L1 of the firing pin 131 moving from the stop position to the top dead center position to the stroke distance L2 of the firing pin 131 moving from the switching position to the top dead center position is greater than or equal to 0.4 and less than or equal to 0.9. In some examples, the ratio of the stroke distance L1 of the firing pin 131 moving from the stop position to the top dead center position to the stroke distance L2 of the firing pin 131 moving from the switching position to the top dead center position is greater than or equal to 0.5 and less than or equal to 0.9. In some examples, the ratio of the stroke distance L1 of the firing pin 131 moving from the stop position to the top dead center position to the stroke distance L2 of the firing pin 131 moving from the switching position to the top dead center position is greater than or equal to 0.6 and less than or equal to 0.8. In some examples, the ratio of the stroke distance L1 of the firing pin 131 moving from the stop position to the top dead center position to the stroke distance L2 of the firing pin 131 moving from the switching position to the top dead center position is equal to 0.3, 0.35, 0.4, 0.45, 0.5, 0.55, 0.6, 0.65, 0.7, 0.75, 0.8, or 0.85.

When the firing pin 131 is at the stop position, the included angle a between the direction of the force F and the direction of the first straight line 101 is greater than or equal to 0 degrees and less than or equal to 40 degrees. In some examples, the included angle a between the direction of the force F and the direction of the first straight line 101 is greater than or equal to 0 degrees and less than or equal to 12 degrees. In some examples, the included angle a between the direction of the force F and the direction of the first straight line 101 is greater than or equal to 2 degrees and less than or equal to 10 degrees. In some examples, the included angle a between the direction of the force F and the direction of the first straight line 101 is greater than or equal to 3 degrees and less than or equal to 8 degrees. In some examples, the included angle a between the direction of the force F and the direction of the first straight line 101 is equal to 39 degrees, 38 degrees, 37 degrees, 35 degrees, 30 degrees, 25 degrees, 20 degrees, 15 degrees, 13 degrees, 12.5 degrees, 12.4 degrees, or 12.3 degrees.

The ratio of the stroke distance L1 of the firing pin 131 moving from the stop position to the top dead center position to the stroke distance L2 of the firing pin 131 moving from the switching position to the top dead center position is greater than or equal to 0.5 and less than or equal to 1. When the firing pin 131 is at the stop position, the included angle a between the direction of the force F and the direction of the first straight line 101 is greater than or equal to 0 degrees and less than or equal to 12 degrees. In this manner, the stop position is close to the top dead center position so that when the fastener driver 100 is started, the starting load of the motor 160 is small, energy is saved, the working efficiency is high, and the motor 160 generates relatively little heat. The stop position is not too close to the top dead center position, thereby ensuring high safety and preventing the fastener driver 100 from accidentally driving out the fastener 10. The stop position is adjusted according to the movement distance of the firing pin 131, and the determination of an appropriate stop position can be quantified so that the stop position has high accuracy.

The stroke distance of the firing pin 131 moving from the bottom dead center position to the top dead center position is greater than or equal to 70 mm and less than or equal to 86 mm. In some examples, the stroke distance of the firing pin 131 moving from the bottom dead center position to the top dead center position is greater than or equal to 75 mm and less than or equal to 81 mm. In some examples, the stroke distance of the firing pin 131 moving from the bottom dead center position to the top dead center position is greater than or equal to 77 mm and less than or equal to 79 mm. In some examples, the stroke distance of the firing pin 131 moving from the bottom dead center position to the top dead center position is equal to 78 mm.

The stroke distance L1 of the firing pin 131 moving from the stop position to the top dead center position is greater than or equal to 1.6 mm and less than or equal to 2.6 mm. In some examples, the stroke distance L1 of the firing pin 131 moving from the stop position to the top dead center position is greater than or equal to 1.8 mm and less than or equal to 2.4 mm. The stroke distance L2 of the firing pin 131 moving from the switching position to the top dead center position is greater than or equal to 3.6 mm and less than or equal to 4.4 mm. In some examples, the stroke distance L2 of the firing pin 131 moving from the switching position to the top dead center position is greater than or equal to 3.8 mm and less than or equal to 4.2 mm. In some examples, the stroke distance L2 of the firing pin 131 moving from the switching position to the top dead center position is equal to 4 mm. The stroke distance L1 of the firing pin moving from the stop position to the top dead center position is less than the stroke distance L2 of the firing pin 131 moving from the switching position to the top dead center position. The stop position is between the switching position and the top dead center position, and the stop position is close to the top dead center position.

With continued reference to FIG. 12, an outer contour 135 of the first meshing tooth 134 has a straight-line portion 1351 and an arc portion 1352. At the switching position, the first driving tooth 147 transitions from engagement with the straight-line portion 1351 to engagement with the arc portion 1352. The included angle b between the straight-line portion 1351 and the direction of the first straight line is greater than or equal to 87 degrees and less than or equal to 105 degrees. In some examples, the included angle b between the straight-line portion 1351 and the direction of the first straight line is greater than or equal to 89 degrees and less than or equal to 99 degrees. In some examples, the included angle b between the straight-line portion 1351 and the direction of the first straight line is greater than or equal to 90 degrees and less than or equal to 97 degrees. In some examples, the included angle b between the straight-line portion 1351 and the direction of the first straight line is approximately equal to 90 degrees. The straight-line portion 1351 is connected to the body portion 132 of the firing pin 131 via an arc-shaped connection line that is concave toward the body portion 132. Due to the existence of the arc-shaped connection line and the straight-line portion 1351, the first driving tooth 147 is in contact with the arc-shaped connection line and then is in contact with the straight-line portion 1351. After the included angle a between the direction of the force F and the direction of the first straight line gradually decreases, the included angle a remains unchanged on the straight-line portion 1351. On the straight-line portion 1351, the included angle a between the direction of the force F and the direction of the first straight line is 0 degrees. In some examples, the straight-line portion 1351 is directly connected to the body portion 132 of the firing pin 131, the first driving tooth 147 is in direct contact with the straight-line portion 1351, and the included angle a between the direction of the force F and the direction of the first straight line remains unchanged at 0 degrees before the firing pin 131 passes the switching position. The arc portion 1352 connected to the straight-line portion 1351 protrudes in a direction away from the body portion 132 of the firing pin 131. When the firing pin 131 passes the switching position, the first driving tooth 147 moves along the arc portion 1352, and the included angle a between the direction of the force F and the direction of the first straight line gradually increases. The arc portion 1352 has a center A of a circle. The reference numerals of the center A of the circle at different positions are denoted by A1, A2, and A3 in the drawings, respectively. The first driving tooth has a center point H. At the top dead center position, the center A of the circle, the contact point B, the center point H of the first driving tooth, and the rotation point C may be connected to form a straight line. The outer contour 135 of the first meshing tooth 134 has the straight-line portion 1351 and the arc portion 1352. In this manner, the first driving tooth 147 may apply a force to the first meshing tooth 134 through the straight-line portion 1351 to drive the firing pin 131 to move backward, and the force loss is small. Through the arc portion 1352, using a gentle arc, the first driving tooth 147 accurately stops the firing pin 131 at the stop position close to the top dead center position with high control accuracy.

When the firing pin 131 moves backward, the pressure exerted by the compressed air in the first cylinder 151 on the firing pin 131 gradually increases. Exerting pressure on the driving teeth 143 is equivalent to applying torque to the driving member 142. The torque is the force F generated at the contact point B and perpendicular to the tangent at the contact point B. The distance from the second straight line 102 to the direction of the force F is the moment arm FD of the force F. The reference numerals of the moment arm FD at different positions are denoted by FD1, FD2, FD3 (not shown), and the like in the drawings, respectively. In other words, when viewed from above, the perpendicular line from the rotation point C to the force F is the moment arm FD. When the firing pin 131 moves from the switching position to the top dead center position, the distance from the force F to the rotation point C gradually shortens, the moment arm FD gradually shortens, and the load of the motor 160 gradually decreases.

The torque of the motor 160 may be regarded as the load of the motor 160. When the gear ratio of the gearset 141 is fixed, the torque of the driving member 142 is positively correlated with the torque of the motor 160. From the switching position to the stop position, the torque of the driving member 142 is greater than or equal to 2.5 N·m and less than or equal to 8.5 N·m. In some examples, from the switching position to the stop position, the torque of the driving member 142 is greater than or equal to 3 N·m and less than or equal to 8 N·m. In some examples, from the switching position to the stop position, the torque of the driving member 142 is greater than or equal to 4 N·m and less than or equal to 7 N·m. At the stop position, the torque of the driving member 142 is small, and the torque of the motor 160 when the motor 160 is restarted is small, thereby saving energy. The fastener driver 100 can operate for a long time with high working efficiency, and the temperature rise of the motor 160 is low.

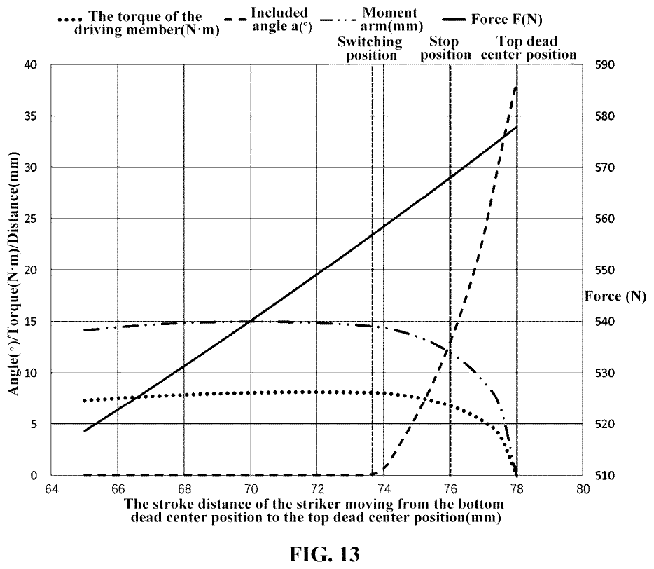

As shown in FIG. 13, during the movement of the firing pin from the bottom dead center position to the top dead center position, as the piston 122 moves backward in the first cylinder 151 and compresses the air, the force F gradually increases. In this example, the force F increases linearly. The torque of the driving member 142 is the product of the force F and the moment arm FD. The variation trend of the torque of the motor 160 is consistent with the variation trend of the torque of the driving member 142. After the firing pin 131 passes the switching position, although the force F still increases, the moment arm FD decreases rapidly. Therefore, the torque of the driving member 142 is reduced, and the torque of the motor 160 is reduced. The ratio of the stroke distance L1 of the firing pin 131 moving from the stop position to the top dead center position to the stroke distance L2 of the firing pin 131 moving from the switching position to the top dead center position is less than or equal to 1. The stop position of the firing pin 131 is close to the top dead center position, and the starting load of the motor 160 is low. When the firing pin 131 is at the stop position, the included angle a between the direction of the force F and the direction of the first straight line 101 is greater than or equal to 0 degrees and less than or equal to 40 degrees. The stop position of the firing pin 131 is close to the top dead center position, and the starting load of the motor is low. It is to be noted that the stop position marked in FIG. 13 is not the only possible stop position. As long as the starting load of the motor 160 is relatively low at the stop position, the specific stop position is not limited here.

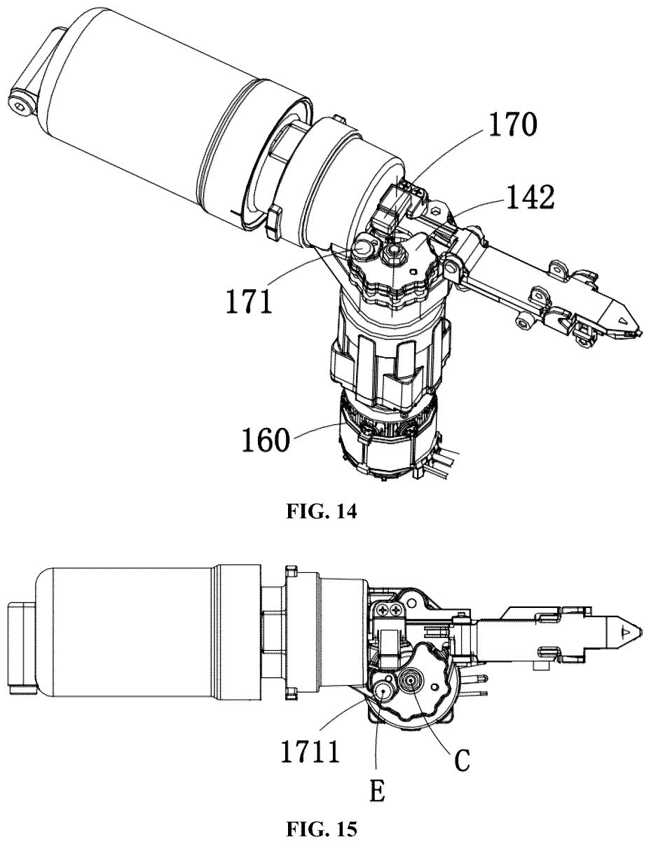

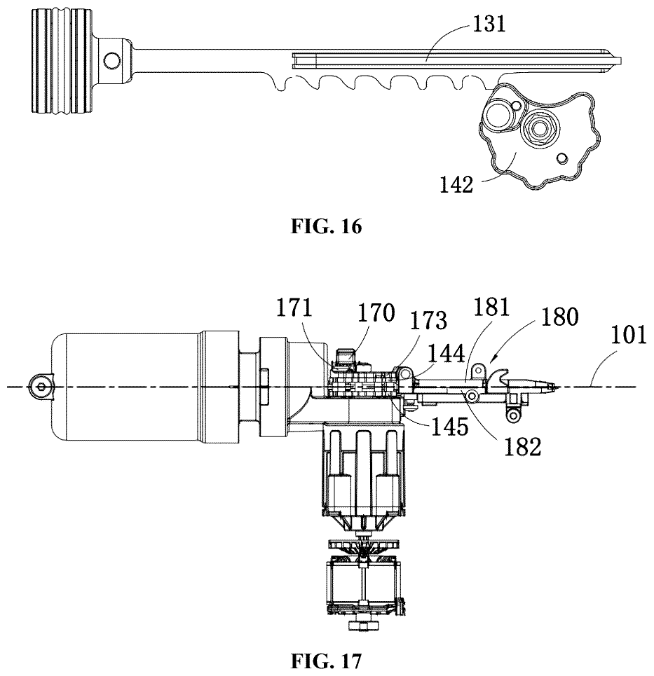

As shown in FIG. 6 and FIGS. 14 to 17, the fastener driver 100 includes a control device. The control device includes a controller 172. The controller 172 is configured to be connected to the motor 160 and a detection mechanism 170. The controller 172 is connected to the motor 160 and the detection mechanism 170 separately so that signals can be sent and received between the controller 172, the motor 160, and the detection mechanism 170. The detection mechanism 170 is configured to detect the position of a moving part 171. After the moving part 171 reaches the first preset position range and is within the first preset position range, the detection mechanism 170 may continuously send detection signals until the moving part 171 is outside the first preset position range. The detection mechanism 170 sends the detection signal to allow the controller to send the control signal. In this example, the detection mechanism 170 includes a Hall sensor. The moving part 171 is a magnetic element 1711, specifically a cylindrical magnet. In some examples, the detection mechanism 170 may be a potentiometer or another mechanism that can detect the position of the moving part 171, and the moving part 171 may be another part that can be detected by the detection mechanism 170.

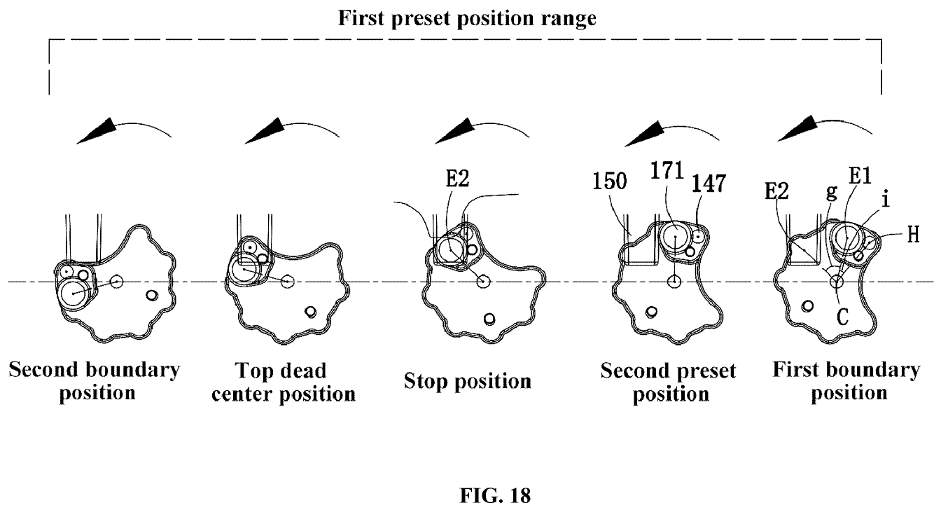

As shown in FIG. 18, the firing pin 131 may move to the stop position. When the firing pin 131 is at the stop position, the moving part 171 has a corresponding position to which the moving part 171 moves. When the firing pin 131 is at the stop position, the position to which the moving part 171 moves correspondingly is also collectively referred to as the stop position. The moving part 171 reaches the second preset position before reaching the stop position. That is to say, the second preset position is between the bottom dead center position and the stop position. When the moving part 171 reaches the second preset position, the controller 172 sends the control signal. Alternatively, the firing pin 131 moves backward from the bottom dead center. The controller 172 sends the control signal at the first preset time before the moving part 171 reaches the stop position. After the moving part 171 reaches the first preset position range, the detection mechanism 170 may sense the moving part 171, and the detection mechanism 170 can send the detection signal to allow the controller 172 to send the control signal. When the moving part 171 reaches the second preset position or at the first preset time before the moving part 171 reaches the stop position, the controller 172 sends the control signal to control the motor. The first preset position range has a first boundary position and a second boundary position, and the first boundary position is on a side of the second boundary position facing the bottom dead center position. The first boundary position and the second boundary position define the first preset position range. The first boundary position may be regarded as an extreme detection position of the detection mechanism 170. The second preset position may coincide with the first boundary position of the first preset position or may be within the first preset position range. The controller 172 sends the control signal at the first preset time before the moving part 171 reaches the stop position. The position of the moving part 171 at the first preset time before the moving part 171 reaches the stop position may coincide with the first boundary position of the first preset position range or may be within the first preset position range.

When the moving part 171 reaches the first preset position range, the detection mechanism 170 can detect the moving part 171 and send the detection signal. In the case where the position of the detection mechanism 170 remains unchanged, the farther the first boundary position is from the detection mechanism 170, the larger the first preset position range is, and the stronger the detection capability of the detection mechanism 170 is, or the stronger the capability of the moving part 171 to be detected by the detection mechanism 170 is. When the moving part 171 reaches the second preset position, the controller 172 sends the control signal to control the motor 160 to rotate by a preset number of rotations before braking or to control the motor 160 to brake after the second preset time.

The detection mechanism 170 can detect the moving part 171 after the moving part 171 reaches the first preset position range. The detection mechanism 170 can continuously detect the moving part 171 within the first preset position range. When the moving part 171 reaches the first preset position range, the detection mechanism 170 starts to be capable of detecting the moving part 171 and starts to allow the controller 172 to send the control signal. At the second preset position, the controller 172 sends the control signal to control the motor 160. Since the second preset position is in front of the stop position, in the case where the detection mechanism 170 allows the controller 172 to send the signal, after the controller 172 sends the control signal, the controller 172 may control the motor 160 to braking after a certain preset condition is satisfied, and the firing pin 131 finally stops at the stop position. In this manner, sufficient time is reserved for the controller 172 to brake the motor 160. The controller 172 may brake the motor 160 within a relatively long position range or time range before stopping. After the preset condition is satisfied, the controller 172 finally brakes the motor 160 accurately, and the stop position of the motor 160 is accurate and controllable.

As shown in FIGS. 15 and 18, the moving part 171 has a center point E. It is defined that an angle between a line connecting the center point E of the moving part 171 at the stop position and the rotation point C of the driving member 142 and a line connecting the center point E of the moving part 171 at the first boundary position and the rotation point C of the driving member 142 is the angle g. In FIG. 18, the center point E at the first boundary position and the center point E at the stop position are denoted by E1 and E2, respectively. The angle g is greater than or equal to 10 degrees and less than or equal to 60 degrees. In some examples, the angle g is greater than or equal to 15 degrees and less than or equal to 50 degrees. In some examples, the angle g is greater than or equal to 20 degrees and less than or equal to 40 degrees. In some examples, the angle g is greater than or equal to 30 degrees and less than or equal to 35 degrees.

The controller 172 sends the control signal at the first preset time before the moving part 171 reaches the stop position. Counting back the first preset time from the time when the moving part 171 reaches the stop position, the moving part 171 is within the first preset position range or has just reached the first boundary position. In some examples, the first preset time is greater than or equal to 20 ms and less than or equal to 30 ms. In some examples, the first preset time is greater than or equal to 22 ms and less than or equal to 28 ms. In some examples, the first preset time is greater than or equal to 24 ms and less than or equal to 26 ms. In some examples, the first preset time is greater than or equal to 10 ms and less than or equal to 50 ms. In some examples, the first preset time is greater than or equal to 15 ms and less than or equal to 40 ms.

During the operation of the fastener driver 100, the fastener driver 100 stops frequently. The first driving tooth 147 and the first meshing tooth 134 may wear out after multiple stops. When the angle g is greater than or equal to 10 degrees and less than or equal to 60 degrees or the first preset time is greater than or equal to 20 ms and less than or equal to 30 ms, the detection mechanism 170 may allow the controller 172 to send the control signal. In this manner, the detection range of the detection mechanism 170 is larger. When the detection mechanism 170 can detect the moving part 171 and send the detection signal, the firing pin 131 is farther from the stop position. Before the firing pin 131 stops at the stop position, in other words, before the motor 160 stops rotating, the detection mechanism 170 has sufficient time to send the detection signal. The controller 172 also has sufficient time to brake the motor 160. The controller 172 may control the motor 160 in advance when the striking assembly 130 is farther from the stop position so that the controller 172 controls the motor 160 for a longer time. In this manner, even if the first driving tooth 147 and the first meshing tooth 134 wear out, the stop position is changed from the initial stop position, and the controller 172 may dynamically adjust the stop position such that the stop position is always at an ideal position. After the first driving tooth 147 and the first meshing tooth 134 wear out, the stop position is closer to the top dead center position, and the fastener driver 100 is prone to double striking, causing safety hazards and inconvenience in use. The detection mechanism 170 allows the controller 172 to send the control signal in advance. The controller 172 may dynamically control the motor 160 in advance when the striking assembly 130 is away from the stop position so that the stop position is always ideal, and the fastener driver 100 is convenient and safe to use.

The first driving tooth 147 has the center point H. An angle i between a line connecting the center point E of the moving part 171 and the center of rotation C of the driving member 142 and a line connecting the center point H of the first driving tooth 147 and the center of rotation C of the driving member 142 is greater than or equal to 5 degrees and less than or equal to 30 degrees. In some examples, the angle i is greater than or equal to 7 degrees and less than or equal to 27 degrees. In some examples, the angle i is greater than or equal to 10 degrees and less than or equal to 25 degrees. The angle i is greater than or equal to 5 degrees and less than or equal to 30 degrees, and the moving part 171 is farther from the first driving tooth 147 so that a sufficient distance exists between the first preset position and the stop position. The first preset position is at a relatively long distance in front of the stop position, and the controller 172 is allowed to perform other controls on the motor 160 before controlling the motor 160 to brake, for example, controlling the number of rotations, rotation time, deceleration, soft braking, and the like, so that the motor 160 stops at the ideal position.

In this example, the Hall sensor may detect the magnetic field lines of the magnetic element 1711 at the first preset position. The surface magnetic field strength of the magnetic element 1711 is greater than or equal to 2800 Gs and less than or equal to 3600 Gs. In some examples, the surface magnetic field strength of the magnetic element 1711 is greater than or equal to 3000 Gs and less than or equal to 3400 Gs. In some examples, the surface magnetic field strength of the magnetic element 1711 is greater than or equal to 3100 Gs and less than or equal to 3300 Gs. The surface magnetic field strength of the magnetic element 1711 is strong, and the magnetic field lines cover a large range and a long distance. In this manner, the detection mechanism 170 can detect the moving part 171 earlier, and the controller 172 has time to dynamically adjust the stop position so that the stop position is always at an ideal position.

The stroke distance of the firing pin 131 moving from the first preset position range to the stop position is greater than or equal to 4 mm and less than or equal to 10 mm. In some examples, the stroke distance of the firing pin 131 moving from the first preset position range to the stop position is greater than or equal to 5 mm and less than or equal to 9 mm. In some examples, the stroke distance of the firing pin 131 moving from the first preset position range to the stop position is greater than or equal to 6 mm and less than or equal to 8 mm. The stroke distance of the firing pin 131 moving from the first preset position range to the stop position is long, and the detection range of the detection mechanism 170 is large.

After sending the control signal, the controller 172 controls the motor 160 to rotate by a preset number of rotations before braking. In some examples, the preset number of rotations is greater than or equal to 1 and less than or equal to 5. In some examples, the preset number of rotations is greater than or equal to 2 and less than or equal to 4. In some examples, the preset number of rotations is greater than or equal to 2 and less than or equal to 3. The controller 172 may adjust the preset number of rotations according to actual conditions so that after the motor 160 rotates by the preset number of rotations, the controller 172 brakes the motor 160, the motor 160 continues rotating by a certain number of rotations during braking and then stops, and the stop position is ideal.

After the controller 172 sends the control signal, braking is performed after the second preset time. The second preset time is greater than or equal to 4 ms and less than or equal to 20 ms. In some examples, the second preset time is greater than or equal to 6 ms and less than or equal to 18 ms. In some examples, the second preset time is greater than or equal to 8 ms and less than or equal to 16 ms. In some examples, the second preset time is greater than or equal to 10 ms and less than or equal to 14 ms. The controller 172 may adjust the second preset time according to actual conditions so that after the motor 160 rotates for the second preset time, the controller 172 brakes the motor 160, the motor 160 continues rotating for a certain period of time and then stops, and the stop position is ideal.

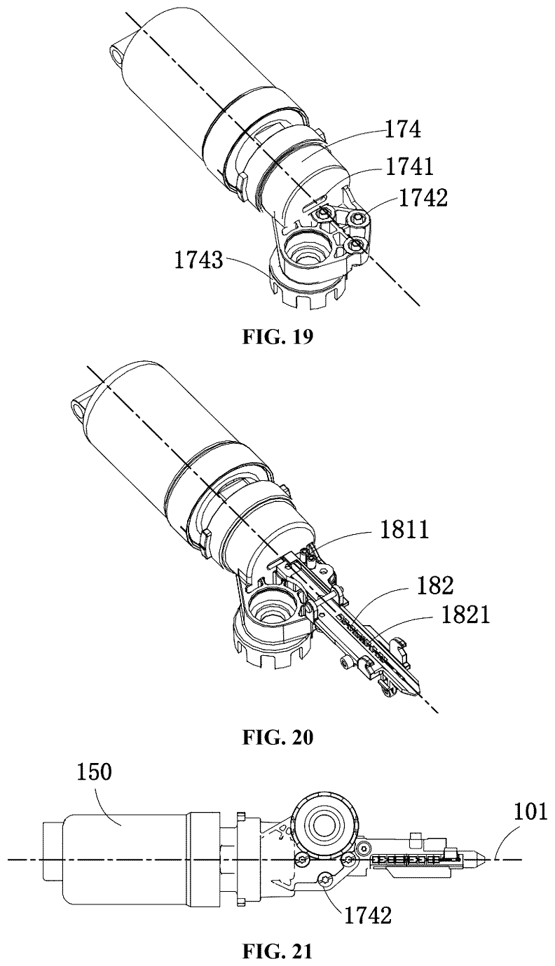

As shown in FIG. 17 and FIGS. 19 to 21, the driving member 142 includes a moving part fixing layer 173. The moving part fixing layer 173 is fixedly mounted on the first fixing layer 144 and rotates synchronously with the first fixing layer 144 and the second fixing layer 145. The moving part 171 is fixedly mounted on the moving part fixing layer 173 and rotates synchronously with the moving part fixing layer 173. The fastener driver 100 includes a guide assembly for guiding the fastener 10 to move along the first straight line 101. The fastener connects with at least part of the magazine 120 so that the fastener 10 is allowed to move from the magazine 120 to input ports.

The fastener driver 100 includes a support frame 174. The support frame 174 connects the energy storage device 150 to the guide assembly 180. The support frame 174 is fixedly connected to the energy storage device 150, and the guide assembly 180 is fixedly connected to the support frame 174. The support frame 174 is fixedly connected to both the energy storage device 150 and the guide assembly 180 so that the energy storage device 150 and the guide assembly 180 have a high degree of coaxiality. The guide assembly 180 includes a first guide member 181 and a second guide member 182. The second guide member 182 includes input ports 1821. The input ports 1821 connects with at least part of the magazine 120. The support frame 174 includes a through hole 1741. The firing pin 131 can pass through the through hole 1741 to move from the energy storage device 150 to the guide assembly 180, and the fastener 10 is guided by the guide assembly 180 and driven out. The support frame 174 includes first mounting portions 1742. The guide assembly 180 is mounted on the support frame 174 via the first mounting portions 1742. The first mounting portion 1742 is configured to be a fixing screw. The screw passes through the guide assembly 180 and is fixed to the first mounting portion 1742. Multiple first mounting portions 1742 may be provided. The through hole has a center. At least part of the through hole 1741 and at least one of the multiple first mounting portions 1742 are located on the first straight line 101. In this example, three first mounting portions 1742 are provided, and the center of the through hole 1741 and two first mounting portions 1742 are located on the first straight line 101. In this manner, the energy storage device 150, the firing pin 131, and the guide assembly 180 are easy to assemble, low in cost, and high in process accuracy. When the firing pin 131 is on the energy storage device 150 and the guide assembly 180, the firing pin 131 always moves along the first straight line 101, and the guidance is more accurate.

In this example, the guide assembly 180 includes a second mounting portion 1811 for mounting the detection mechanism 170. The second mounting portion 1811 includes a protrusion formed on the first guide member 181. The detection mechanism 170 is fixedly mounted on the second mounting portion 1811 via screws. The support frame 174 includes a third mounting portion 1743. The third mounting portion 1743 is used for mounting the gearset 141 and the driving member 142. The driving member 142 is rotatably fixed on the third mounting portion 1743 via a bearing. The third mounting portion 1743 includes a tooth-shaped protrusion formed on the support frame 174. The detection mechanism 170 is mounted to the guide assembly 180, the guide assembly 180 is fixedly connected to the support frame 174, the driving member 142 is mounted to the support frame 174, and the moving part 171 is fixedly mounted to the driving member 142. In this manner, the positional relationship between the detection mechanism 170 and the rotary shaft of the driving member 142 is fixed so that the detection mechanism 170 can accurately identify the position of the moving part 171 with reduced errors.

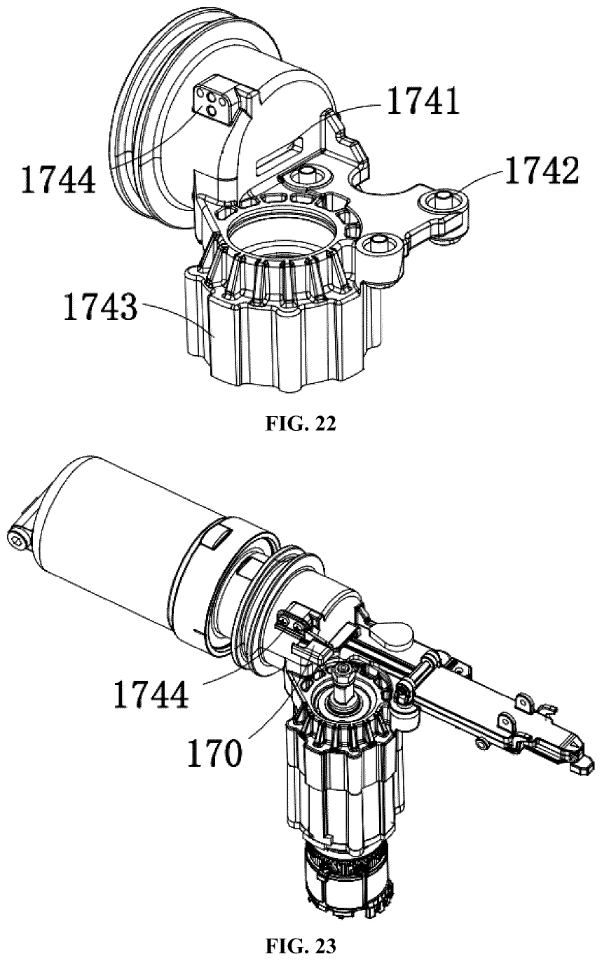

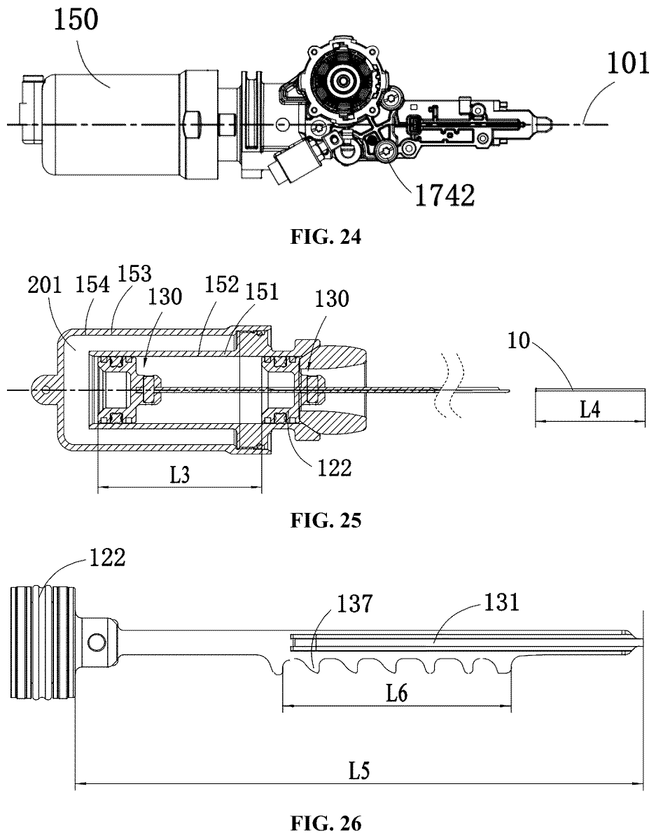

As shown in FIGS. 22 to 24, in some examples, the detection mechanism 170 is not mounted on the guide assembly 180 but is directly mounted on the support frame 174. The support frame 174 includes a fourth mounting portion 1744 for mounting the detection mechanism 170. The fourth mounting portion 1744 includes a protrusion formed on the support frame 174. The detection mechanism 170 is fixedly mounted on the fourth mounting portion 1744 via screws. The detection mechanism 170 and the driving member 142 are both mounted on the support frame 174, and the positional relationship between the detection mechanism 170 and the rotary shaft of the driving member 142 is fixed so that the detection mechanism 170 can accurately identify the position of the moving part 171 with reduced errors. The energy storage device 150, the guide assembly 180, the detection mechanism 170, and the driving member 142 are all positioned by the support frame 174 so that the simple assembly, compact structure, and accurate positioning can be ensured, and the energy storage device 150 and the guide assembly 180 have a high degree of coaxiality.

As shown in FIG. 25, the distance between the top dead center position and the bottom dead center position is defined as the stroke L3 of the striking assembly 130. The fastener driver 100 may drive the fastener 10 within a preset length L4 to move. The ratio of the stroke L3 of the striking assembly 130 to the preset length L4 is less than or equal to 1.5. In some examples, the ratio of the stroke L3 of the striking assembly 130 to the preset length L4 is less than or equal to 1.49, 1.48, 1.47, 1.46, 1.45, 1.44, 1.43, 1.42, 1.41, or 1.4. In some examples, the ratio of the stroke L3 of the striking assembly 130 to the preset length L4 is greater than or equal to 1.4 and less than or equal to 1.49. In some examples, the ratio of the stroke L3 of the striking assembly 130 to the preset length L4 is greater than or equal to 1.41 and less than or equal to 1.46. In some examples, the ratio of the stroke L3 of the striking assembly 130 to the preset length L4 is greater than or equal to 1.42 and less than or equal to 1.45. The ratio of the preset length L4 of the fastener 10 to the stroke L3 of the striking assembly 130 is relatively small. The stroke L3 of the striking assembly 130 is relatively short, but the fastener driver 100 can drive out a relatively long fastener 10. The length of the fastener driver 100 is short.

The stroke L3 is less than or equal to 80 mm. In some examples, the stroke L3 is less than or equal to 85 mm, 84 mm, 83 mm, 82 mm, 81 mm, 79 mm, 78 mm, 77 mm, 76 mm, 75 mm, 74 mm, 73 mm, or 72 mm. In some examples, the stroke L3 is greater than or equal to 74 mm and less than or equal to 82 mm. In some examples, the stroke L3 is greater than or equal to 76 mm and less than or equal to 80 mm. The stroke L3 is relatively short so that the length of the fastener driver 100 is relatively short.

The preset length L4 is greater than or equal to 50 mm. In some examples, the preset length L4 is greater than or equal to 51 mm, 52 mm, 53 mm, 54 mm, 55 mm, 56 mm, 57 mm, or 58 mm. In some examples, the preset length L4 is greater than 50 mm and less than or equal to 58 mm. In some examples, the preset length L4 is greater than or equal to 51 mm and less than or equal to 56 mm. The preset length L4 is relatively large, and the fastener driver 100 can drive out a relatively long fastener 10.

As shown in FIG. 26, the length L5 of the firing pin 131 is less than or equal to 165 mm. In some examples, the length L5 of the firing pin 131 is less than or equal to 164 mm, 163 mm, 162 mm, 161 mm, 160 mm, 159 mm, 158 mm, 157 mm, 156 mm, or 155 mm. In some examples, the length L5 of the firing pin 131 is greater than or equal to 155 mm and less than or equal to 165 mm. In some examples, the length L5 of the firing pin 131 is greater than or equal to 156 mm and less than or equal to 162 mm. The length L5 of the firing pin 131 is short so that the length of the fastener driver 100 is relatively short.

The firing pin 131 includes a toothed portion 137. The portion of the body portion 132 where teeth are provided is the toothed portion 137. The portion of the body portion 132 from the first meshing tooth 134 to the seventh meshing tooth 136 that is in contact with the driving member 142 is the toothed portion 137. The ratio of the length L6 of the toothed portion 137 to the preset length L4 is less than or equal to 1.21. In some examples, the ratio of the length L6 of the toothed portion 137 to the preset length L4 is less than or equal to 1.23, 1.22, 1.2, or 1.19. In some examples, the ratio of the length L6 of the toothed portion 137 to the preset length L4 is greater than or equal to 1.19 and less than or equal to 1.23. In some examples, the ratio of the length L6 of the toothed portion 137 to the preset length L4 is greater than or equal to 1.2 and less than or equal to 1.22. The length L6 of the toothed portion 137 is relatively short so that the length L5 of the firing pin 131 is relatively short.

As shown in FIG. 4, the length L7 of the guide assembly 180 is less than or equal to 108 mm. In some examples, the length L7 of the guide assembly 180 is less than or equal to 113 mm, 112 mm, 111 mm, 110 mm, 109 mm, 107 mm, 106 mm, 105 mm, 104 mm, or 103 mm. In some examples, the length L7 of the guide assembly 180 is greater than or equal to 103 mm and less than or equal to 113 mm. In some examples, the length L7 of the guide assembly 180 is greater than or equal to 104 mm and less than or equal to 110 mm. The guide assembly 180 is relatively short so that the length of the fastener driver 100 is relatively short.

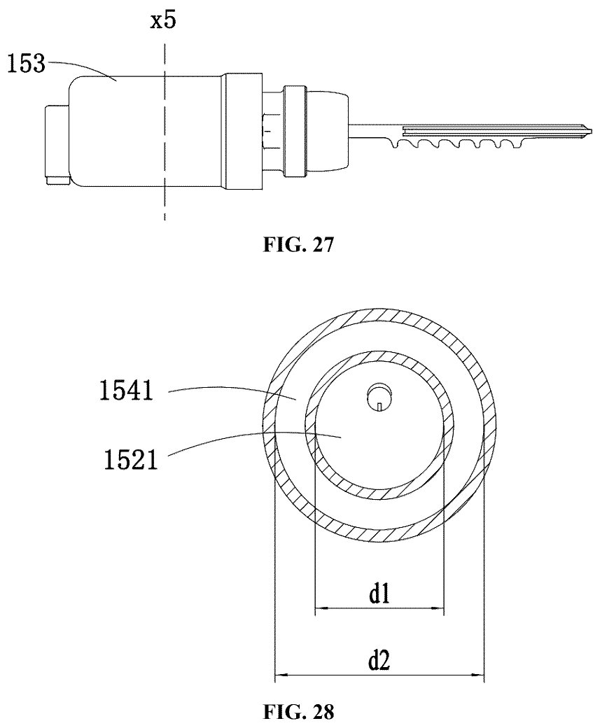

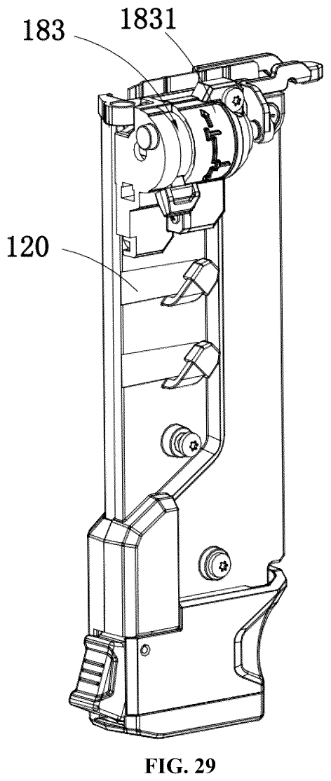

As shown in FIGS. 25, 27, and 28, the first cylinder 151 includes a first inner wall 152. When the piston 122 moves in the first cylinder 151, the first inner wall 152 is in contact with the piston 122. The first inner wall 152 has a circular first cross section 1521. The ratio of the stroke L3 of the firing pin 131 to the diameter d1 of the first cross section 1521 is greater than or equal to 1.7 and less than or equal to 2.8. In some examples, the ratio of the stroke L3 of the firing pin 131 to the diameter d1 of the first cross section 1521 is greater than or equal to 1.9 and less than or equal to 2.7. In some examples, the ratio of the stroke L3 of the firing pin 131 to the diameter d1 of the first cross section 1521 is greater than or equal to 2.1 and less than or equal to 2.6. In some examples, the ratio of the stroke L3 of the firing pin 131 to the diameter d1 of the first cross section 1521 is less than or equal to 2.5, 2.45, 2.4, 2.35, 2.3, 2.25, 2.2, 2.1, 2, 1.9, or 1.8. The ratio of the stroke L3 of the firing pin 131 to the diameter d1 of the first cross section 1521 is relatively small, and the diameter d1 is greater than the stroke L3.

The diameter of the driving member 142 is defined as the diameter of a circle formed by connecting the centers of the multiple driving teeth 143. The ratio of the diameter d1 of the first cross section 1521 to the diameter of the driving member 142 is greater than or equal to 0.9 and less than or equal to 1. In some examples, the ratio of the diameter d1 of the first cross section 1521 to the diameter of the driving member 142 is greater than or equal to 1 and less than or equal to 1.1. The ratio of the diameter of the driving member 142 to the stroke L3 of the firing pin 131 is greater than or equal to 0.37 and less than or equal to 0.41. In some examples, the ratio of the diameter of the driving member 142 to the stroke L3 of the firing pin 131 is greater than or equal to 0.38 and less than or equal to 0.4.

The energy storage device includes a second cylinder 153. At least part of the first cylinder 151 is accommodated in the second cylinder 153. The second cylinder 153 includes a second inner wall 154. The second inner wall 154 has a circular second cross section 1541. The ratio of the diameter d1 of the first cross section 1521 to the diameter d2 of the second cross section 1541 is greater than or equal to 0.6 and less than or equal to 0.7. In some examples, the ratio of the diameter d1 of the first cross section 1521 to the diameter d2 of the second cross section 1541 is greater than or equal to 0.6 and less than or equal to 0.65. In some examples, the ratio of the diameter d1 of the first cross section 1521 to the diameter d2 of the second cross section 1541 is greater than or equal to 0.5 and less than or equal to 0.7. In some examples, the ratio of the diameter d1 of the first cross section 1521 to the diameter d2 of the second cross section 1541 is greater than or equal to 0.53 and less than or equal to 0.63.

The diameter d1 of the first cross section 1521 is greater than or equal to 28 mm and less than or equal to 36 mm. In some examples, the diameter d1 of the first cross section 1521 is greater than or equal to 29 mm and less than or equal to 35 mm. In some examples, the diameter d1 of the first cross section 1521 is greater than or equal to 30 mm and less than or equal to 34 mm. The product of the first cross section 1521 of the first cylinder 151 and the stroke L3 is the gas displacement when the piston 122 moves from the bottom dead center position to the top dead center position in the first cylinder 151. The diameter d1 of the first cross section 1521 is relatively large, and the gas displacement is relatively large.

The ratio of the striking energy outputted by the fastener driver 100 to the gas displacement is greater than or equal to 0.3 J/cm³ and less than or equal to 0.7 J/cm³. In some examples, the ratio of the striking energy outputted by the fastener driver 100 to the gas displacement is greater than or equal to 0.35 J/cm³ and less than or equal to 0.65 J/cm³. In some examples, the ratio of the striking energy outputted by the fastener driver 100 to the gas displacement is greater than or equal to 0.4 J/cm³ and less than or equal to 0.6 J/cm³. In some examples, the ratio of the striking energy outputted by the fastener driver 100 to the gas displacement is greater than or equal to 0.45 J/cm³ and less than or equal to 0.55 J/cm³. The striking energy corresponding to the gas displacement per unit is relatively large so that the working efficiency of the fastener driver 100 is high.

The gas displacement is greater than or equal to 54 cm³ and less than or equal to 71 cm³. In some examples, the gas displacement is greater than or equal to 58 cm³ and less than or equal to 68 cm³. In some examples, the gas displacement is greater than or equal to 60 cm³ and less than or equal to 66 cm³.

The diameter d2 of the second cross section 1541 is greater than or equal to 47 mm and less than or equal to 57 mm. In some examples, the diameter d2 of the second cross section 1541 is greater than or equal to 50 mm and less than or equal to 54 mm. In some examples, the diameter d2 of the second cross section 1541 is greater than or equal to 51 mm and less than or equal to 53 mm. In some examples, the diameter d2 of the second cross section 1541 is greater than or equal to 45 mm and less than or equal to 60 mm.

The second cylinder 153 has a volume. The volume is greater than or equal to 152 cm³ and less than or equal to 186 cm³. In some examples, the volume is greater than or equal to 157 cm³ and less than or equal to 181 cm³. In some examples, the volume is greater than or equal to 160 cm³ and less than or equal to 178 cm³. In some examples, the volume is greater than or equal to 165 cm³ and less than or equal to 173 cm³.

The ratio of the volume to the gas displacement is greater than or equal to 1.5 and less than or equal to 1.83. In some examples, the ratio of the volume to the gas displacement is greater than or equal to 1.6 and less than or equal to 1.73. In some examples, the ratio of the volume to the gas displacement is greater than or equal to 1.65 and less than or equal to 1.68.

As shown in FIG. 2, the length L8 of the fastener driver 100 in the front and rear direction is less than or equal to 295 mm. In some examples, the length L8 of the fastener driver 100 in the front and rear direction is less than or equal to 294 mm, 293 mm, 292 mm, 291 mm, 290 mm, 289 mm, 288 mm, 287 mm, or 286 mm. The fastener driver 100 is short in length, small in size, light in weight, and convenient and labor-saving to use.

When the battery pack 115 is not mounted, the weight of the fastener driver 100 is less than or equal to 2.3 kg. In some examples, the weight of the fastener driver 100 is less than or equal to 2.29 kg, 2.28 kg, 2.27 kg, 2.26 kg, 2.25 kg, 2.24 kg, 2.23 kg, or 2.22 kg. When the battery pack 115 is mounted, the weight of the fastener driver 100 is less than or equal to 2.9 kg. In some examples, the weight of the fastener driver 100 to which the battery pack 115 is mounted is less than or equal to 2.91 kg, 2.89 kg, 2.88 kg, 2.87 kg, or 2.86 kg. The fastener driver 100 is light in weight and convenient and comfortable for the user to use.

When the battery pack 115 is not mounted, the ratio of the weight of the fastener driver 100 to the length L8 in the front and rear direction is less than or equal to 0.078 kg/cm. In some examples, the ratio of the weight of the fastener driver 100 to the length L8 in the front and rear direction is less than or equal to 0.077 kg/cm, 0.076 kg/cm, 0.075 kg/cm, or 0.074 kg/cm. The fastener driver 100 has high output power, is short in length, is small in size, and is convenient to use.

When the battery pack 115 is not mounted, the ratio of the output power of the fastener driver 100 to the length L8 in the front and rear direction is greater than or equal to 11.3 W/cm. In some examples, the ratio of the output power of the fastener driver 100 to the length L8 in the front and rear direction is greater than or equal to 11.6 W/cm, 11.5 W/cm, 11.4 W/cm, 11.2 W/cm, or 11.1 W/cm. The ratio of the output power to the weight of the fastener driver 100 is greater than or equal to 150 W/kg. In some examples, the ratio of the output power to the weight of the fastener driver 100 is greater than or equal to 160 W/kg, 157 W/kg, 155 W/kg, 152 W/kg, 147 W/kg, 145 W/kg, 142 W/kg, or 140 W/kg. The fastener driver 100 has high output power and is light in weight so that it is convenient for the user to hold the fastener driver 100 by hand for a long time.

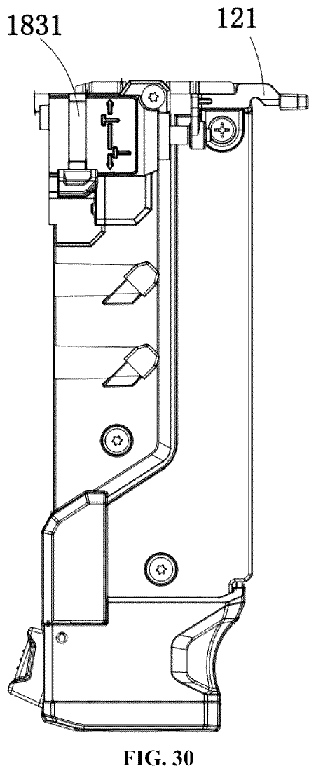

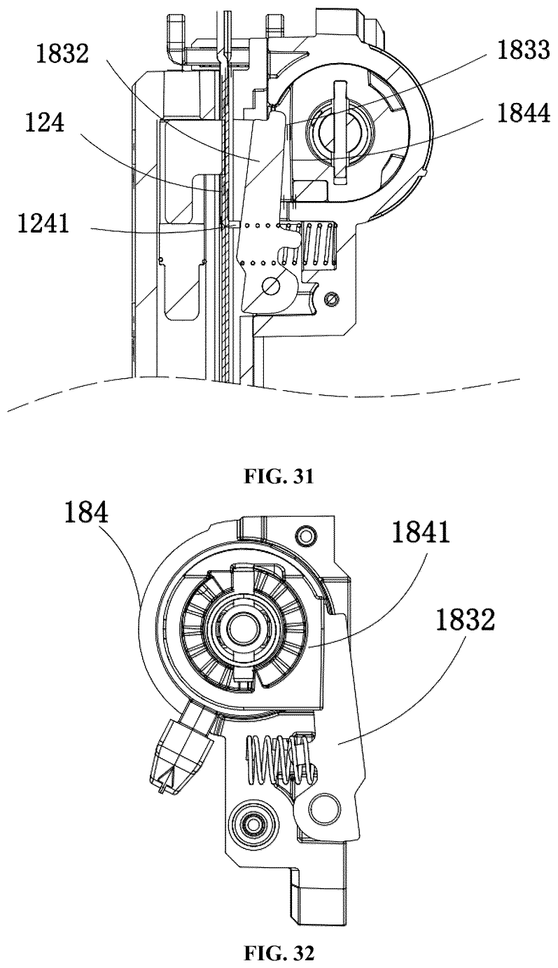

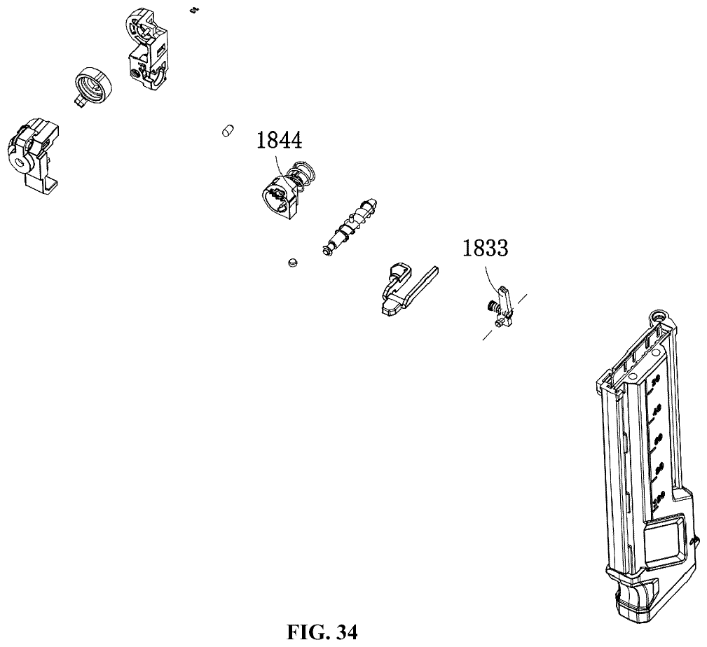

As shown in FIGS. 29 to 34, the fastener driver 100 includes an anti-dry fire assembly 183. The anti-dry fire assembly 183 is configured to prevent potential hazards caused by the firing pin 131 firing without the fastener 10 when the fasteners 10 are exhausted. The fastener driver 100 includes a lifting member 124. The lifting member 124 arranges a column of fasteners 10 closely in the magazine 120 in the up and down direction by the elastic force. The elastic force is generated by an elastic member, such as a spring or a coil spring. The lifting member 124 is configured to drive the fastener 10 to move so that the fastener 10 can pass through the input ports. After one fastener 10 is driven out, the force of the lifting member 124 acts on the fastener 10, and the fastener 10 is lifted upward by the lifting member 124. The topmost fastener 10 in a column of fasteners 10 passes through the input ports to wait to be driven out by the firing pin 131. The anti-dry fire assembly 183 implements the anti-dry fire function through the position change of the lifting member 124.

The magazine 120 is adjacent to the main housing 111. The anti-dry fire assembly 183 is disposed on the upper and outward side of the magazine 120, so the interference from external objects can easily cause the anti-dry fire assembly 183 to fail. The anti-dry fire assembly 183 includes an anti-dry fire assembly housing 1831. At least part of the anti-dry fire assembly housing 1831 is disposed on the outer side of the anti-dry fire assembly 183 to prevent the anti-dry fire assembly 183 from being interfered with by external objects. In this example, the anti-dry fire assembly housing 1831 basically seals and wraps the anti-dry fire assembly 183 so that the anti-dry fire assembly 183 can be effectively prevented from being interfered with by external objects or getting dusty, thereby extending the service life of the fastener driver 100.

As shown in FIGS. 32 to 34, the fastener driver 100 includes a depth adjustment assembly 184. The depth adjustment assembly 184 includes a gear part 1841, a push rod 1842, and a trigger rod 1843. The trigger lever 121 is connected to the push rod 1842. The trigger lever 121 may be mounted to the push rod 1842 by means of a circlip, a protrusion and a recess, or a magnetic element, thereby facilitating the rapid replacement and installation of the trigger lever 121 when the trigger lever 121 is damaged. When the trigger lever 121 abuts against the workpiece and moves, the push rod 1842 moves along with the trigger lever 121. The push rod 1842 is configured to abut against the gear part 1841. The trigger rod 1843 is operated by the user to adjust the position where the push rod 1842 abuts against the gear part 1841 to adjust the nailing depth. The gear part 1841 includes a step structure against which the push rod 1842 abuts. The push rod 1842 is rotatably connected to the gear part 1841. When the push rod 1842 moves along the front and rear direction with the trigger lever 121, the push rod 1842 abuts against the gear part 1841 and drives the gear part 1841 to move along the front and rear direction. A magnet is mounted on the gear part 1841. A safety Hall sensor 185 is disposed in the anti-dry fire assembly 183. When the safety Hall sensor 185 detects the magnet, the safety switch is turned on, and the user may operate the fastener driver 100 to strike the fastener 10.

The anti-dry fire assembly 183 includes a stop block 1832. The stop block 1832 may rotate about a third straight line 103. The lifting member 124 includes a pushing portion 1241. The pushing portion 1241 is a protrusion formed on the lifting member 124 and protruding toward the stop block 1832. When the fasteners 10 are exhausted, the pushing portion 1241 moves to the upper side of the magazine 120 with the lifting member 124 and pushes the stop block 1832 to rotate about the third straight line 103. The stop block 1832 includes a first stop portion 1833. The gear part 1841 includes a second stop portion 1844. When the lifting member 124 pushes the stop block 1832 to rotate, the first stop portion 1833 abuts against the second stop portion 1844, and the stop block 1832 prevents the gear part 1841 from moving backward. The gear part 1841 cannot move backward, the push rod 1842 and the trigger lever 121 cannot move backward, and the safety switch cannot be turned on. The fastener driver 100 cannot operate when the fasteners 10 are exhausted, and the firing pin 131 cannot be driven out when the fasteners 10 are exhausted.

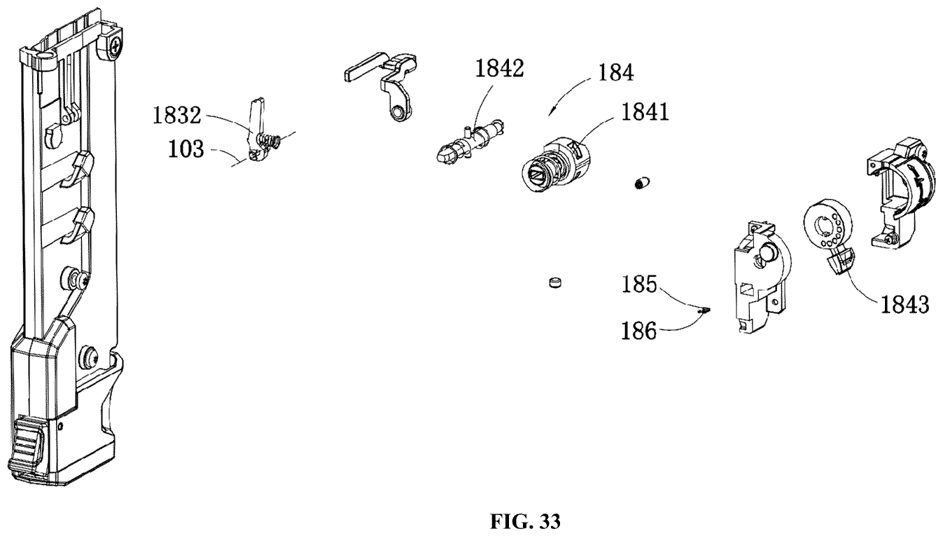

As shown in FIGS. 3 and 33, the fastener driver 100 includes light emission mechanisms 190. Multiple light emission mechanisms 190 may be provided. In some examples, an anti-dry fire Hall sensor 186 is further disposed in the anti-dry fire assembly 183. When the anti-dry fire Hall sensor 186 identifies the magnet on the gear part 1841 and the safety Hall sensor 185 does not detect the magnet, the light emission mechanism 190 changes the color or frequency of the light to prompt the user, which is convenient and safe to use.

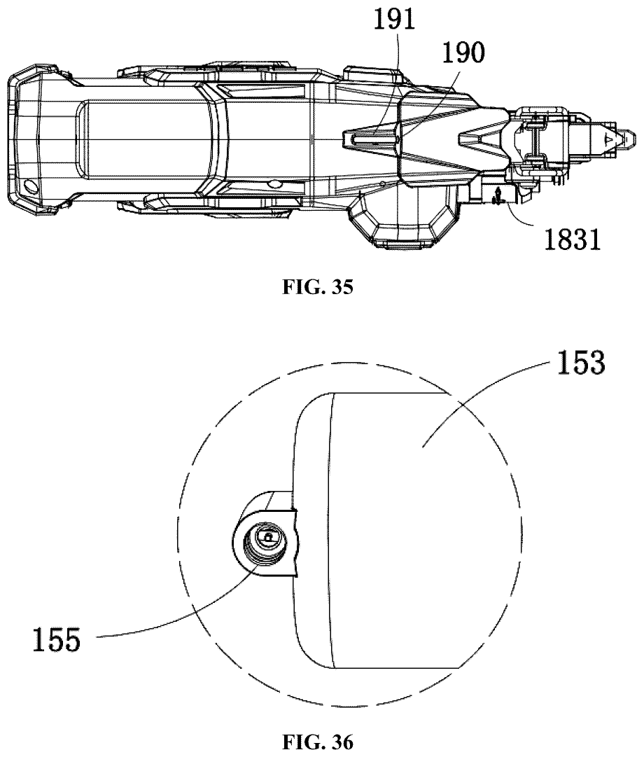

As shown in FIGS. 3, 4, and 35, at least one light emission mechanism 190 is mounted directly above the guide assembly 180. At least one light emission mechanism 190 located directly above the guide assembly 180 is mounted on the main housing 111. The main housing 111 includes a protective structure 191. The light emission mechanism 190 is mounted on the protective structure 191. In this example, the protective structure 191 is formed on the main housing 111. The protective structure 191 is formed with a horn-shaped upward protrusion to protect the light emission mechanism 190 from being damaged by impacts when the fastener driver 100 falls. The horn-shaped protrusion of the protective structure 191 is a V-shaped groove when viewed from the front. The light emitted by the light emission mechanism 190 is reflected by the V-shaped groove, projecting a V-shaped, arrow-shaped, or triangular light spot onto the workpiece to indicate the nailing position, which is convenient for the user. In some examples, the protective structure 191 can allow the light emission mechanism 190 to project a linear projection shape, a circular projection shape, or any other projection shape that can indicate the nailing position onto the workpiece.

In this example, the fastener driver 100 is a pre-inflated fastener driver and needs to be used after the energy storage device 150 is inflated. The air pressure in the energy storage device 150 is higher than atmospheric pressure so that the impact force of the fastener driver 100 is enhanced. The fastener driver 100 purchased by the user is generally pre-inflated by the manufacturer for use by the user. During use, the energy storage device 150 gradually leaks air, so the energy storage device 150 needs to be reinflated.

As shown in FIGS. 36 to 38, the energy storage device 150 includes a ventilation portion 155. The energy storage device 150 is inflated and deflated via the ventilation portion 155. The ventilation portion 155 is located at the rear of the second cylinder 153. The ventilation portion 155 includes a hole connecting with the interior of the energy storage device 150. The controller 172 controls the motor 160 to brake and controls the firing pin 131 to stop at the stop position. The stop position is between the top dead center position and the bottom dead center position. At the stop position, the striking assembly 130 still meshes with the driving member 142. When the striking assembly 130 reaches the top dead center position or when the striking assembly 130 moves backward and passes the top dead center position, the striking assembly 130 disengages from the driving member 142. The striking assembly 130 and the driving member 142 do not form a force interaction relationship, and the movement of the striking assembly 130 is not affected by the driving member 142.

The fastener driver 100 has an operating state and a maintenance state. In the operating state, the ventilation portion 155 does not connect with the atmosphere. During the use of the fastener driver 100, due to long-term vibrations, inevitable manufacturing tolerances, the storage environment, and other factors, a small amount of gas escapes from the energy storage device 150 to the atmosphere through the ventilation portion 155, causing the impact force of the fastener driver 100 to decrease. When the fastener driver 100 is not used for nailing, the striking assembly 130 stays at the stop position, and the striking assembly 130 meshes with the driving member 142. As shown in FIG. 6, the transmission mechanism 140 includes the clutch assembly 149. The clutch assembly 149 restricts the forward movement of the striking assembly 130 when the striking assembly 130 meshes with the driving member 142. The clutch assembly 149 includes a one-way clutch. When the fastener driver 100 is viewed from above, the driving member 142 rotates counterclockwise to drive the striking assembly 130 to move backward. The one-way clutch prevents the driving member 142 from rotating clockwise to prevent the striking assembly 130 from moving forward. At the stop position, the force applied by the compressed gas to the striking assembly 130 to make the striking assembly 130 tend to move forward is balanced by the force applied by the clutch assembly 149 to the striking assembly 130 to make the striking assembly 130 tend to move backward.

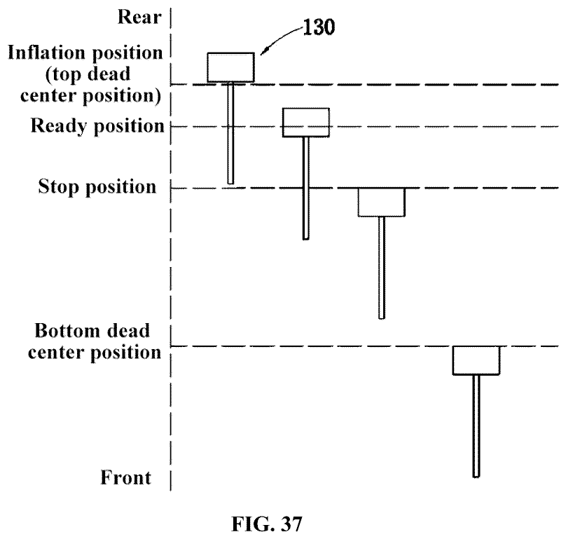

As shown in FIG. 37, in the maintenance state, the ventilation portion 155 may connect with the atmosphere in response to the operation of the user to allow the energy storage device 150 to inflate and deflate. The fastener driver 100 may be reinflated by the user or maintenance personnel. Before being inflated, the energy storage device 150 is deflated. Part of the gas in the energy storage device 150 is discharged into the atmosphere through the ventilation portion 155. The air pressure in the energy storage device 150 is reduced from a value higher than atmospheric pressure to a value basically equal to atmospheric pressure. The force applied by the compressed gas to the striking assembly 130 is reduced. The compressed gas is gradually converted into atmospheric gas, and the atmospheric gas in the energy storage device 150 no longer applies a force to the striking assembly 130. Since the force applied by the gas to the striking assembly 130 to make the striking assembly 130 tend to move forward gradually decreases to zero, the striking assembly 130 moves from the stop position toward the top dead center. Before the energy storage device 150 is inflated, the striking assembly 130 moves backward to and stays at a ready position which exceeds the stop position and is closer to the top dead center position. Alternatively, the striking assembly 130 moves backward to and stays at an inflation position that reaches or exceeds the top dead center position. By deflating the energy storage device 150 before inflating, the air pressure in the energy storage device 150 is reduced, thereby providing a possibility for inflating the energy storage device 150 safely.

If the energy storage device 150 is inflated when the striking assembly 130 meshes with the driving member 142, even if the energy storage device 150 is fully inflated, the striking assembly 130 does not move forward due to the blockage of the clutch assembly 149. The user may still continue inflating the energy storage device 150, but the excessive air pressure in the energy storage device 150 may cause danger during nailing. When the energy storage device 150 is deflated and then inflated again, the striking assembly 130 may directly reach or exceed the top dead center position after the energy storage device 150 is deflated, and the striking assembly 130 disengages from the driving member 142. In this manner, the user or maintenance personnel may inflate the energy storage device 150 without over-inflation or danger when the firing pin 131 is driven out.

In some examples, when the energy storage device 150 is deflated through the ventilation portion 155, the striking assembly 130 moves backward to and stays at the inflation position. The striking assembly 130 directly reaches or passes the top dead center position after the energy storage device 150 is deflated, thereby offering convenience in operation and saving energy. In some examples, after the energy storage device 150 is deflated, the striking assembly 130 moves to the ready position. The transmission mechanism 140 drives the striking assembly 130 to move from the ready position to the inflation position and stay at the inflation position. After the energy storage device 150 is deflated, the user presses the trigger to cause the dry firing of the fastener driver 100. The user may press the trigger once or multiple times. The motor 160 rotates and drives the driving member 142 to rotate. Since the air pressure in the energy storage device 150 is atmospheric pressure, no potential reaction force exists behind the striking assembly 130, and the driving member 142 may push the striking assembly from the ready position to the inflation position. The striking assembly 130 disengages from the driving member 142, and the energy storage device 150 may be safely inflated.

When the energy storage device 150 is inflated, as the air pressure in the energy storage device 150 gradually increases to exceed atmospheric pressure, the striking assembly 130 moves forward toward the bottom dead center position. As the energy storage device 150 continues being inflated, the striking assembly 130 moves forward to the bottom dead center position. When the inflation of the energy storage device 150 is completed, the striking assembly 130 stays at the bottom dead center position. The striking assembly 130 moves toward the bottom dead center as the energy storage device 150 is inflated. The striking assembly 130 moves slowly, the movement distance is controllable, and the inflation process is safe and reliable. When the inflation of the energy storage device 150 is completed, the striking assembly 130 stays at the bottom dead center position. After the user presses the trigger again, the firing pin 131 retracts instead of being driven out directly, which is not likely to cause danger and is safe to use.

The motor 160 brakes to stop the backward movement of the striking assembly 130. When the motor 160 brakes, the motor 160 is configured to rotate by a first number of braking rotations from the start of braking to the end of braking before the energy storage device 150 is inflated, that is, in the maintenance state. After the energy storage device 150 is inflated, that is, in the operating state, the motor 160 rotates by a second number of braking rotations from the start of braking to the end of braking. The difference between the first number of braking rotations and the second number of braking rotations is greater than or equal to 5 and less than or equal to 15. In some examples, the difference between the first number of braking rotations and the second number of braking rotations is greater than or equal to 6 and less than or equal to 12. In some examples, the difference between the first number of braking rotations and the second number of braking rotations is greater than or equal to 7 and less than or equal to 11. In some examples, the difference between the first number of braking rotations and the second number of braking rotations is about 9. In some examples, the first number of braking rotations is greater than or equal to 11 and less than or equal to 13. In some examples, the first number of braking rotations is about 12. In some examples, the second number of braking rotations is greater than or equal to 1 and less than or equal to 5. In some examples, the second number of braking rotations is greater than or equal to 2 and less than or equal to 4. In some examples, the second number of braking rotations is about 3.

The difference between the first number of braking rotations and the second number of braking rotations is controlled within a certain range so that when the motor 160 completes braking, the position of the driving member 142 is appropriate. In the maintenance state, the motor 160 drives the driving member 142 to rotate by a number of rotations such that the driving member 142 neither meshes with the striking assembly 130 due to too few rotations nor meshes with the striking assembly 130 due to too many rotations. The striking assembly 130 may move toward the bottom dead center during the inflation process without being hindered by the driving member 142.

In some examples, the fastener driver 100 includes a detection assembly for detecting the position of the striking assembly 130 relative to the inflation position. In this manner, the controller 172 may control the degree of inflation of the energy storage device 150. The fastener driver 100 further includes a display device for displaying the position of the striking assembly 130. In this manner, the user can accurately know the degree of inflation of the energy storage device 150.

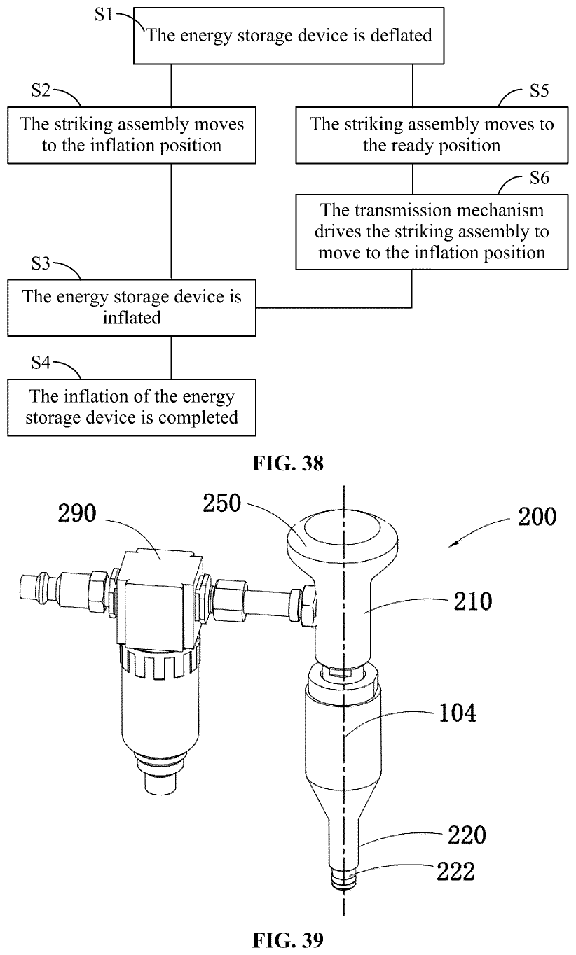

As shown in FIG. 38, the process of inflating the fastener driver 100 is described below. In S1, the energy storage device 150 is deflated. The striking assembly 130 moves backward from the stop position. In S2, if the striking assembly 130 moves to the inflation position, S3 is performed in which the energy storage device 150 is inflated. In S4, the striking assembly 130 moves to the bottom dead center, and the inflation of the energy storage device 150 is completed. After the energy storage device 150 is deflated in S1, in S5, if the striking assembly 130 moves to the ready position, S6 is performed in which the user presses the trigger and the transmission mechanism 140 drives the striking assembly 130 to move to the inflation position. Then, S3 is performed in which the energy storage device 150 is inflated. Finally, in S4, the striking assembly 130 moves to the bottom dead center, and the inflation of the energy storage device 150 is completed.

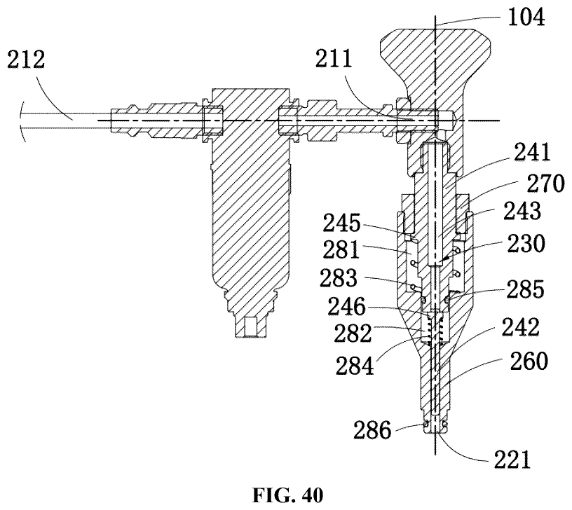

As shown in FIG. 25 and FIGS. 39 to 41, the fastener driver 100 needs to be used in conjunction with an inflation adapter 200 for inflation. The inflation adapter 200 is configured to inflate a device to be inflated, such as the fastener driver 100. After the energy storage device 150 leaks air, the working performance of the fastener driver 100 may deteriorate. By inflating the fastener driver 100 using the inflation adapter 200, the working performance of the fastener driver 100 may be restored. As shown in FIG. 25, the device to be inflated includes an air storage space 201. The air storage space 201 of the fastener driver 100 is a space that can store gas and is formed by the first cylinder 151, the second cylinder 153, and the piston 122 at the bottom dead center position. The inflation adapter 200 includes a first connection end 210 and a second connection end 220. The first connection end 210 is used for connecting an air source, such as pressurized or unpressurized air, nitrogen, or helium. The first connection end 210 is provided with an air inlet 211. The air source enters the inflation adapter 200 through the air inlet 211. The second connection end 220 is configured to be connected to the ventilation portion 155. When the second connection end 220 is connected to the ventilation portion 155, the inflation adapter 200 is connected to the fastener driver 100.

The inflation adapter 200 includes an air outlet 221. In this example, the air outlet 221 is disposed at the second connection end 220. The air outlet 221 connects with the ventilation portion 155 so that the gas from the air source flows into the inflation adapter 200 from the air inlet 211, flows through the inflation adapter 200, flows out from the air outlet 221, and then flows to the ventilation portion 155. The ventilation portion 155 connects with the air storage space 201, and the gas is finally stored in the air storage space 201. At least one airflow path for gas to flow exists between the air inlet 211 and the air storage space 201. The airflow path from the air inlet 211 to the air storage space 201 is defined as an inflation channel 230.

The second connection end 220 may move toward the ventilation portion 155 to an extreme position. When the second connection end 220 moves to the extreme position, the distance between the second connection end 220 and the ventilation portion 155 is gradually reduced. The second connection end 220 includes a meshing portion 222. The meshing portion 222 meshes with the ventilation portion 155 so that the inflation adapter 200 is connected to the fastener driver 100. When the second connection end 220 starts to mesh with the ventilation portion 155, the second connection end 220 and the ventilation portion 155 start to establish a connection relationship. When the second connection end 220 moves to the extreme position, the second connection end 220 and the ventilation portion 155 establish a tight connection relationship. The meshing portion 222 enables the second connection end 220 to stay at least at the extreme position. In this manner, when the second connection end 220 moves to the extreme position, the meshing portion 222 keeps the second connection end 220 at the extreme position, and a continuous and tight connection relationship is established between the second connection end 220 and the ventilation portion 155.

The meshing portion 222 is formed with threads. The ventilation portion 155 is also formed with threads. The meshing portion 222 meshes with the ventilation portion 155 via threads, and the second connection end 220 is kept at the extreme position relative to the ventilation portion 155 through the meshing of threads. The connection between the inflation adapter 200 and the fastener driver 100 is tight and reliable. In some examples, the ventilation portion 155 and the meshing portion 222 may mesh with each other in another manner such as a groove and a protrusion or magnetic elements. In some examples, a knurled structure is provided on the inflation adapter 200 so that the user can tighten the inflation adapter 200 onto the fastener driver 100 by hand easily, comfortably, and conveniently.

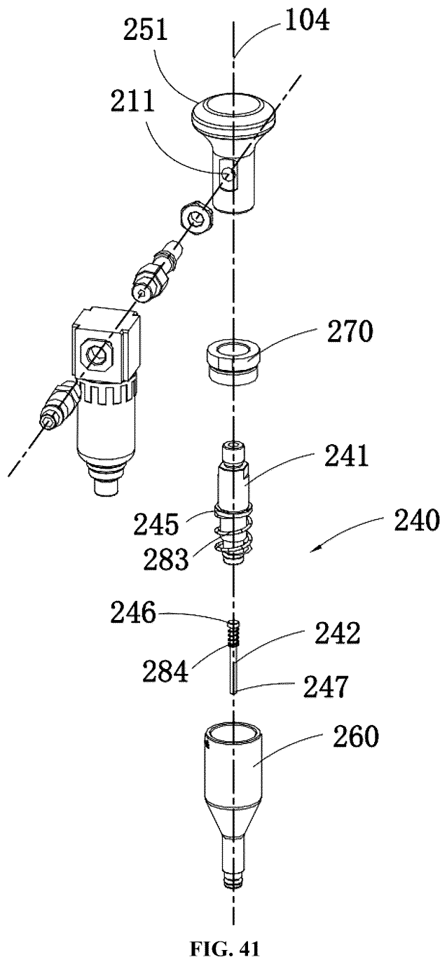

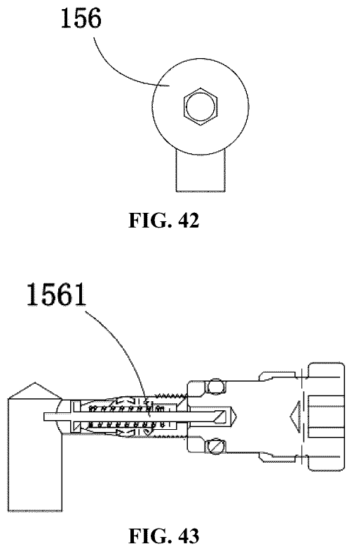

As shown in FIG. 42, a valve 156 is provided at the ventilation portion 155. When the valve 156 is opened, the ventilation portion 155 allows gas to enter the air storage space 201. When the valve 156 is not opened, the ventilation portion 155 does not allow gas to enter the air storage space 201. As shown in FIG. 41, the inflation adapter 200 includes a drive assembly 240. The drive assembly 240 is configured to open the valve 156 of the ventilation portion 155. The drive assembly 240 has at least a first position and a second position. At the first position, the drive assembly 240 opens the valve 156. At the second position, the drive assembly 240 does not open the valve 156. That is to say, at the first position, the inflation channel 230 is opened to allow the flow of air. At the second position, the inflation channel 230 is closed to block the flow of air.

When the second connection end 220 is at the extreme position, the drive assembly 240 can be at least at the second position. When the second connection end 220 is at the extreme position, the drive assembly 240 can be at least at the second position at which the valve 156 is not opened and the inflation channel 230 is closed. When the second connection end 220 moves toward the ventilation portion 155, including after the second connection end 220 moves toward the ventilation portion 155 to the extreme position, the drive assembly 240 does not immediately open the valve 156 or the inflation channel 230. The drive assembly 240 does not open the valve 156 upon the second connection end 220 reaching the extreme position. Before the inflation starts, the air storage space 201 does not connect with the atmosphere. The gas in the air storage space 201 does not escape into the atmosphere, thereby avoiding the following: the air pressure in the energy storage device 150 is reduced, reducing the inflation efficiency and quality.

After the second connection end 220 reaches the extreme position, the drive assembly 240 can move to at least the first position. After the second connection end 220 reaches the extreme position, the drive assembly 240 can move to at least the first position at which the valve 156 is opened and the inflation channel 230 is opened. The drive assembly 240 may move to the first position to open the valve 156 after the second connection end 220 is tightly connected to the ventilation portion 155. The inflation adapter 200 connects with the air storage space 201 after the second connection end 220 is tightly connected to the ventilation portion 155 so that the gas in the air storage space 201 does not leak into the atmosphere, the inflation efficiency and quality are improved, and the inflation adapter 200 is convenient and reliable to use.

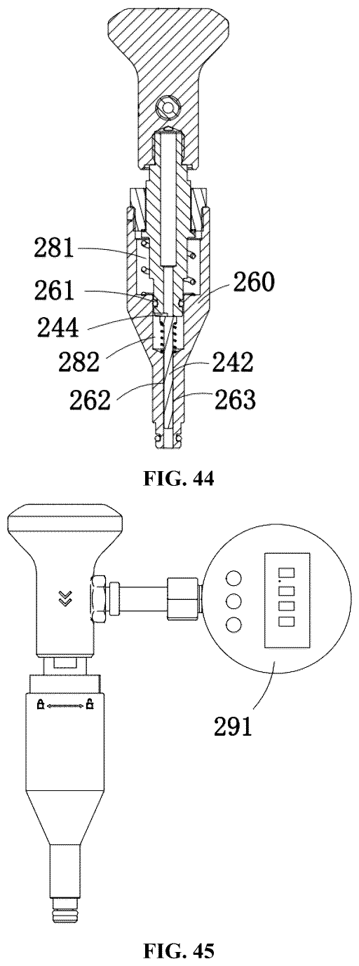

As shown in FIGS. 39 to 44, the inflation adapter 200 includes an operating portion 250. The operating portion 250 is operated by the user to drive the drive assembly 240 to move. The operating portion 250 is configured to be operated by the user to move along a fourth direction 104. The drive assembly 240 is configured to be driven by the operating portion 250 to move along the fourth direction 104. The drive assembly 240 and the operating portion 250 move in the same direction. When the user operates the operating portion 250 to move along the fourth direction 104, the operating portion 250 drives the drive assembly 240 to move along the fourth direction 104. The structure is simple and is convenient and comfortable to use. In some examples, the operating portion 250 and the drive assembly 240 move in different directions. The operating portion 250 may rotate to drive the drive assembly 240 to move; and the drive assembly 240 may be driven by the operating portion 250 to rotate. The operating portion 250 includes a handle 251. The handle 251 includes a nearly spherical portion and a planar portion. The user grasps the nearly spherical portion with fingers, places the palm on the planar portion, and presses the operating portion 250 along the fourth direction 104. In this manner, the operating portion 250 is comfortable to use. In some examples, the handle 251 may be in another shape, such as a plate shape or a column shape.

The inflation adapter 200 includes a housing 260 and a limiting portion 270. The limiting portion 270 is disposed on the housing 260. The second connection end 220 is located at an end of the housing 260, and the limiting portion 270 is located at an end of the housing 260 facing away from the second connection end 220. The operating portion 250 is disposed at an end facing away from the second connection end 220, and the limiting portion 270 is located between the operating portion 250 and the second connection end 220. The first connection end 210 is disposed on the operating portion 250. The limiting portion 270 is configured to limit the movement of the operating portion 250. When the operating portion 250 abuts against the limiting portion 270, the limiting portion 270 prevents the operating portion 250 from continuing moving along the fourth direction 104. In some examples, the inflation adapter 200 includes a holding portion. After the operating portion 250 moves a certain distance, the holding portion holds the operating portion 250 at a position and prevents the operating portion 250 from continuing moving. The holding portion may include threads, a groove and a protrusion, magnetic elements, or the like.

The drive assembly 240 includes a first driving member 241 and a second driving member 242. The operating portion 250 drives the first driving member 241. The first driving member 241 drives the second driving member 242. The first driving member 241 is located between the operating portion 250 and the second driving member 242. An end of the first driving member 241 abuts against the operating portion 250 and has an interference fit with the operating portion 250, and the other end of the first driving member 241 abuts against the second driving member 242. The first driving member 241 extends basically along the fourth direction 104 and is basically cylindrical. The first driving member 241 includes a through hole 243 connecting with the air inlet 211. The through hole 243 extends along the fourth direction 104 and forms a portion of the inflation channel 230. A connecting hole 244 is formed at an end of the first driving member 241 facing the second driving member 242, and the connecting hole 244 allows the airflow passing through the through hole 243 to flow out from the first driving member 241.

The inflation adapter 200 includes a first inflation cavity 281 and a second inflation cavity 282. The first inflation cavity 281 accommodates a first elastic member 283 and a part of the first driving member 241. The second inflation cavity 282 accommodates a second elastic member 284 and a part of the second driving member 242. The first elastic member 283 is sleeved on the first driving member 241. The second elastic member 284 is sleeved on the second driving member 242. The first driving member 241 includes a first pushing portion 245. The first pushing portion 245 is a circumferential protrusion formed on the first driving member 241. An end of the first pushing portion 245 abuts against the limiting portion, and the other end of the first pushing portion 245 abuts against the first elastic member 283. The second elastic member 284 includes a second pushing portion 246. The second pushing portion 246 is a circumferential protrusion formed on the second driving member 242. An end of the second pushing portion 246 abuts against the first driving member 241, and the other end of the second pushing portion 246 abuts against the second elastic member 284. When the user presses the operating portion 250 to drive the drive assembly 240 to move, the first pushing portion 245 and the second pushing portion 246 abut against the first elastic member 283 and the second elastic member 284, respectively and bias the first elastic member 283 and the second elastic member 284 in the pressing direction, respectively. The first elastic member 283 and the second elastic member 284 are deformed and store elastic potential energy. When the user releases the operating portion 250, the first elastic member 283 and the second elastic member 284 restore their shapes in the direction opposite to the pressing direction and abut against the first pushing portion 245 and the second pushing portion 246, respectively, thereby driving the drive assembly 240 to move in the direction opposite to the pressing direction. In this manner, the drive assembly 240 is reset. The second driving member 242 and the first driving member 241 are two separate parts and thus are convenient to manufacture, thereby saving costs. The second driving member 242 and the first driving member 241 may be driven by the first elastic member 283 and the second elastic member 284, respectively so that the movement of the drive assembly 240 is stable and reliable. The drive assembly 240 may be reset immediately after the inflation is completed, thereby preventing gas leakage when the inflation adapter 200 is disassembled.

The inflation adapter 200 includes a first sealing member 285. The first sealing member 285 seals the first inflation cavity 281 relative to the second inflation cavity 282. The housing 260 has a first inner wall 261. The first sealing member 285 is sleeved on an end of the first driving member 241 facing the second driving member 242 and has an interference fit with the first inner wall 261. In this manner, when the airflow flows out of the first driving member 241 from the connecting hole 244 and enters the second inflation cavity 282, the airflow does not return to the first inflation cavity 281 so that the inflation efficiency is high. The second inflation cavity 282 forms a portion of the inflation channel 230.

The second driving member 242 extends basically along the fourth direction 104 and is basically cylindrical. The housing 260 has a second inner wall 262. A portion of the second driving member 242 is accommodated in the second inner wall 262 and has a clearance fit with the second inner wall 262. After passing through the second inflation cavity 282, the airflow passes through a gap 263 between the second driving member 242 and the second inner wall 262 and finally flows into the air storage space 201. The gap 263 between the second driving member 242 and the second inner wall 262 forms the last portion of the inflation channel 230.

The inflation adapter 200 includes a second sealing member 286. The second sealing member 286 is sleeved on the meshing portion 222. The second sealing member 286 seals the second connection end 220 relative to the ventilation portion 155. When the second connection end 220 moves to the extreme position, the meshing portion 222 keeps the second connection end 220 at the extreme position, and the second sealing member 286 enables a sealed space to be formed between the inflation channel 230 and the air storage space 201.

The second driving member 242 includes a trigger portion 247. The trigger portion 247 may be operated by the user to open the valve 156. The trigger portion 247 protrudes from the air outlet 221 or retracts into the air outlet 221 as the second driving member 242 moves. When the second connection end 220 moves to the extreme position, the trigger portion 247 protrudes from the air outlet 221 to open the valve 156.

The threads of the ventilation portion 155 are disposed on the valve 156. The valve 156 includes a trigger lever 1561. When the user operates the operating portion 250, the trigger portion 247 of the second driving member 242 abuts against the trigger lever 1561 to drive the trigger lever 1561 to move. The trigger lever 1561 moves to open and close the valve 156.

The process of the user using the inflation adapter 200 for inflation is described below. The user connects the inflation adapter 200 to the fastener driver 100 through the meshing portion 222, the second connection end 220 moves to the extreme position, and at this time, the drive assembly 240 is at the second position at which the valve 156 is not opened. After the inflation adapter 200 is tightly connected to the fastener driver 100, when the user operates the operating portion 250 for the first time, the drive assembly 240 moves from the second position to the first position to open the valve 156. After the valve 156 is opened, the user may inflate the energy storage device 150. When the user operates the operating portion 250 again, the drive assembly 240 returns to the second position from the first position, the valve 156 is closed, and the inflation ends. At this time, the user disconnects the inflation adapter 200 from the fastener driver 100 via the meshing portion 222. No air leakage occurs throughout the inflation process. Inflation can start only after the user operates the operating portion 250 so that the user can control the timing of inflation independently, thereby ensuring convenient usage.

The air source is connected to the air inlet 211 through an air inlet pipe 212. In some examples, a quick connector is disposed between the air inlet pipe 212 and the air inlet 211 to facilitate the connection between the inflation adapter 200 and the air source. The air inlet 211 extends along a direction basically perpendicular to the fourth direction 104. In this manner, the longer air inlet pipe 212 is basically perpendicular to the fourth direction 104 and connected to the air inlet 211 so that the air inlet pipe 212 does not hinder the user from operating the operating portion 250 along the fourth direction 104, thereby ensuring a comfortable and convenient user experience. In some examples, the air inlet 211 may extend along another direction, for example, a direction parallel to the fourth direction 104. The first connection end 210 is rotatable relative to the second connection end 220 so that the user can inflate the fastener driver 100 from different directions. In this example, the operating portion 250 and the air inlet 211 are rotatable relative to the housing 260.

In this example, the inflation adapter 200 further includes a filter 290. The filter 290 may filter the air, thereby improving the purity of the gas filled into the energy storage device 150, preventing dust from entering the energy storage device 150, and improving the impact force and service life of the fastener driver 100. The filter 290 is connected to the air inlet 211 to allow filtered air to enter the air inlet 211. The air inlet pipe 212 is connected to the filter 290 via a quick connector. The filter 290 is connected to the air inlet 211 and moves with the movement of the operating portion 250. The gas in the air source enters the filter 290 from the air inlet pipe 212, is filtered by the filter 290, and then enters the inflation channel 230 from the air inlet 211, thereby preventing dust from entering the energy storage device 150 and reducing the frictional resistance of the piston 122 during movement.

As shown in FIG. 45, in some examples, the inflation adapter 200 may be provided with a measuring device 291. During inflation, the air pressure in the inflation channel 230 is the same as the air pressure in the air storage space 201. The measuring device 291 measures the air pressure in the inflation channel 230 and the air pressure in the air storage space 201. The measuring device 291 includes a display screen and buttons. The display screen shows the numerical value of the measured air pressure, which is convenient for the user to see the numerical value of the measured air pressure. The buttons are used by the user to perform operations such as powering on, zeroing, and calibrating the measuring device 291. The operation process of the measuring device 291 is similar to the inflation process. The user moves the second connection end 220 to the extreme position to establish a seal between the inflation adapter 200 and the fastener driver 100, and then the user operates the operating portion 250 to open the valve 156 to measure the air pressure. After measuring the air pressure, the user operates the operating portion 250 to close the valve 156 and then breaks the seal between the inflation adapter 200 and the fastener driver 100. The user does not need to reinflate the fastener driver 100 just to measure the air pressure, thereby ensuring a convenient and rapid operation. After the valve 156 is opened, a small amount of gas in the air storage space 201 diffuses into the inflation adapter 200 and the measuring device 291, and the air pressure in the energy storage device 150 is slightly reduced. The space for accommodating gas inside the measuring device 291 is less than or equal to 5% of the air storage space 201. In this manner, the space for accommodating gas inside the measuring device 291 is extremely small compared to the air storage space 201, thereby ensuring that the air pressure in the energy storage device 150 is reduced to a very small extent and the air pressure measured by the measuring device 291 is accurate. In some examples, the measuring device 291 may compensate for the decrease in air pressure in the energy storage device 150 through a calibration function to ensure that the measured air pressure is accurate.

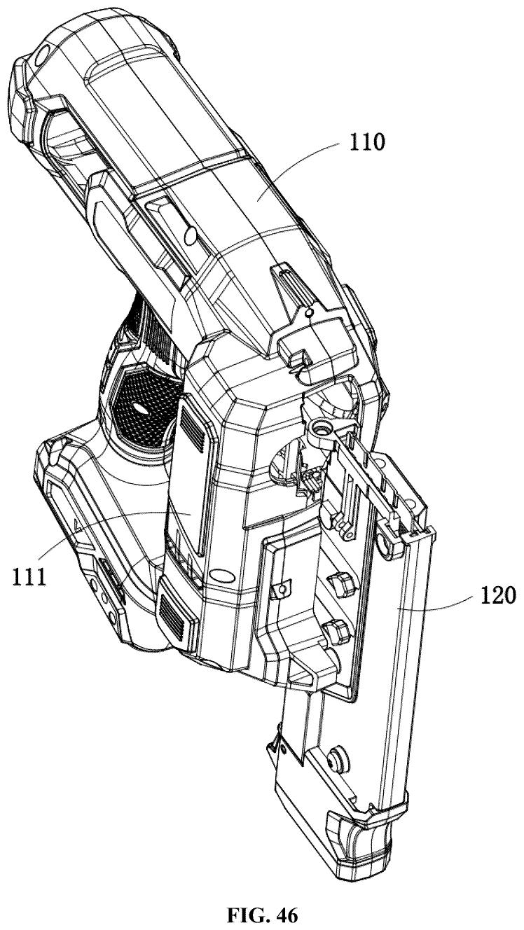

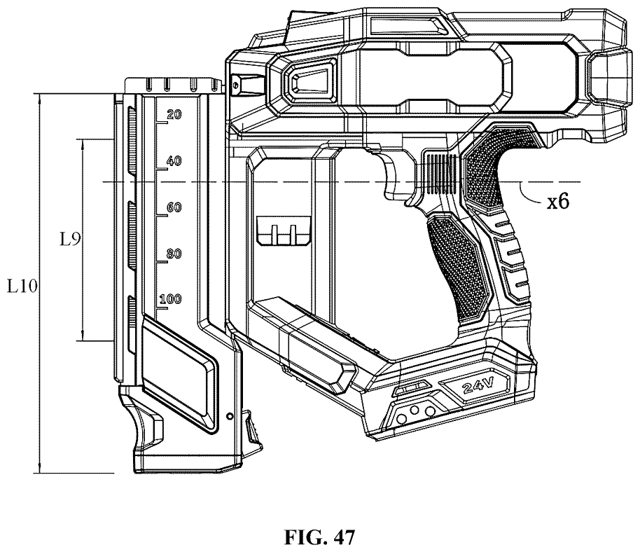

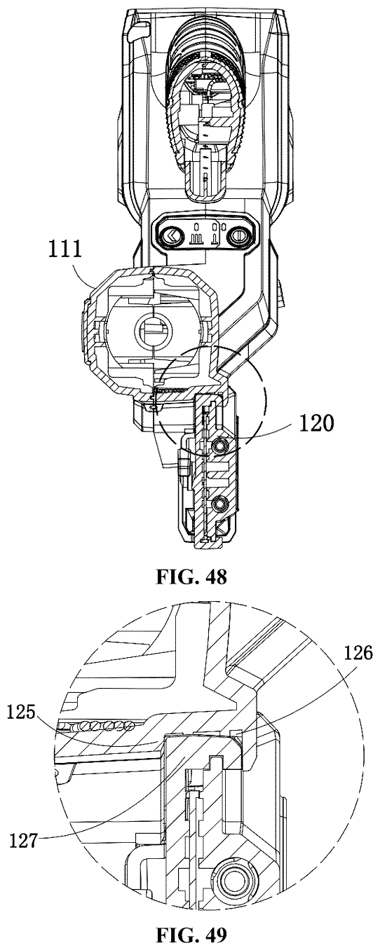

As shown in FIGS. 46 to 49, part of the magazine 120 is wrapped by the housing 110. The magazine 120 is fixed to the main housing 111. The main housing 111 includes a fixing rib 125. The fixing rib 125 defines the installation position of the magazine 120. The fixing rib 125 is formed with a positioning groove 126. The positioning groove 126 fixes the magazine 120 on the main housing 111 along the length direction of the magazine 120. The magazine 120 includes a magazine housing 127. The magazine housing 127 is confined within the positioning groove 126. The ratio of the length L9 of the fixing rib 125 to the length L10 of the magazine 120 is greater than or equal to 0.3. In some examples, the ratio of the length L9 of the fixing rib 125 to the length L10 of the magazine 120 is greater than or equal to 0.4. In some examples, the ratio of the length L9 of the fixing rib 125 to the length L10 of the magazine 120 is greater than or equal to 0.5. In this manner, most of the length of the magazine 120 can be fixed by the positioning groove 126 and wrapped by the main housing 111 so that the magazine 120 is easy to mount, stable, and not easy to wobble.

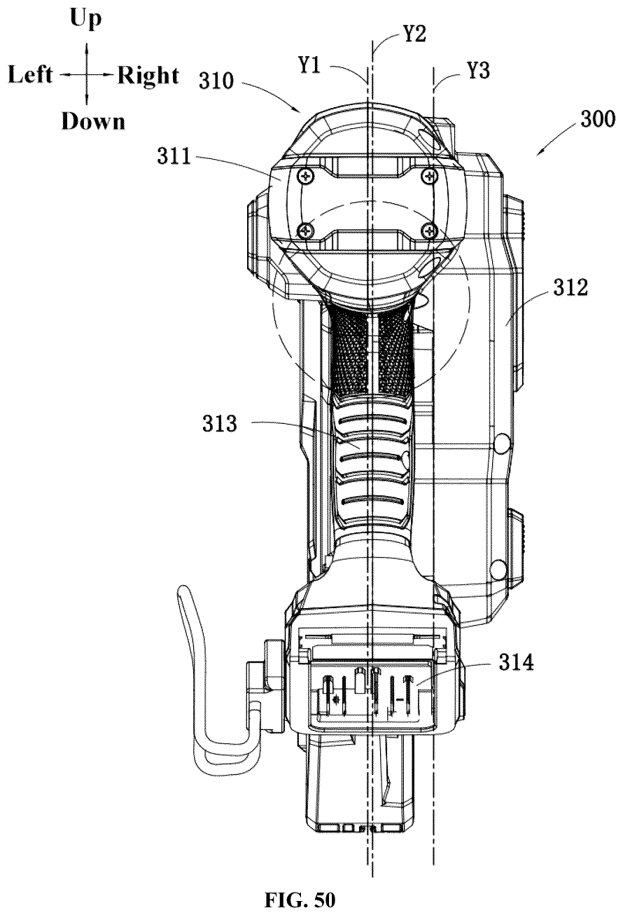

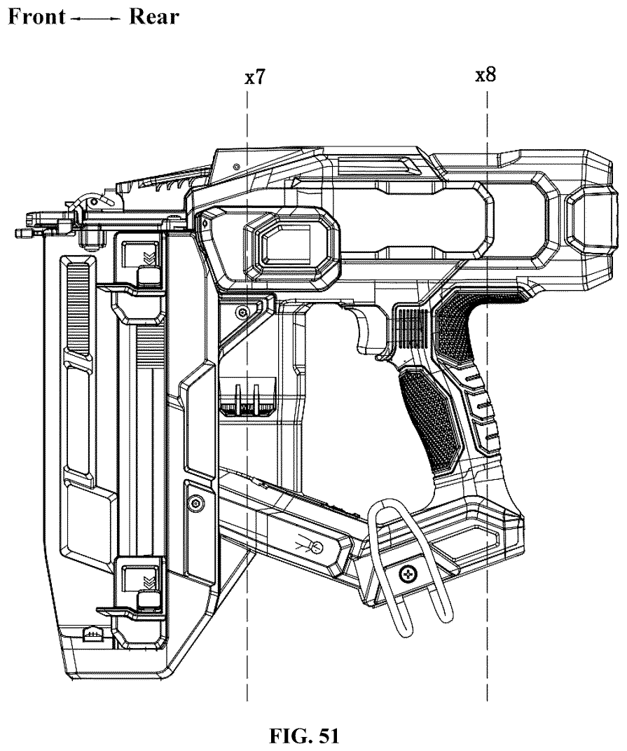

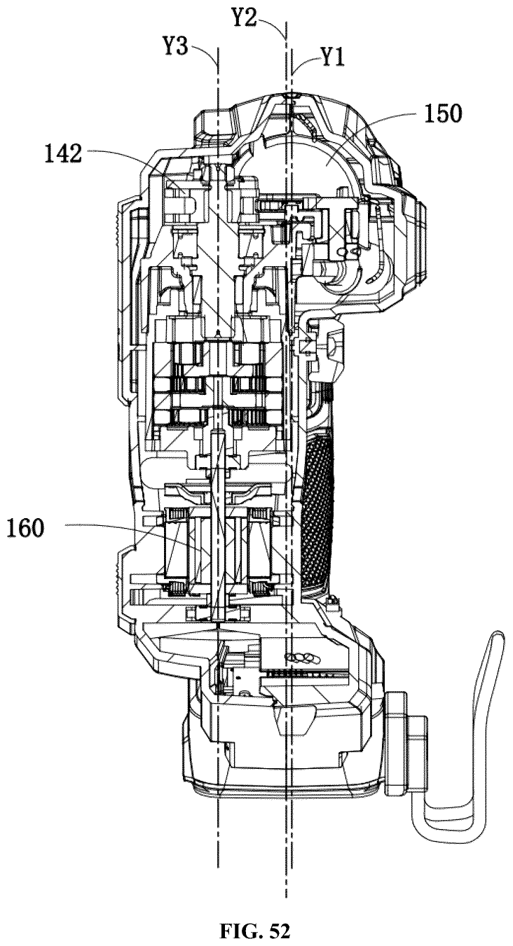

As shown in FIGS. 50 to 55, the present application further provides a fastener driver 300 according to another example, and the structure of the fastener driver 300 is basically the same as the structure of the fastener driver 100.

The fastener driver 300 includes a housing 310. The housing 310 includes a main housing 311, a transmission portion 312, and a grip 313 for the user to hold. The transmission portion 312 accommodates the motor 160. The transmission portion 312 is disposed in front of the grip 313. The motor 160 is disposed in front of the grip 313. When the fastener driver 300 is viewed along the front and rear direction, the grip 313, the energy storage device 150, and the motor 160 have centerlines. The centerline of the energy storage device 150 when viewed along the front and rear direction is named Y1, the centerline of the grip 313 when viewed along the front and rear direction is named Y2, and the centerline of the motor 160 when viewed along the front and rear direction is named Y3. It is to be noted that each centerline refers to a characteristic line formed by sequentially connecting the center points of the grip 313 in the width direction when viewed along the front and rear direction, or the center points of the energy storage device 150 in the width direction when viewed along the front and rear direction, or the center points of the motor 160 in the width direction when viewed along the front and rear direction. When the grip 313, the energy storage device 150, or the motor 160 is inclined, the degree of inclination of the centerline changes with the degree of inclination of the grip 313, the energy storage device 150, or the motor 160, but the centerline is still located in the middle of the grip 313, the energy storage device 150, or the motor 160 in the width direction.

The centerline Y2 of the grip 313 is at least partially disposed between the centerline Y1 of the energy storage device 150 and the centerline Y3 of the motor 160. Since the driving member 142 drives the firing pin 131 from the side of the firing pin 131, when the fastener driver 300 is viewed along the front and rear direction, the firing pin 131 and the driving member 142 are misaligned, and the energy storage device 150 for accommodating the firing pin 131 and the motor 160 for driving the driving member 142 to rotate are misaligned. The motor 160 is located on the right side of the energy storage device 150. The motor 160 is relatively heavy. The motor 160 is connected to a gearbox 1401, and the gearbox 1401 accommodates the gearset 141. The gearbox 1401 and the gearset 141 are also relatively heavy. Therefore, when the user holds the grip 313 to use the fastener driver 300, the right side of the user's hand bears more weight. When the user uses the fastener driver 300, the user's hand tends to turn to the right. The centerline Y2 of the grip 313 is at least partially disposed between the centerline Y1 of the energy storage device 150 and the centerline Y3 of the motor 160, that is, the centerline Y2 of the grip 313 is between the centerline of the main housing 311 and the centerline of the transmission portion 312. The centerline Y2 of the grip 313 is on the right side of the centerline Y1 of the energy storage device 150 and on the left side of the centerline Y3 of the motor 160. In this manner, the holding position of the user and the centerline Y1 of the energy storage device 150 are misaligned, and the holding position of the user is close to the centerline Y3 of the motor 160. In the left and right direction, the user's hand is closer to the motor 160 and the transmission mechanism that are relatively heavy so that the fastener driver 300 is comfortable to use, and the user's hand bears the weight evenly and is not easy to turn over. In this example, the centerline Y2 of the grip 313 is disposed between the centerline Y1 of the energy storage device 150 and the centerline Y3 of the motor 160. The centerline Y2 of the grip 313 is basically parallel to the centerline Y1 of the energy storage device 150. The centerline Y2 of the grip 313 is basically parallel to the centerline Y3 of the motor 160. The centerline Y3 of the motor 160 basically coincides with the rotation axis of the motor 160.

The fastener driver 300 has a center of gravity G. The center of gravity G of the fastener driver 300 is located on a side of the energy storage device 150 facing the motor 160. The centerline Y2 of the grip 313 is at least partially disposed between the centerline Y1 of the energy storage device 150 and the center of gravity G. In the left and right direction, the holding position of the user is closer to the center of gravity G of the fastener driver 300, and the downward force applied by the weight of the motor 160 and the gearbox 1401 can act more on the user's hand and be supported by the wrist and arm, rather than being concentrated on one side of the user's hand. The user's hand does not easily turn left or right, and the fastener driver 300 with a balanced weight is comfortable and safe to use. When the user uses the fastener driver 300 for a long time, the user is less likely to feel fatigued.

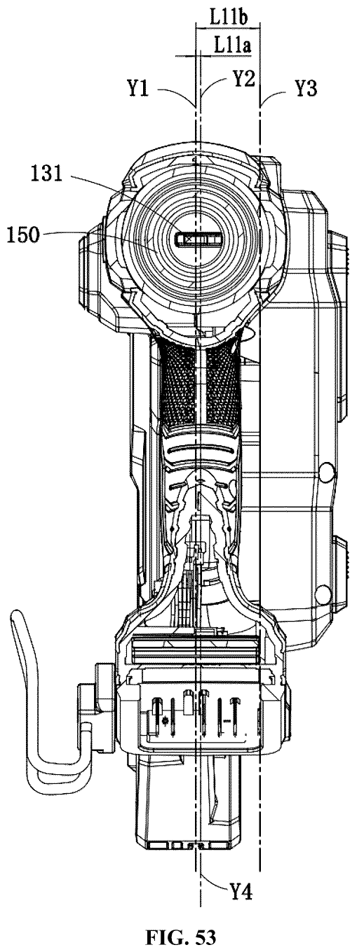

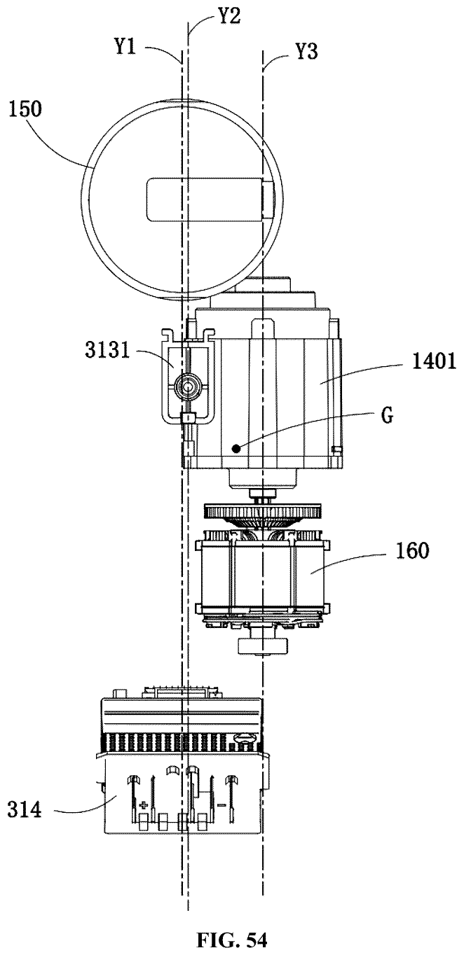

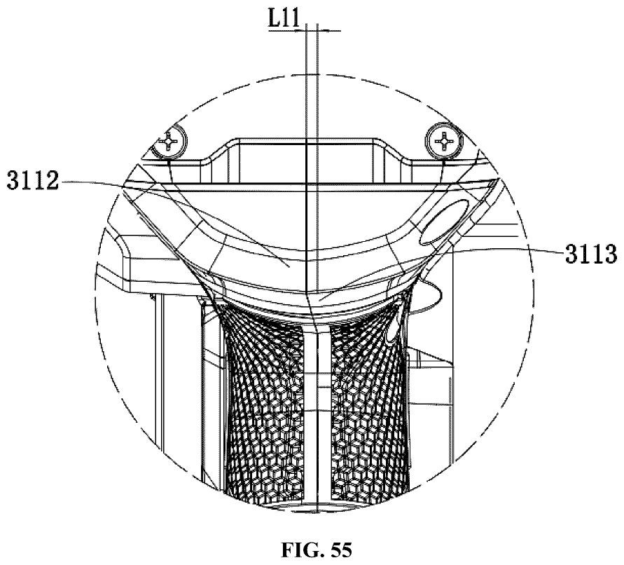

As shown in FIGS. 53 and 54, the fastener driver 300 includes a coupling portion 314. The centerline of the coupling portion 314 when viewed along the front and rear direction is named Y4. The centerline Y4 of the coupling portion 314 is at least partially disposed between the centerline Y1 of the energy storage device 150 and the centerline Y3 of the motor 160. The centerline Y4 of the coupling portion 314 and the centerline Y2 of the grip 313 are on the same plane. The centerline Y4 of the coupling portion 314 is close to the center of gravity G of the fastener driver 300 so that the fastener driver 300 is stable when placed vertically and is not prone to fall. The centerline Y4 of the coupling portion 314 and the centerline Y2 of the grip 313 are on the same plane, and the manufacturing cost of the fastener driver 300 is low. As shown in FIG. 55, the main housing 311 includes a first housing 3112 and a second housing 3113. The first housing 3112 and the second housing 3113 fit each other along a fitting surface. The fitting surface of the first housing 3112 and the second housing 3113 passes through the centerline Y2 of the grip 313 and the centerline Y1 of the energy storage device 150. When the fastener driver 300 is manufactured, the first housing 3112 and the second housing 3113 fit each other along the fitting surface, and the centerline Y2 of the grip 313 and the centerline Y1 of the energy storage device 150 are offset relative to the centerline Y1 of the energy storage device 150. The manufacturing is simple, accurate, and cost-effective.

In some examples, the centerline Y4 of the coupling portion 314 is at least partially disposed on a side of the centerline Y1 of the energy storage device 150 facing away from the centerline Y3 of the motor 160. In this manner, when the battery pack 115 is mounted on the coupling portion 314, the center of gravity G of the fastener driver 300 shifts to the left due to the large weight of the battery pack 115. The centerline Y2 of the grip 313, that is, the holding position of the user, is closer to the center of gravity G so that the fastener driver 300 is more comfortable to use.

The direction of the first straight line 101 along which the fastener 10 is driven out basically coincides with the centerline Y1 of the energy storage device 150, and the grip 313 is generally at least partially disposed below the energy storage device 150. Therefore, in the left and right direction, the holding position of the user is close to the position where the fastener 10 is driven out. The energy storage device 150 includes a first cylinder 151. The centerline Y2 of the grip 313 is at least partially disposed between the centerline of the first cylinder 151 and the centerline Y3 of the motor 160. The first cylinder 151 accommodates at least part of the firing pin 131. The centerline Y2 of the grip 313 is at least partially disposed between the centerline of the firing pin 131 and the centerline Y3 of the motor 160. The centerline Y1 of the energy storage device 150, the centerline of the first cylinder 151, and the centerline of the firing pin 131 basically coincide with each other. The centerline of a trigger 3131 is at least partially disposed between the centerline Y1 of the energy storage device 150 and the centerline Y3 of the motor 160. The centerline of the trigger 3131 basically coincides with the centerline Y2 of the grip 313.

The centerline Y2 of the grip 313 is basically parallel to the centerline Y1 of the energy storage device 150. The distance L11a between the centerline Y2 of the grip 313 and the centerline Y1 of the energy storage device 150 is greater than or equal to 0.5 mm and less than or equal to 10 mm. In some examples, the distance L11a between the centerline Y2 of the grip 313 and the centerline Y1 of the energy storage device 150 is greater than or equal to 2 mm and less than or equal to 8 mm. In some examples, the distance L11a between the centerline Y2 of the grip 313 and the centerline Y1 of the energy storage device 150 is greater than or equal to 4 mm and less than or equal to 6 mm. The distance L11a between the centerline Y2 of the grip 313 and the centerline Y1 of the energy storage device 150 is relatively small, and in the left and right direction, the holding position of the user is relatively close to the position where the fastener 10 is driven out so that it is convenient for the user to align with the position where the fastener 10 is driven out, thereby ensuring ease of use. The centerline Y2 of the grip 313 is within 0.5 to 10 mm to the right of the centerline Y1 of the energy storage device 150, thereby balancing the user's requirements for weight balance and shooting position alignment. In this manner, in the case where the user feels that the fastener driver 300 is well-balanced in weight and is not easy to turn over, the shooting position alignment is easy, and the fastener driver 300 is comfortable and convenient to use and is aesthetically pleasing.

The ratio of the distance L11a between the centerline Y1 of the energy storage device 150 and the centerline Y2 of the grip 313 to the distance L11b between the centerline Y1 of the energy storage device 150 and the centerline Y3 of the motor 160 is less than or equal to 0.5. In some examples, the ratio of the distance L11a between the centerline Y1 of the energy storage device 150 and the centerline Y2 of the grip 313 to the distance L11b between the centerline Y1 of the energy storage device 150 and the centerline Y3 of the motor 160 is less than or equal to 0.4, 0.3, 0.2, or 0.1.

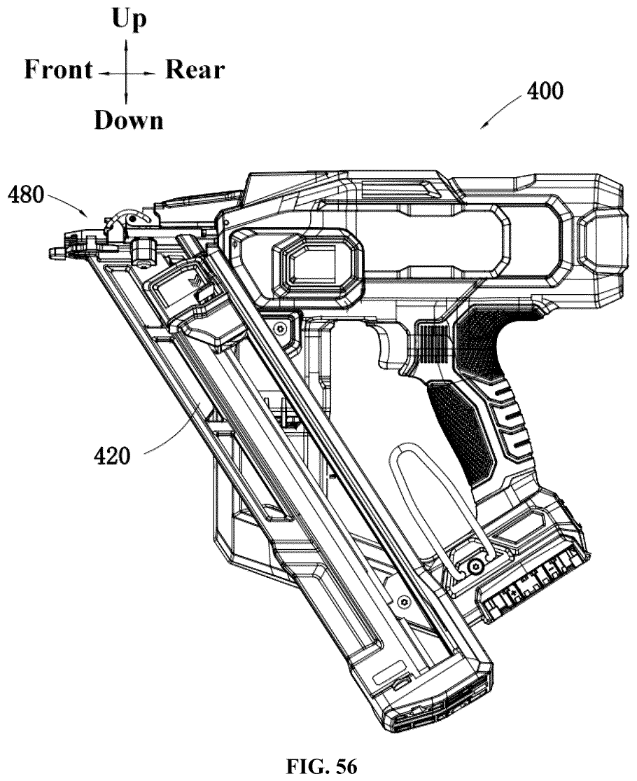

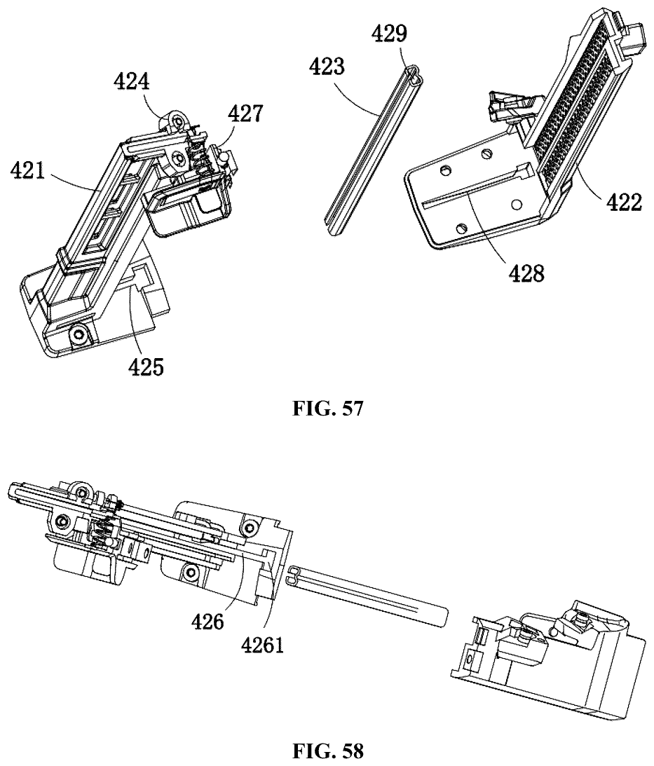

As shown in FIGS. 56 to 58, the present application further provides a fastener driver 400 according to another example, and the structure of the fastener driver 400 is basically the same as the structure of the fastener driver 100. The fastener driver 400 includes a magazine 420 and a guide assembly 480. The magazine 420 includes an upper magazine 421, a lower magazine 422, and a guide rail 423. The guide rail 423 is configured to guide the fasteners 10 to move in the magazine. The guide rail 423 is fixed on the upper magazine 421. The upper magazine 421 is disposed on the front side of the lower magazine 422. The upper magazine 421 includes a guide assembly fixing portion 424 and a guide rail fixing portion 425. The length of the upper magazine 421 is defined by the top and bottom of the upper magazine 421. The guide assembly fixing portion 424 is located at the top of the upper magazine 421, and the guide rail fixing portion 425 is located at the bottom of the upper magazine 421. The upper magazine 421 is fixed to the guide assembly 480 via the guide assembly fixing portion 424. The guide assembly fixing portion 424 includes a hole. The screw passes through the hole to fix the magazine to the guide assembly 480.

The guide rail 423 is fixed on the upper magazine 421 via the guide rail fixing portion 425. In this manner, since the upper magazine 421 is fixed on the guide assembly 480 and the guide rail 423 is fixed on the upper magazine 421, the guide rail 423 is fixed relative to the guide assembly 480. When the guide rail 423 guides the fastener 10 to move, the position of the fastener 10 relative to the guide assembly 480 is stable, and the fastener 10 is not easy to wobble, thereby improving the nailing quality.

The guide rail fixing portion 425 includes a first strip-shaped hole 426. The first strip-shaped hole 426 has a shape matching the shape of the fastener 10 to allow the fastener 10 to pass through. The first strip-shaped hole 426 has a guide rail fixing end 4261. The guide rail fixing end 4261 has a shape matching the shape of the guide rail 423 so that an end of the guide rail 423 can be inserted into the guide rail fixing end 4261. The upper magazine 421 includes a guide rail abutting portion 427. The other end of the guide rail 423 abuts against the guide rail abutting portion 427 and the guide assembly 480. In this manner, the guide rail 423 can be stably fixed on the upper magazine 421, and the installation is simple.

The lower magazine 422 is fixed to the upper magazine 421. The lower magazine 422 includes a second strip-shaped hole 428. The second strip-shaped hole 428 has a shape matching the shape of the fastener 10 to allow the fastener 10 to pass through. The guide rail 423 includes a mounting groove 429. The mounting groove 429 has a shape matching the shape of the rear end of the fastener 10 to guide the fastener 10 to move. When the fasteners 10 are loaded into the magazine 420, the fasteners 10 pass through the second strip-shaped hole 428, the first strip-shaped hole 426, and the mounting groove 429 in sequence. After the fasteners 10 are loaded into the magazine 420, the fasteners 10 are not affected by the lower magazine 422. In this manner, the installation accuracy requirement for the lower magazine 422 during manufacturing is relatively low. Even if the lower magazine 422 is loose or not aligned with the upper magazine 421, the movement of the fasteners 10 is not affected.

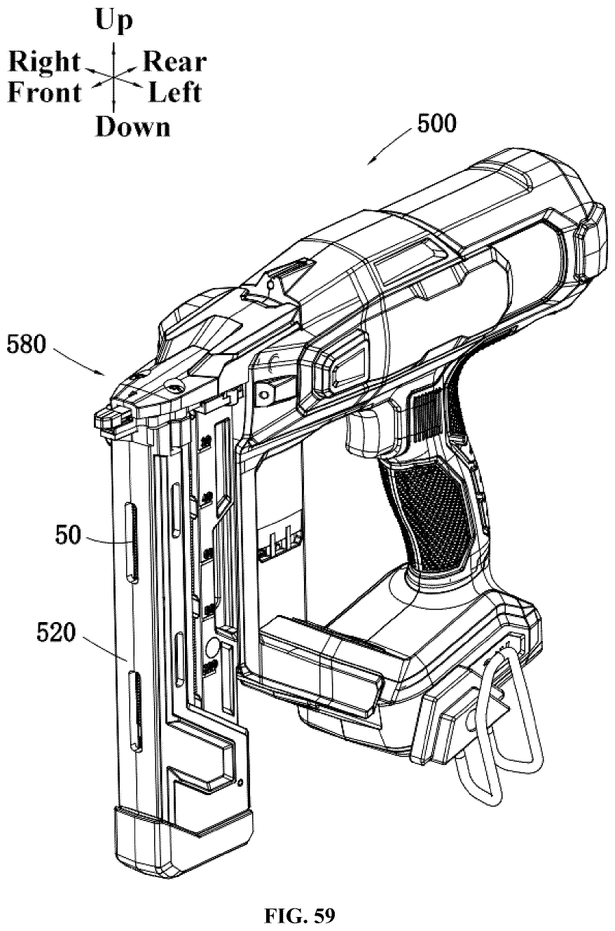

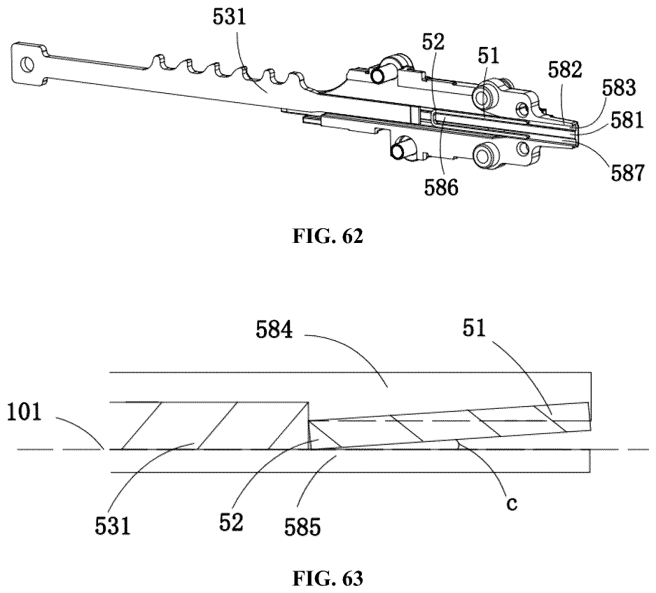

As shown in FIGS. 59 to 66, the present application further provides a fastener driver 500 according to another example, and the structure of the fastener driver 500 is basically the same as the structure of the fastener driver 100. The fastener driver 500 includes a magazine 520, a firing pin 531, fasteners 50, and a guide assembly 580. The fastener 50 is U-shaped. The fastener 50 includes at least two legs 51 and a connecting portion 52 connecting the at least two legs 51. In this example, the fastener 50 has two legs 51 and one connecting portion 52. The two legs 51 are two straight parts of a U-shape, respectively, and the connecting portion 52 is a bent part of the U-shape. The guide assembly 580 guides the fastener 50 into the workpiece. Since the fastener 50 is U-shaped and has a gap between the at least two legs 51, the fastener 50 is easily deformed at the at least two legs 51 after the fastener 50 is in contact with the workpiece.

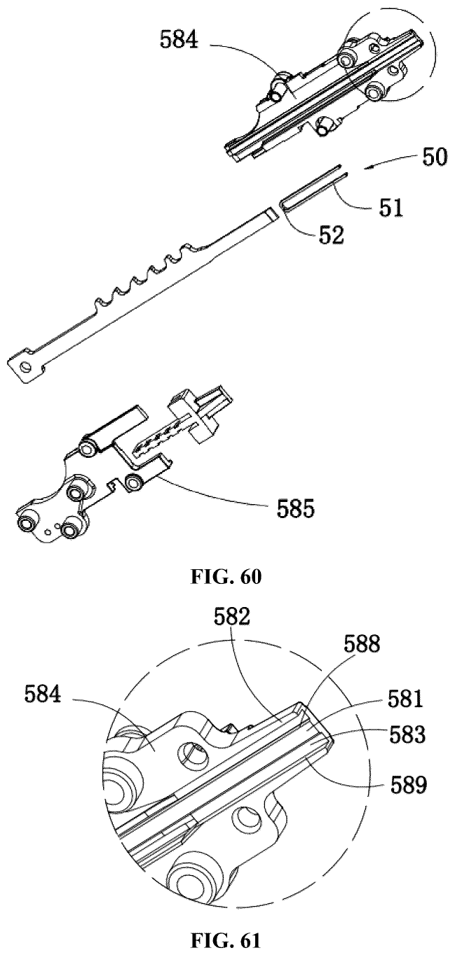

As shown in FIGS. 60 to 63, the guide assembly 580 extends basically along the first straight line 101. The guide assembly 580 includes a first guide structure 581. The first guide structure 581 prevents the at least two legs 51 of the fastener 50 from approaching each other. When the fastener 50 is in contact with a certain workpiece, the two legs 51 of the fastener 50 are subjected to the force from the workpiece and approach each other under the action of the force. The shape of the fastener 50 changes, resulting in problems such as the fastener 50 failing to be driven into the workpiece, the fastener 50 being skewed, and the poor work quality. The first guide structure 581 prevents the at least two legs 51 of the fastener 50 from approaching each other so that the at least two legs 51 of the fastener 50 do not approach each other after being in contact with the workpiece, thereby ensuring high work quality and working efficiency.

The guide assembly 580 includes a second guide structure 582. The second guide structure 582 prevents the at least two legs 51 of the fastener 50 from moving away from each other. Depending on the material of the workpiece, when the fastener 50 is in contact with a certain workpiece, the two legs 51 of the fastener 50 are subjected to the force from the workpiece and move away from each other under the action of the force. The shape of the fastener 50 changes, resulting in problems such as the fastener 50 failing to be driven into the workpiece, the fastener 50 being skewed, and the poor work quality. The second guide structure 582 prevents the at least two legs 51 of the fastener 50 from moving away from each other so that the at least two legs 51 of the fastener 50 do not move away from each other after being in contact with the workpiece, thereby ensuring high work quality and working efficiency.

The guide assembly 580 includes the first guide structure 581 and the second guide structure 582 that prevent the shape of the fastener 50 from changing, thereby preventing the at least two legs 51 from approaching each other or moving away from each other when the fastener 50 is in contact with the workpiece. In this manner, in case of different workpieces or different working conditions, the shape of the fastener 50 can remain unchanged, thereby ensuring high work quality and working efficiency.

The guide assembly 580 includes a guide surface 583. After the fastener 50 moves to the uppermost position relative to the guide assembly 580, the guide surface 583 is in contact with the at least two legs 51. The guide surface 583 extends basically along the direction of the first straight line 101. When the firing pin 531 drives the fastener 50 to move, the upper sides of the at least two legs 51 abut against the guide surface 583 and move along the guide surface 583. The first guide structure 581 protrudes relative to the guide surface 583. When the fastener driver 500 is placed vertically, the first guide structure 581 protrudes downward relative to the guide surface 583. The first guide structure 581 is a strip-shaped rib that protrudes relative to the guide surface 583. The first guide structure 581 is located in the middle of the guide surface 583, and the extension direction of the first guide structure 581 is consistent with the direction of the first straight line 101. The at least two legs 51 abut against the guide surface 583, and the first guide structure 581 is sandwiched between the at least two legs 51. The first guide structure 581 includes at least two first abutting surfaces 588. The at least two first abutting surfaces 588 are located on two sides of the first guide structure 581 facing outward along the length direction. When the fastener 50 is subjected to an external force and the at least two legs 51 tend to approach each other, the at least two first abutting surfaces 588 abut against the at least two legs 51, respectively and prevent the at least two legs 51 from approaching each other.

The first guide structure 581 includes a slideway 586 located between the at least two first abutting surfaces 588. Since a gap exists between the at least two legs 51, the at least two legs 51 may abut against the guide surface 583 when moving to the uppermost position. The connecting portion 52 has a continuous shape, so when the connecting portion 52 moves to the uppermost position, the connecting portion 52 abuts against the slideway 586 of the first guide structure 581. The slideway 586 extends along the direction of the first straight line 101. When the firing pin 531 drives the fastener 50 to move, the upper side of the connecting portion 52 abuts against the slideway 586 and moves along the slideway 586.

The second guide structure 582 protrudes relative to the guide surface 583. When the fastener driver 500 is placed vertically, the second guide structure 582 protrudes downward relative to the guide surface 583. The second guide structure 582 has two strip-shaped ribs that protrude relative to the guide surface 583. The second guide structure 582 is located on two sides of the guide surface 583, and the extension direction of the second guide structure 582 is consistent with the direction of the first straight line 101. The second guide structure 582 includes at least two second abutting surfaces 589. The at least two second abutting surfaces 589 are located on two sides of the second guide structure 582 facing inward along the length direction. When the fastener 50 is subjected to an external force and the at least two legs 51 tend to move away from each other, the at least two second abutting surfaces 589 abut against the at least two legs 51, respectively and prevent the at least two legs 51 from moving away from each other.

The guide assembly 580 includes a first guide member 584 and a second guide member 585. The first guide member 584 and the second guide member 585 face each other. At least part of the first guide member 584 is located above the second guide member 585. The first guide structure 581 and the second guide structure 582 are both disposed on the first guide member 584, thereby ensuring a simple structure and facilitating machining. The first guide structure 581 and the second guide structure 582 both protrude downward, thereby facilitating manufacturing and reducing costs. At least part of the second guide member 585 supports the movement of the fasteners 50. The first guide member 584 and the second guide member 585 are fixed together by screws or the like. A movement channel 587 is formed between the first guide member 584 and the second guide member 585. The movement channel 587 accommodates part of the firing pin 531 and the fastener 50. When the firing pin 531 pushes the fastener 50 to move, at least part of the fastener 50 moves within the movement channel 587. When the fastener 50 moves, the at least two legs 51 abut against the first guide structure 581. The upper side of the connecting portion 52 abuts against the first guide member 584, and the lower side of the connecting portion 52 abuts against the second guide member 585. The first guide member 584 is mainly used for guiding the fasteners 50, and the second guide member 585 is mainly used for supporting the movement of the fasteners 50. The structure is effective and simple.

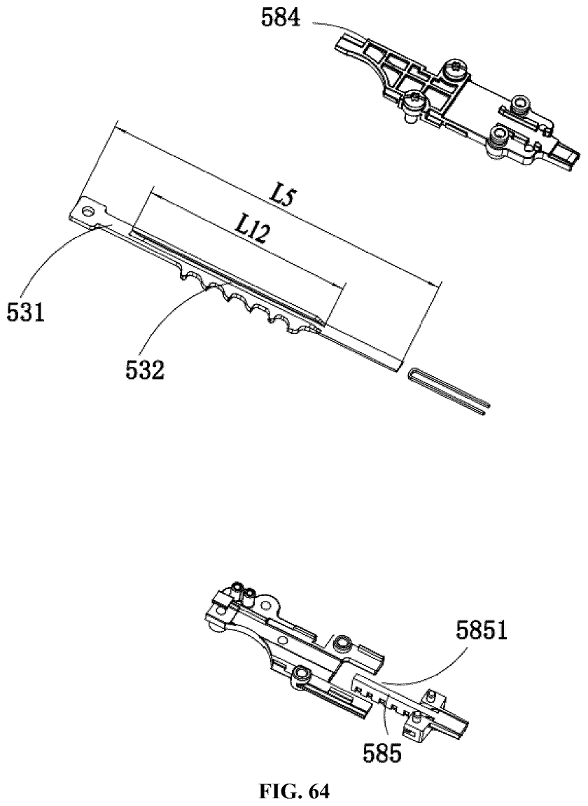

As shown in FIG. 64, the first guide structure 581 guides the movement of the firing pin 531. The firing pin 531 includes a guide groove 532. The guide groove 532 extends along the direction of the first straight line 101. When the firing pin 531 moves, the guide groove 532 engages with at least part of the first guide structure 581. The first guide structure 581 mates with the guide groove 532 to guide the movement of the firing pin 531. In this manner, the longer firing pin 531 is less likely to wobble so that the fastener driver 500 has high work quality. In the front and rear direction, the ratio of the length L12 of the guide groove 532 to the length L5 of the firing pin 531 is greater than or equal to 0.4 and less than or equal to 0.8. In some examples, the ratio of the length L12 of the guide groove 532 to the length L5 of the firing pin 531 is greater than or equal to 0.5 and less than or equal to 0.7. In some examples, the ratio of the length L12 of the guide groove 532 to the length L5 of the firing pin 531 is about 0.6. The length L12 of the guide groove 532 is longer than the length L5 of the firing pin 531 so that even if the firing pin 531 moves to the top dead center position farther from the guide assembly 580, part of the guide groove 532 mates with the first guide structure 581. During the entire movement process of the firing pin 531, the movement direction of the firing pin 531 can be guided by the guide assembly 580 so that the firing pin 531 is less likely to wobble, and the fastener driver 500 has high work quality.

As shown in FIG. 63, after the fastener 50 is in contact with the guide assembly 580, since the at least two legs 51 are in contact with the guide surface 583 and the connecting portion 52 is in contact with the slideway 586, a height difference exists between the at least two legs 51 and the connecting portion 52. The extension direction of the fastener 50 is inclined relative to the direction of the first straight line 101. The angle c at which the extension direction of the fastener 50 is inclined relative to the direction of the first straight line 101 is greater than or equal to 0 degrees and less than or equal to 8 degrees. In some examples, the angle c at which the extension direction of the fastener 50 is inclined relative to the direction of the first straight line 101 is greater than or equal to 1 degree and less than or equal to 7 degrees. In some examples, the angle c at which the extension direction of the fastener 50 is inclined relative to the direction of the first straight line 101 is greater than or equal to 2 degrees and less than or equal to 6 degrees. The angle c at which the extension direction of the fastener 50 is inclined relative to the direction of the first straight line 101 is relatively small so that the work quality is not affected when the fastener 50 is driven into the workpiece.

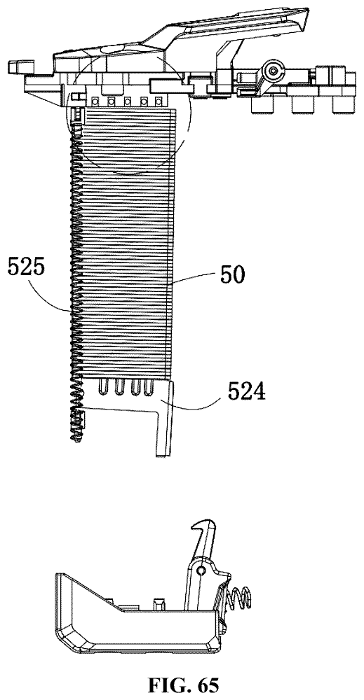

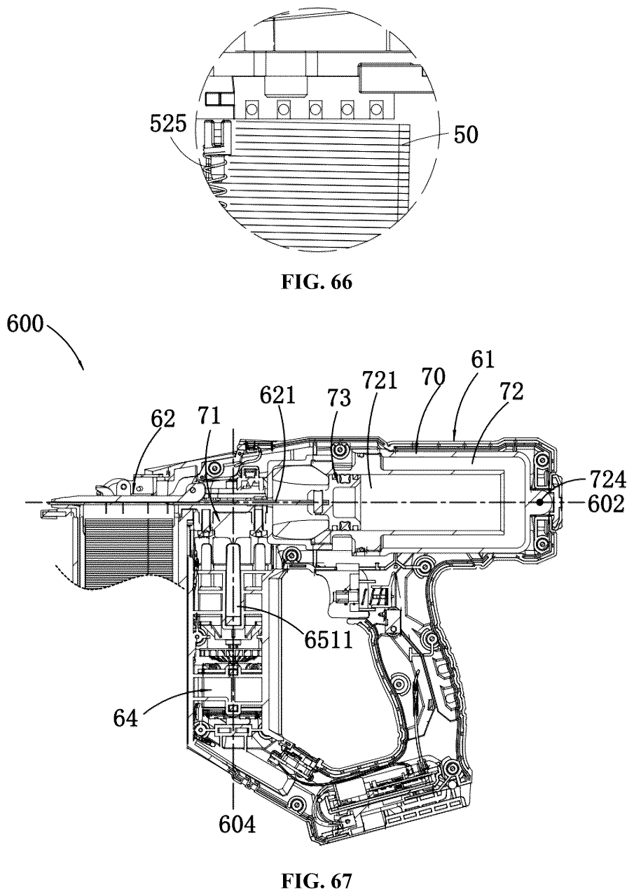

As shown in FIGS. 65 and 66, the fastener driver 500 includes a lifting member 524. The second guide member 585 includes input ports 5851. The input ports 5851 connects with at least part of the magazine 520. The lifting member 524 arranges a column of fasteners 50 closely in the magazine 520 in the up and down direction by the elastic force. The elastic force is generated by an elastic member, such as a spring or a coil spring. The lifting member 524 is configured to drive the fastener 50 to move so that the fastener 50 can pass through the input ports 5851. After one fastener 50 is driven out, the force of the lifting member 524 acts on the fastener 50, and the fastener 50 is lifted upward by the lifting member 524. The topmost fastener 50 in a column of fasteners 50 passes through the input ports 5851 to wait to be driven out by the firing pin 531. In this example, the elastic member is a lifting spring 525. The upper end of the lifting spring 525 is fixedly connected to the guide assembly 580. The lower end of the lifting spring 525 is fixedly connected to the left side of the lifting member 524. When the fasteners 50 are mounted, the user first overcomes the elastic force of the lifting spring 525 and moves the lifting member 524 downward. The lifting spring 525 is deformed and becomes longer. After enough space for placing a column of fasteners 50 is reserved, the user releases the hand, and the lifting spring 525 drives the lifting member 524 to clamp the fasteners 50 in the magazine 520. The lower end of the lifting spring 525 is fixedly connected to the left side of the lifting member 524. In this manner, the force applied to the left side of the lifting member 524 is greater than the force applied to the right side of the lifting member 524. The left side of the lifting member 524 is higher than the right side of the lifting member 524. The lifting member 524 is inclined relative to the direction of the first straight line 101 so that the extension direction of the fastener 50 is inclined relative to the direction of the first straight line 101. The angle at which the lifting member 524 is inclined relative to the direction of the first straight line 101 is consistent with the angle c at which the extension direction of the fastener 50 is inclined relative to the direction of the first straight line 101.

As shown in FIGS. 67 to 71, the present application further provides a fastener driver 600 according to another example.

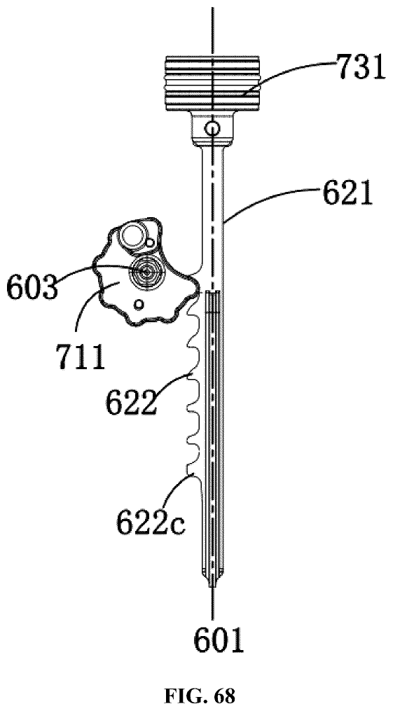

As shown in FIGS. 67 and 68, the fastener driver 600 includes a housing 61, a striking assembly 62, a power mechanism 70, and a motor 64. The housing 61 is configured to support the striking assembly 62, the power mechanism 70, and the motor 64. The striking assembly 62 includes a striking member 621 for driving the fastener. Optionally, the striking member 621 is configured to drive the fastener into a working surface along the direction of a striking straight line 601. The striking member 621 is a sheet element extending along a plane parallel to the direction of the striking straight line 601, and the axis defined by the striking member 621 coincides with the striking straight line 601. The power mechanism 70 is configured to drive the striking member 621 to move along the direction of the striking straight line 601, thereby impacting and driving the fastener into the working surface 200 along the direction of the striking straight line 601.

The power mechanism 70 includes a drive assembly 71, an energy storage assembly 72, and a firing assembly 73. The drive assembly 71 is configured to drive the energy storage assembly 72 to store energy. The firing assembly 73 is formed with or connected to the striking member 621. The firing assembly 73 is configured to be movable along the direction of a second straight line 602 relative to the housing 61. When moving along the direction of the second straight line 602, the firing assembly 73 drives the striking member 621 to move along the direction of the striking straight line 601. The energy storage assembly 72 stores energy for driving the firing assembly 73 to move and drives the firing assembly 73 to move along the second straight line 602 when releasing the energy, thereby driving the striking member 621 to move along the direction of the striking straight line 601.

The energy storage assembly 72 includes a gas spring mechanism or a mechanical spring mechanism. The mechanical spring mechanism utilizes the drive assembly to compress a coil spring so that the spring stores energy when compressed and releases energy when extending. When releasing energy, the spring drives the striking member to move.

As shown in FIGS. 67 to 69, in this example, the energy storage assembly 72 is, for example, a gas spring mechanism. The energy storage assembly 72 includes a cylinder 721, and the cylinder 721 further includes a gas filling nozzle 724 configured to pre-fill gas in the cylinder 721. The firing assembly 73 is at least partially disposed within the cylinder 721. The firing assembly 73 does work on the gas in the cylinder 721, and the gas in the cylinder 721 pushes the firing assembly 73 to move to drive the fasteners (for example, nails, tacks, or staples) held in the magazine into the workpiece. The firing assembly 73 includes a piston 731. The striking member 621 and the piston 731 are fixedly connected. The piston 731 is driven to reciprocate in the cylinder 721 along the direction of the second straight line 602. In this example, the second straight line 602 coincides with the striking straight line 601. In some examples, the second straight line 602 and the striking straight line 601 are parallel and do not coincide. In some examples, the second straight line 602 is at a certain angle to the striking straight line 601.

As shown in FIGS. 68 to 73, the drive assembly 71 includes a drive wheel 711 disposed on an output shaft 6511. In a striking cycle, the motor 64 rotates to drive the drive wheel 711 to rotate to drive the striking member 621 to move from the bottom dead center or striking position to the top dead center or stop position, and the firing assembly 73 compresses the gas in the cylinder 721. As shown in FIG. 71, at the stop position, the firing assembly 73 and the drive wheel 711 are held in place, and the compressed gas continuously pushes the firing assembly 73, that is, the piston 731, to generate an acceleration. This state persists until a trigger command indicating that the user starts to nail is received. At this time, the holding force of the firing assembly 73 is released. As shown in FIG. 70, when the holding force is released, the gas compressed by the firing assembly 73 drives the firing assembly 73 and the striking member 621 to the striking position, thereby driving the nail into the workpiece.

In this example, it is defined that a striking cycle includes a lifting cycle and an impact cycle, and the lifting cycle starts when the rotation of the drive wheel 711 can drive the striking member 621 to move toward the top dead center or stop position as shown in FIG. 70. It is defined that the impact cycle starts when the holding force is released and the gas compressed by the firing assembly 73 drives the firing assembly 73 and the striking member 621 to move toward the bottom dead point or striking position.

In this example, wheel pins 712 are disposed on the drive wheel 711, and lifting teeth 622 meshing with the wheel pins 712 are disposed on the striking member 621. The wheel pins 712 mesh with the lifting teeth 622 to drive the striking member 621 to move. The lifting tooth 622 is configured to have a meshing surface 6221 meshing with the wheel pin 712 and a non-meshing surface 6222 opposite to the meshing surface 6221. The wheel pin 712 that meshes with the lifting tooth 622 at the start of the lifting cycle is defined as a first pin 712a, and the lifting tooth 622 that is closest to the first pin 712a at the start of the lifting cycle is defined as a target lifting tooth 622b. It is to be understood that the lifting tooth 622 closest to the first pin 712a may be any downstream lifting tooth 622 of a first lifting tooth 622a that meshes with the first pin 712a.

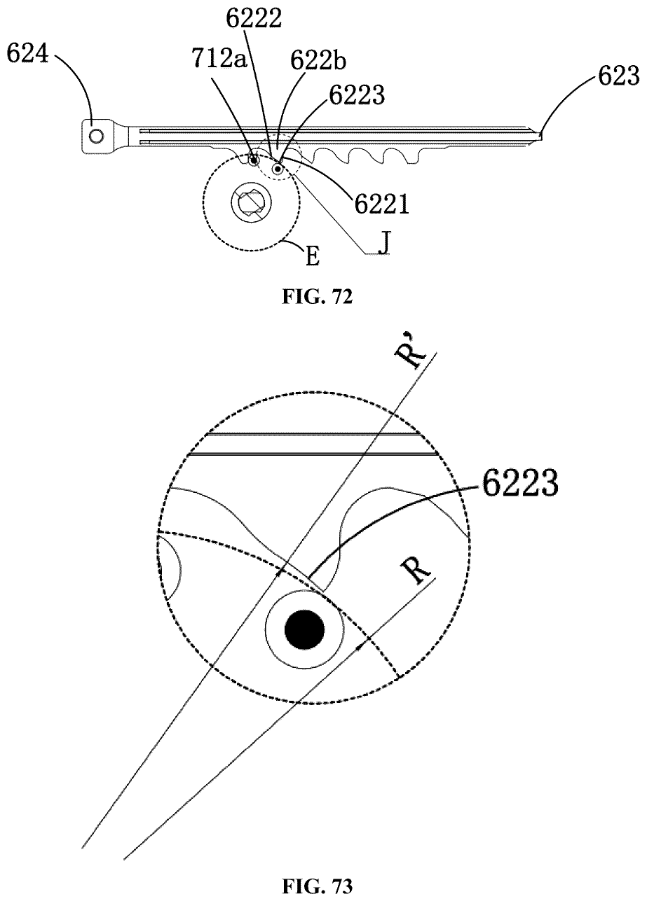

As shown in FIGS. 72 and 73, at the start of the lifting cycle, the outer envelope E of the rotation trajectory of the wheel pin 712 has no interference with at least the non-meshing surface 6222 of the target lifting tooth 622b. The outer envelope E of the rotation trajectory of the wheel pin 712 is a curve that is tangent to at least one point on each line of the rotation trajectory of the wheel pin 712. In the related art, due to some reasons, the striking member 621 does not move completely to the theoretical stop position. Then, during the rotation of the drive wheel 711, the wheel pin, such as the first pin 712a, may collide with the downstream lifting tooth (such as the target lifting tooth 622b) of the meshing lifting tooth (such as the first lifting tooth 622a). In this example, by reasonably setting the shape of the lifting tooth 622, the wheel pin 712 on the drive wheel 711 is prevented from colliding with the lifting tooth 622 during the striking cycle, thereby ensuring the service life and operational safety of the fastener driver.

In this example, the wheel pin 712 and the lifting tooth 622 are configured to be a protrusion and a recess meshing with each other. Optionally, the recess may be a groove, a blind hole, or a through hole structure.

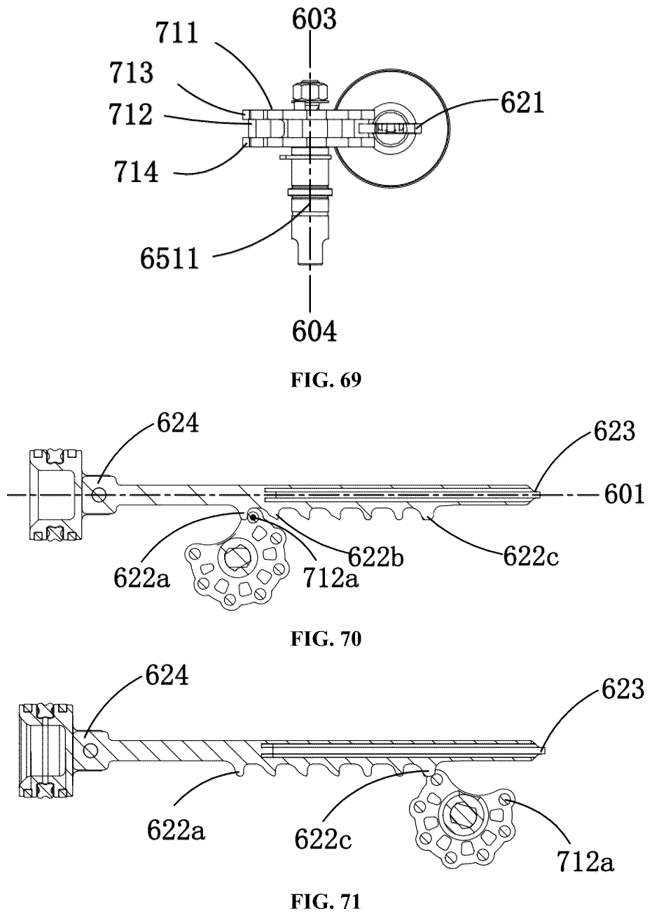

As shown in FIGS. 68 and 69, the drive wheel 711 includes a first fixing layer 713 and a second fixing layer 714 that are basically in parallel. Multiple wheel pins 712 are disposed between the first fixing layer 713 and the second fixing layer 714 along the circumferential direction. The first fixing layer 713 and the second fixing layer 714 are plates having a certain thickness. The multiple wheel pins 712 are cylindrical, and two ends of the cylinder are disposed on the first fixing layer 713 and the second fixing layer 714, respectively. In some examples, the wheel pins 712 are movable or rotatable to reduce friction between the wheel pins 712 and the lifting teeth 622. In some examples, a movable or rotatable pin bushing is sleeved on the wheel pin 712.

As shown in FIGS. 70 and 71, the striking member 621 is provided with a striking end 623 for striking the fastener and a fixed end 624 away from the striking end 623. In this example, the fixed end 624 and the piston 731 are fixedly connected. It is to be explained that the fixed connection between the fixed end 624 and the piston 731 means that the users or non-professionals cannot disassemble the fixed end 624 of the striking member 621 from the piston 731 without using tools. Professionals may non-destructively disassemble the fixed end 624 of the striking member 621 from the piston 731 with the aid of tools, thereby facilitating maintenance. In this example, the striking end 623 is located downstream of the fixed end 624, and multiple lifting teeth 622 are provided between the fixed end 624 and the striking end 623. The multiple lifting teeth 622 are arranged on the striking member 621 along the length direction of the striking member 621. The multiple lifting teeth 622 are protrudingly arranged and have a wavy shape as a whole.

For example, the second lifting tooth 622 starting from the fixed end 624 is the target lifting tooth 622b. For example, the third lifting tooth 622 starting from the fixed end 624 is the target lifting tooth 622b (not shown in the figure). In some examples, the lifting tooth 622 at the upstream end of the target lifting tooth 622b has the same tooth structure as the target lifting tooth 622b. In some examples, the lifting teeth 622 at the upstream and downstream ends of the target lifting tooth 622b have the same tooth structure as the target lifting tooth 622b. In some examples, during the theoretical design and the normal operation of the machine, the tooth structure of the first lifting tooth 622a that should mesh with the first pin 712a is different from the tooth structure of the target lifting tooth 622b. In some examples, during the theoretical design and the normal operation of the machine, at the stop position, the lifting tooth that meshes with the wheel pin 712 when the firing assembly 73 and the drive wheel 711 are held in place is defined as a holding lifting tooth 622c, and the tooth structure of the holding lifting tooth 622c is different from the tooth structure of the target lifting tooth 622b.

As shown in FIGS. 72 and 73, in this example, the non-meshing surface 6222 of the lifting tooth is provided with a relief portion 6223 that is concave toward the meshing surface 6221, the relief portion 6223 is basically arc-shaped, and the relief portion 6223 has a radius of curvature R′. The radius of curvature of the outer envelope E of the rotation trajectory of the wheel pin 712 is R. The radius of curvature R′ of the relief portion 6223 is greater than or equal to the radius of curvature R of the outer envelope E of the rotation trajectory of the wheel pin 712. In this manner, the risk of collision between the wheel pins 712 and the lifting teeth 622 during operation can be reduced.

As shown in FIG. 69, the drive wheel 711 rotates about a third straight line 603. In this example, the third straight line 603 coincides with a motor axis 604, and the third straight line 603 intersects with the striking straight line 601. For example, the third straight line 603 is perpendicular to the striking straight line 601. Multiple wheel pins 712 are distributed along the circumferential direction of the drive wheel 711, and each wheel pin 712 on the drive wheel 711 meshes with a corresponding lifting tooth 622 on the striking member 621. As shown in FIG. 70, in the lifting cycle, starting from the first pin 712a meshing with the first lifting tooth 622a, the wheel pins 712 arranged in sequence along the direction of rotation mesh with the corresponding lifting teeth 622 in sequence, and when the wheel pin meshes with the holding lifting tooth 622c (as shown in FIG. 71), the striking member 621 and the piston 731 move to the stop position (the top dead center).

The basic principles, main features, and advantages of this application are shown and described above. It is to be understood by those skilled in the art that the aforementioned examples do not limit the present application in any form, and all technical solutions obtained through equivalent substitutions or equivalent transformations fall within the scope of the present application.

What is claimed is:

1. A fastener driver, comprising:
a striking assembly comprising a piston and a firing pin connected to the piston;
a transmission mechanism comprising a driving member configured to drive the striking assembly to move backward to a top dead center position; and
an energy storage device configured to drive the striking assembly to move forward to a bottom dead center position to output an impact force;
wherein a distance L3 between the top dead center position and the bottom dead center position is defined as a stroke of the striking assembly, the fastener driver is configured to drive a fastener within a preset length L4 to move, and a ratio of the stroke of the striking assembly to the preset length is less than or equal to 1.5 to 1.

2. The fastener driver of claim 1, wherein the stroke is less than or equal to 80 mm.

3. The fastener driver of claim 1, wherein a length of the firing pin is less than or equal to 165 mm.

4. The fastener driver of claim 1, wherein the firing pin comprises a toothed portion, and a ratio of a length of the toothed portion to the preset length is less than or equal to 1.21 to 1.

5. The fastener driver of claim 1, wherein the driving member drives the firing pin to move from the bottom dead center position, pass through a switching position and a stop position in sequence, and move to the top dead center position.

6. The fastener driver of claim 5, wherein a ratio of a stroke distance of the firing pin moving from the stop position to the top dead center position to a stroke distance of the firing pin moving from the switching position to the top dead center position is less than 1 to 1.

7. The fastener driver of claim 5, wherein a stroke distance of the firing pin moving from the switching position to the top dead center position is greater than or equal to 3.7 mm and less than or equal to 4.8 mm.

8. The fastener driver of claim 5, wherein a stroke distance of the firing pin moving from the stop position to the top dead center position is greater than or equal to 1.6 mm and less than or equal to 2.6 mm.

9. The fastener driver of claim 5, wherein a ratio of a stroke distance of the firing pin moving from the stop position to the top dead center position to a stroke distance of the firing pin moving from the switching position to the top dead center position is greater than or equal to 0.5 to 1 and less than or equal to 0.9 to 1.

10. The fastener driver of claim 5, wherein the firing pin comprises a body portion extending along a direction of a first straight line and a plurality of meshing teeth disposed on the body portion, the driving member comprises a plurality of driving teeth configured to mesh with the firing pin to drive the firing pin, and the plurality of meshing teeth comprise a first meshing tooth that stops the firing pin at the stop position.

11. The fastener driver of claim 10, wherein the first meshing tooth and a driving tooth of the plurality of driving teeth are in contact at a contact point and generate a force perpendicular to a tangent at the contact point, and when the firing pin moves from the switching position to the top dead center position, an included angle between a direction of the force and the direction of the first straight line gradually increases.

12. The fastener driver of claim 1, comprising a guide assembly configured to guide the fastener to move, wherein a length of the guide assembly is less than or equal to 108 mm.

13. The fastener driver of claim 1, wherein a length of the fastener driver in a front and rear direction is less than or equal to 295 mm.

14. The fastener driver of claim 1, wherein the energy storage device comprises a first cylinder accommodating at least part of the piston, the first cylinder comprises a first inner wall in contact with the piston, the first inner wall has a circular first cross section, and a ratio of a stroke of the firing pin to a diameter of the first cross section is greater than or equal to 1.7 to 1 and less than or equal to 2.8 to 1.

15. The fastener driver of claim 14, wherein a product of the first cross section and the stroke is defined as gas displacement, and a ratio of striking energy outputted by the fastener driver to the gas displacement is greater than or equal to 0.3 J to 1 cm³ and less than or equal to 0.7 J to 1 cm³.

16. A fastener driver, comprising:
a striking assembly comprising a piston and a firing pin connected to the piston;
a transmission mechanism comprising a driving member configured to drive the striking assembly to move backward to a top dead center position; and
an energy storage device configured to drive the striking assembly to move forward to a bottom dead center position to output an impact force;
wherein a length of the fastener driver in a front and rear direction is less than or equal to 295 mm.

17. A fastener driver, comprising:
a striking assembly comprising a piston and a firing pin connected to the piston;
a transmission mechanism comprising a driving member configured to drive the striking assembly to move backward to a top dead center position; and
an energy storage device configured to drive the striking assembly to move forward to a bottom dead center position to output an impact force, wherein the energy storage device comprises a first cylinder accommodating at least part of the piston, the first cylinder comprises a first inner wall in contact with the piston, and the first inner wall has a circular first cross section;
wherein a distance between the top dead center position and the bottom dead center position is defined as a stroke of the striking assembly, and a ratio of a stroke of the firing pin to a diameter of the first cross section is greater than or equal to 1.7 to 1 and less than or equal to 2.8 to 1.

18. The fastener driver of claim 17, wherein the energy storage device comprises a second cylinder, at least part of the first cylinder is accommodated in the second cylinder, the second cylinder comprises a second inner wall, the second inner wall has a circular second cross section, and a ratio of the diameter of the first cross section to a diameter of the second cross section is greater than or equal to 0.6 to 1 and less than or equal to 0.7 to 1.

19. The fastener driver of claim 17, wherein the diameter of the first cross section is greater than or equal to 28 mm and less than or equal to 36 mm.

20. The fastener driver of claim 17, wherein a product of an area of the first cross section and the stroke is defined as gas displacement, and a ratio of striking energy outputted by the fastener driver to the gas displacement is greater than or equal to 0.3 J to 1 cm³ and less than or equal to 0.7 J to 1 cm³.
